(19) United States
(12) Patent Application Publication
(10) Pub. No.: US 2022/0217980 A1
(43) Pub. Date: Jul. 14, 2022

(54) DITHIOCARBAMATE FUNGICIDE MACROMOLECULAR COMPLEXES

(71) Applicant: Adama Makhteshim Ltd., Beer Sheva (IL)

(72) Inventors: Wilhelmus Maria van der Krieken, PW Wageningen (NL); Stefania Mazzitelli, PW Wageningen (NL)

(73) Assignee: Adama Makhteshim Ltd., Beer Sheva (IL)

(21) Appl. No.: 17/595,754

(22) PCT Filed: May 28, 2020
(86) PCT No.: PCT/IB2020/055089

§ 371 Date: Nov. 23, 2021

(30) Foreign Application Priority Data
May 28, 2019 (EP) 19177114.6

(51) Int. Cl. A01N 47/14; A01N 25/24; A01N 25/04; A01P 3/00

(52) U.S. Cl. CPC A01N 47/14; A01P 3/00; A01N 25/04; A01N 25/24

(57) ABSTRACT

The invention relates to a macromolecular complex of a polycation and a dithiocarbamate fungicide. The invention further relates to a method for producing a macromolecular complex according to the invention, a composition comprising said macromolecular complex, and to the use of said composition. The invention additionally relates to a method of protecting a plant, and to a method of preventing, reducing and/or eliminating the presence of a pathogen on a plant, by contacting said plant with a composition of the invention.

This application claims the benefit of EP Patent Application No. EP19177114, filed on May 28, 2019, the contents of which are incorporated herein by reference in their entirety.

Throughout this application various publications are referenced. The disclosures of these documents in their entireties are hereby incorporated by reference into this application in order to more fully describe the state of the art to which this invention pertains.

### FIELD

The present invention relates to a macromolecular complex comprising a dithiocarbamate fungicide and a polycation as a polyelectrolyte. The invention further relates to methods for producing a maeromolecular complex of the invention, to compositions comprising the macromolecular complex, and to methods of preventing, reducing and/or eliminating the presence of a phytopathogen on a plant or on one or more plant parts, comprising applying a composition of the invention to said plant or plant part.

### 1. INTRODUCTION

Agricultural pest control includes biological control means such as crop rotation, companion planting, breeding of pest-resistant cultivars, and the use of living organisms such as dogs to catch rodents, the use of physical traps such as sticky flypapers, garden guns, and the application of chemical control means. Chemical control is based on substances that are toxic to the pests involved, while causing little or no toxic effects to the agricultural plants. Chemical control agents or pesticides include lime and wood ash, sulphur, bitumen, nicotine, heavy metals such as copper, lead and mercury, and neem oil.

Chemical control agents can be incredibly beneficial and have contributed to increased food production over the past century. However, when a pesticide is applied it may be carried into the environment by leaching into the soil or drifting through the air. In addition, pesticide exposure to human sometimes may cause adverse health effects ranging from simple irritation of the skin and eyes to more severe effects such as affecting the nervous system. A major challenge in agriculture, therefore, is to control plant pests while reducing the amounts of chemical control agents that are applied.

Compositions of a pesticide may be used to enhance performance of the pesticide and, thereby, reduce the amount that is to be applied to be effective against the agricultural pest. A formulation may, for example, increase stickiness, increase rainfastness, and/or provide longer duration by slow release of the active ingredient.

The published international application WO 2008/002623 describes the use of ion exchanging polymers to provide slow release of a charged pesticide. Similarly, WO 2008/024509 describes the encapsulation of a bioactive ingredient into a cationic latex, thereby providing sustained release of the bioactive ingredient. US 2013/0244880 describes biologically degradable, water insoluble matrices encapsulating pesticides. Disagregation of the matrices would provide slow and controlled release of the pesticide.

Several documents, e.g. CN 102302037 and CN 103039468, describe that chitosan oligosaccharide works synergistically with fungicides and increases crop resistance itself. Furthermore, chitosan has recently been reported to be useful as a rainfastness adjuvant (Symonds et al., 2016. RSC Adv 6, 102206). In addition, a low molecular weight chitosan obtained from biomass of Argentine Sea's crustaceans has been reported to have some activity against Phytophthora infestans and Fusarium solani f. sp. eumartii (Ippólito et al., 2017. In: Biological Activities and Application of Marine Polysaccharides, Emad A. Shalaby (ed), IntechOpen). Said low molecular weight chitosan, when applied together with the synthetic fungicide Mancozeb, was found to provide a synergist effect in reducing F. eumartii spore germination (Ippólito et al., 2017. Ibid).

Furthermore, WO 2013/133705 and WO 2013/133706 describe the use of a neutral, insoluble polyelectrolyte complex, generated by mixing solutions of a polycation and a polyanion. Said polyclectrolyte complex was found to improve the protective effect of a biocide that was adhered to the polyelectrolyte complex, in comparison with the same biocide without said polyelectrolyte complex.

It is an objective of the present invention to provide compositions and methods that allow increase in the activity of a dithiocarbamate fungicide and reduction in the amounts of dithiocarbamate fungicide needed to protect a plant against phytopathogenic pests. Said composition preferably increases the biological activity of the dithiocarbamate fungicide.

### 2. SUMMARY OF THE INVENTION

The present invention provides a macromolecular complex of a polyelectrolyte and a bioactive ingredient, wherein (1) the polyelectrolyte is a polycation, (2) the bioactive ingredient is a dithiocarbamate fungicide, and (3) the macromolecular complex is characterized by intermolecular, non-covalent interactions, preferably electrostatic interactions such as ionic interactions, hydrogen bonds and van der Waals forces, such as dipole-dipole interactions, between the polyelectrolyte and the bioactive ingredient.

The present invention provides a macromolecular complex comprising (i) a dithiocarbamate fungicide and (ii) a polycation, wherein the macromolecular complex comprises up to 1 part of polyanion per 6 parts of the dithiocarbamate fungicide by weight.

The invention also provides a macromolecular complex comprising (i) mancozeb and (ii) a polycation. In some embodiments, the complex is characterized by non-covalent intermolecular interactions, preferably ionic interactions and hydrogen bonds, between donor and acceptor groups of the mancozeb and the polycation.

The invention further provides a composition comprising any one of the macromolecular complexes described herein and an agriculturally acceptable additive.

The present invention provides a concentrate composition comprising (1) a macromolecular complex comprising (i) a dithiocarbamate fungicide and (ii) a polycation, and (2) an aqueous carrier.

The present invention also provides a suspension concentrate comprising (1) a macromolecular complex comprising (i) a dithiocarbamate fungicide and (ii) a polycation, and (2) an aqueous carrier.

The invention also provides a process for producing a macromolecular complex, wherein the process comprises (a) providing an aqueous composition of a polycation, (b) mixing a dithiocarbamate fungicide into the aqueous composition, while keeping the pH of the mixture between pH=3-6, preferably between 3-4, by addition of an acid, (c) thereby producing a macromolecular complex of the polycation and the dithiocarbamate fungicide.

The present invention also provides a macromolecular complex produced by any of the methods or processes described herein.

The invention also provides a method for increasing the bioavailability of a dithiocarbamate fungicide, comprising interacting the dithiocarbamate fungicide with a polycation to form a macromolecular complex, preferably by complexing or entrapping the dithiocarbamate fungicide partially or completely within the polycation, prior to application of the dithiocarbamate fungicide to a plant, plant part, and/or soil.

The invention also provides a fungicidal macromolecular complex comprising a dithiocarbamate fungicide and a polycation.

The present invention also provides a dithiocarbamate fungicide delivery system comprising a macromolecular complex comprising (i) the dithiocarbamate fungicide and (ii) at least one polycation, wherein molecules of the dithiocarbamate fungicide interact with molecules of the polycation through non-covalent intermolecular interactions, preferably electrostatic intermolecular interactions.

The invention also provides a fungicidal delivery system comprising a polycation, a dithiocarbamate fungicide and a system of dispersants, wherein molecules of the dithiocarbamate fungicide interact with molecules of the polycation through intermolecular force(s).

The invention also provides a fungicidal delivery system comprising a macromolecular complex comprising an effective amount of a dithiocarbamate and a polycation, wherein molecules of the dithiocarbamate fungicide interact with molecules of the polycation through intermolecular force(s).

The invention also provides a fungicidal delivery system comprising any one or any combination of the macromolecular complexes described herein.

The invention also provides use of a macromolecular complex and/or a composition according to the invention for the protection of a plant, or a part of a plant, against a pathogen. For such use, the macromolecular complex and/or the composition is preferably sprayed over a plant or a part of a plant.

In an aspect, the invention provides a method of protecting a plant, or a part of a plant, against a pathogen, comprising contacting said plant, or part of said plant, with a macromolecular complex and/or a composition according to the invention.

In an aspect, the invention provides a method of preventing, reducing and/or eliminating the presence of a pathogen on a plant, or a part of a plant, comprising contacting said plant, or part of said plant, with a macromolecular complex and/or a composition according to the invention.

In an aspect, the invention provides a method of controlling diseases caused by phytopathogenic fungi in plants or on propagation material thereof which comprises contacting the plants, or propagation material thereof, with a macromolecular complex and/or a composition according to the invention.

The invention also provides a method for improving leaf adhesion of a dithiocarbamate fungicide comprising interacting the dithiocarbamate fungicide with a polycation to form a macromolecular complex, preferably by complexing or entrapping the dithiocarbamate fungicide partially or completely within the polycation, prior to application of the dithiocarbamate fungicide to a plant, plant part, and/or soil.

The invention also provides a method for improving rainfastness of a dithiocarbamate fungicide comprising interacting the dithiocarbamate fungicide with a polycation to form a macromolecular complex, preferably by complexing or entrapping the dithiocarbamate fungicide partially or completely within the polycation, prior to application of the dithiocarbamate fungicide to a plant, plant part, and/or soil.

The invention also provides a method for increasing persistence of a dithiocarbamate fungicide comprising interacting the dithiocarbamate fungicide with a polycation to form a macromolecular complex, preferably by complexing or entrapping the dithiocarbamate fungicide partially or completely within the polycation, prior to application of the dithiocarbamate fungicide to a plant, plant part, and/or soil.

### 3. LEGENDS TO THE FIGURES

FIG. 1. Scanning electron microscope (SEM) pictures of control Manzidan 800 wg (A), mancozeb-chitosan macromolecular complexes (B) and mancozeb-polyallylamine macromolecular complexes (C) on a plastic surface; of control Manzidan 800 wg (D), mancozeb-chitosan macromolecular complexes (E) and mancozeb-polyallylamine macromolecular complexes (F) on adaxial wheat leaves, and of mancozeb-chitosan macromolecular complexes (G) and control mancozeb particles (H) on a glass surface. A-F: 300× enlargement; G,H: 15000× enlargement

FIG. 2. Mancozeb samples (a) and polycation-mancozeb combinations (in ratios 1:20, 1:40, 1:60 and 1:80) chitosan-mancozeb (b), ϵ-PLL—mancozeb (c) and PAA-mancozeb (d).

FIG. 3. Dose-response curves of Mancozeb DITHAN NEOTEC and 5 new formulations DT-CE-M2-300-01T, DT-CE-M2-300-02T, DT-CE-M2-300-03T, DT-CE-M2-300-04T and DT-CE-M2-300-05T towards Phakopsora pachyrhizi strainTHAI1 obtained from the AUDPC.

FIG. 4. Efficacy (obtained from AUDPCvalues) of Mancozeb prototypes DT-CE-M2-300-01T, DT-CE-M2-300-02T, DT-CE-M2-300-03T, DT-CE-M2-300-04T and DT-CE-M2-300-05T and the reference Mancozeb fungicide DITHAN NEOTEC, applied at 4.69 g a.i./ha (31.25 ppm) and rainwashed or not with 40 mm of water applied 24 h after treatment and inoculation with spores of P. pachyrhizi strainTHAI1 on soybean leaves.

FIG. 5. Rainfastness of Mancozeb prototypes DT-CE-M2-300-01T, DT-CE-M2-300-04T and DT-CE-M2-300-05T and the reference Mancozeb fungicide DITHAN NEOTEC, applied at 4.69 g a.i./ha (31.25 ppm) at an artificial rain 40 mm applied 24 h after treatment and inoculation with spores of P. pachyrhizi strainTHAI1 on soybean leaves.

FIG. 6. Evolution of the efficacy of Mancozeb prototypes DT-CE-M2-300-01T, DT-CE-M2-300-04T and DT-CE-M2-300-05T, or the reference Mancozeb fungicide DITHAN NEOTEC, applied at 7.81 ppm (A) or 31.25 ppm (B) and inoculated 1 week, 2 weeks or 3 weeks after treatment with spores of P. pachyrhizi strainTHAI1 on soybean leaves.

FIG. 7. Schematic description of the procedure for the preparation of optimized compositions comprising macromolecular complex of the present invention.

FIG. 8. Diagrammatic scale for assessing the severity of the target soybean spot.

FIG. 9. Diagrammatic scale of soybean end-of-cycle diseases caused by Septoria glycine e Cercospora kikuchiii. Upper panel: aggregated symptoms. Bottom panel: symptoms randomly distributed.

FIG. 10. Diagrammatic scale of soybean powdery mildew (Microsphaera diffusa).

FIG. 11. SAR assessment scale FIG. 12. Efficacy of mancozeb macromolecular complex.

FIG. 13. Efficacy of tank mix of mancozeb macromolecular complex, picoxystrobin and tebuconazole.

FIG. 14. Efficacy of tank mix of mancozeb macromolecular complex and prothioconazole.

FIG. 15. Schematic of the procedures used for preparing the eight different compositions of Example 9.

FIG. 16. Calibration curve of lignosulfonate concentration.

FIG. 17. Efficacy of 8 new mancozeb prototypes PT01, PT02, PT03, FF04, PT05, PT06, PT07. FF08 and the reference mancozeb formulation Dithan Neotec used preventively at 0.75 g a.i./ha towards Phakopsora pachyrhizi strain THAI1 obtained from the AUDPC values.

### 4. DETAILED DESCRIPTION

### 4.1 Definitions

Unless defined otherwise, all technical and scientific terms used herein have the meaning commonly understood by persons of ordinary skill in the art to which this subject matter pertains.

The term “a” or “an”, as used herein, includes the singular and the plural, unless specifically stated otherwise. Therefore, the terms “a,” “an,” or “at least one” can be used interchangeably in this application.

As used herein, the term “about” when used in connection with a numerical value includes ±10% from the indicated value. In addition, all ranges directed to the same component or property herein are inclusive of the endpoints, are independently combinable, and include all intermediate points and ranges. It is understood that where a parameter range is provided, all integers within that range, and tenths thereof, are also provided by the invention. For example, “30-45%” includes 30%, 30.1%, 30.2%, etc. up to 45%.

The term “polyelectrolyte”, as is used herein, refers to a molecule consisting of a plurality of functional, charged groups that are linked to a polymer backbone. In the context of this application, the term “polycation” is interchangeable with the term “positively charged polyelectrolyte”, while the term “polyanion” is interchangeable with the term “negatively charged polyelectrolyte”. The terms polycation and polyanion refer to positively charged and negatively charged polymer molecules, respectively, under neutral or acidic conditions, i.e. at pH 3-8.

The term “polyelectrolyte complex”, as is used herein, refers to a structure that is formed by interaction of at least one polycation with at least one polyanion. Polyelectrolyte complexes are described, for example, in WO 2013/133705 and WO 2013/133706, the contents of each of which are hereby incorporated by reference. An example of polyelectrolyte complex may be a “polyelectrolyte matrix” (“PEM”).

The term “polyelectrolyte matrix”, as is used herein, refers to a network that is formed by interaction of at least one polycation with at least one polyanion that result in a matrix like physical structure.

The term “macromolecular complex”, as is used herein, refers to structure that is formed by non-covalent interaction of a dithiocarbamate fungicide with a polyelectrolyte, such as at least one polycation, at least one polyanion, or at least one polyclectrolyte complex. In such macromolecular complex, the non-covalent interactions are preferably electrostatic interactions. The macromolecular complex thus avoids the use of covalent cross-linkers.

The term “electrostatic interaction” as is used herein, refers to electric force between any two charged molecules and/or dipole molecules. The term “electrostatic interactions” includes ionic interactions, hydrogen bonds, and van der Waals forces such as dipole-dipole interactions.

The term “free”, as is used herein in connection with a dithiocarbamate fungicide, refers to a dithiocarbamate fungicide that is not part of a macromolecular complex. A free dithiocarbamate fungicide is a non-complexed form of the dithiocarbamate fungicide.

The term “ionizable”, as is used herein, refers to a dithiocarbamate fungicide and/or a polymer (polyelectrolyte) which comprises a functional group(s) that can be ionized or protonated in an aqueous solution. Said molecules are capable of dissociating into the corresponding cation and anion, similar to salts such as copper sulfate.

The term “lignin compound”, as is used herein, refers to a chemical compound that is derived from naturally occurring lignin or lignen by a process that includes sulphonation. The resulting sulfonic acids are strong acids and lignin compounds are therefore negatively charged at pH values below 7.

As used herein, the term “chitosan” refers to a linear polysaccharide composed of randomly distributed β-(1-4)-linked D-glucosamine (deacetylated unit) and N-acetyl-D-glucosamine (acetylated unit). Chitosan is produced by deacetylation of chitin. The term “chitosan” includes chitosan, chitosan derivatives and mixtures of chitosan and chitosan derivatives.

The term “crop”, as is used herein, include cereals such as wheat, barley, rye, oats, sorghum and millet, rice, cassava and maize, and crops that produce, for example, peanut, sugar beet, cotton, soya, oilseed rape, potato, tomato, peach and vegetables.

The term “part of a plant”, as is used herein, indicates a part of a plant including, but not limited to, pollen, ovule, leaf, root, flower, fruit, stem, bulb, corn, branch and seed.

The term “bioactive ingredient”, as is used herein with connection to an additional bioactive ingredient, refers to a chemical substance capable of controlling pests and/or killing living organisms. Bioactive ingredients are commonly used in medicine, agriculture, forestry, and in industry where they prevent the fouling of, for example, water, agricultural products including seed, and oil pipelines. A bioactive ingredient can be a pesticide, including a fungicide, herbicide, insecticide, algicide, molluscicide, miticide and rodenticide; and/or an antimicrobial such as a germicide, antibiotic, antibacterial, antiviral, antifungal, antiprotozoal and/or antiparasitic compound.

The term “bioactive ingredient”, as is used herein with connection to part of the macromolecular complex and/or complex of the present invention, is a dithiocarbamate fungicide such as mancozeb.

The term “bioactive ingredient”, as is used herein in connection with a macromolecular complex and/or complex of the present invention, is a dithiocarbamate fungicide.

As used herein, the term “pest” includes, but is not limited to, insect, nematode, weed, fungi, algae, mite, tick, and animal. Said pest preferably is a phytopathogenic fungi, an unwanted insect, and/or a weed.

As used herein, the term “weed” refers to any unwanted vegetation.

As is used herein, the term “pesticide” includes, but is not limited to, a herbicide, insecticide, fungicide, nematocide, mollusks repellent and a control agent.

The terms “controlling a pest” and “pest control”, as used herein, refers to preventive, persistence, curative and/or knock down treatment of a pest.

The term “polyene fungicide”, as used herein, refers to a polyene macrolide antifungal that possess antifungal activity such as natamycin, lucensomycin, filipin, nystatin or amphotericin B, most preferred natamycin. Derivatives of a polyene fungicide, such as derivatives of natamycin, are also included. A preferred derivative is a salt or a solvate of a polyene fungicide and/or a modified form of a polyene fungicide such as e.g. different shaped crystal forms such as the needle-shaped crystal of natamycin described in U.S. Pat. No. 7,727,966.

The term “suspension concentrate”, as used herein, refers to a suspension of solid particles in a liquid intended for dilution with water prior to use. In some embodiments, suspension concentrate refers to an aqueous suspension concentrate.

The term “dispersion concentrate”, as used herein, refers to a dispersion of solid particles in a liquid intended for dilution with water prior to use.

The term “water dispersible granules”, as used herein, refers to a formulation in granule form which is dispersible in water forming a dispersion such as a suspension or solution.

The term “wettable powder”, as used herein, refers to a powder formulation intended to be mixed with water or another liquid prior to use.

The term “water slurriable powder”, as used herein, refers to a powder formulation that is made into a slurry in water prior to use.

### 4.2 Macromolecular Complexes

It was surprisingly found that the presence of a dithiocarbamate fungicide as one of the constituents of a macromolecular complex significantly enhances the biological efficacy and improves persistence of the dithiocarbamate fungicide, when compared to a non-complexed dithiocarbamate fungicide.

Dithiocarbamate fungicide that is provided in a macromolecular complex according to the invention is also more compatible with other active ingredients, compared to dithiocarbamate fungicide that is not provided in a macromolecular complex according to the invention.

In addition, a macromolecular complex according to the invention reduces drift of the dithiocarbamate fungicide. Said macromolecular complex surprisingly results in a reduction of moving in the soil or of leakage of dithiocarbamate fungicide. Said complex furthermore results in a reduced toxicity of the plants, hence causes less phytotoxicity, when compared to dithiocarbamate fungicide that is not provided in a macromolecular complex according to the invention.

The interaction of a polycation with a dithiocarbamate fungicide is taught to result in the encapsulation/complexation of the dithiocarbamate fungicide by the polycation. A thus encapsulated and/or complexed dithiocarbamate fungicide shows enhanced biological efficacy, improved persistence of the dithiocarbamate fungicide, when compared to free, non-encapsulated and/or not complexed dithiocarbamate fungicide. A thus encapsulated and/or complexed dithiocarbamate fungicide also shows enhanced biological efficacy and improved persistence, when compared to the same dithiocarbamate fungicide that is added to an already formed polyelectrolyte complex, as described in WO 2013/133705 and WO 2013/133706.

This invention provides a macromolecular complex of a polyclectrolyte and a bioactive ingredient, wherein (1) the polyelectrolyte is a polycation, (2) the bioactive ingredient is dithiocarbamate fungicide, and (3) the macromolecular complex is characterized by intermolecular, non-covalent interactions, preferably electrostatic interactions such as ionic interactions, hydrogen bonds and van der Waals forces, such as dipole-dipole interactions, between the polyelectrolyte and the bioactive ingredient.

The present invention provides a macromolecular complex comprising (a) polycation and (b) dithiocarbamate fungicide, wherein the macromolecular complex is characterized by intermolecular, non-covalent interactions, preferably electrostatic interactions such as ionic interactions, hydrogen bonds and van der Waals forces, such as dipole-dipole interactions, between the polycation and the dithiocarbamate fungicide.

The invention further provides a macromolecular complex comprising (a) a polycation and (b) a dithiocarbamate fungicide, wherein the macromolecular complex comprises no more than 1 part of polyanion per 6 parts of the dithiocarbamate fungicide by weight.

The invention further provides a macromolecular complex comprising (a) a polycation, (b) a dithiocarbamate fungicide, and (c) a lignosulfonate, wherein the macromolecular complex comprises no more than 1 part of lignosulfonate per 6 parts of the dithiocarbamate fungicide by weight.

In some embodiments, the macromolecular complex is characterized by intermolecular, non-covalent interactions, preferably electrostatic interactions such as ionic interactions, hydrogen bonds and van der Waals forces, such as dipole-dipole interactions, between said donor and acceptor groups on the polycation and the dithiocarbamate fungicide.

In some embodiments, the macromolecular complex is characterized by non-covalent intermolecular interactions, preferably ionic interaction and hydrogen bonds between donor and acceptor groups of the polycation and the dithiocarbamate fungicide.

In some embodiments, the dithiocarbamate fungicide and the polycation are interacted.

In some embodiments, the macromolecular complex comprises up to no more than 1 part of polyanion per 8 parts of the dithiocarbamate fungicide by weight. In some embodiments, the macromolecular complex comprises up to no more than 1 part of polyanion per 10 parts of the dithiocarbamate fungicide by weight. In some embodiments, the macromolecular complex comprises up to 1 part of polyanion per 20 parts of the dithiocarbamate fungicide by weight. In some embodiments, the macromolecular complex comprises up to 1 part of polyanion per 25 parts of the dithiocarbamate fungicide by weight. In some embodiments, the macromolecular complex comprises up to 1 part of polyanion per 50 parts of the dithiocarbamate fungicide by weight. In some embodiments, the macromolecular complex comprises up to 1 part of polyanion per 100 parts of the dithiocarbamate fungicide by weight. In some embodiments, the macromolecular complex comprises up to 1 part of polyanion per 1000 parts of the dithiocarbamate fungicide by weight.

In some embodiments, the macromolecular complex comprises an amount of a polyanion, wherein the amount of the polyanion is up to 15% of the weight of the dithiocarbamate fungicide. In some embodiments, the macromolecular complex comprises an amount of a polyanion, wherein the amount of the polyanion is up to 10% of the weight of the dithiocarbamate fungicide.

The present invention also provides a macromolecular complex comprising (i) a dithiocarbamate fungicide, (ii) a polyanion, and (iii) a polycation, wherein the weight ratio between the dithiocarbamate fungicide and the polyanion in the macromolecular complex is from 6:1 to 1000:1.

In some embodiments, the weight ratio between the dithiocarbamate fungicide and the polyanion is from 10:1 to 1000:1. In some embodiments, the weight ratio between the dithiocarbamate fungicide and the polyanion is from 25:1 to 1000:1. In some embodiments, the weight ratio between the dithiocarbamate fungicide and the polyanion is from 50:1 to 1000:1. In some embodiments, the weight ratio between the dithiocarbamate fungicide and the polyanion is from 100:1 to 1000:1.

In some embodiments, the dithiocarbamate fungicide is a dimethyldithiocarbamate such as ferbam (iron(III) dimethyldithiocarbamate), ziram (zinc dimethyldithiocarbamate), thiram (dimethylcarbamothioylsulfanyl-N,N-dimethyldithiocarbamate), propineb (zinc propylenebis(dithiocarbamate) and an ethylenebisdithiocarbamate.

A preferred dithiocarbamate is or comprises an ethylene bisdithiocarbamate (EBDC) such as sodium ethylenebisdithiocarbamate (nabam), zinc ammoniate ethylenebis(dithiocarbamate)-poly(ethylenethiuram disulfide) (metiram). A more preferred EBDC is in the form of a complex with manganese (maneb), zinc (zineb) or, most preferably, a combination of manganese and zinc (mancozeb; zinc; manganese(2+); N-[2-(sulfidocarbothioylamino)ethyl]carbamodithioate or [[2-[(dithiocarboxy)amino]ethyl]carbamodithioato(2-)-κS,κS′]manganese mixture with [[2-[(dithiocarboxy) amino]ethyl]carbamodithioato (2-)-κS,κS′]zinc). A preferred dithiocarbamate in a macromolecular complex of the invention is mancozeb.

In some embodiments, the dithiocarbamate fungicide is mancozeb.

In some embodiments, the dithiocarbamate fungicide is a mixture of two dithiocarbamates fungicides.

In some embodiments, the batch of dithiocarbamate fungicide is a mixture of the dithiocarbamate fungicide and at least one additive. In some embodiments, the batch of dithiocarbamate fungicide is a mixture of the dithiocarbamate fungicide and a stabilizer. In some embodiments, the stabilizer is a polyanion. In some embodiments, the stabilizer is lignosulfonate calcium. In some embodiments, the polyanion is sodium lignosulfonate. In some embodiments, the polyanion is calcium lignosulfonate.

Most dithiocarbamates fungicides such as mancozeb are hardly soluble in water. Mancozeb has a solubility at 20° C. of about 6.2 mg per liter. Present commercial formulations such as Dithane (Dow Agrosciences), and penncozeb (Elf Atochem) are formulated as water dispersible granules (WG) or wettable powders (WP), with high concentrations of mancozeb as active ingredient in the range of 70-80%. The present innovative formulations increase the solubility and/or dispersibility of a dithiocarbamate such as mancozeb and improve its biological efficacy. The net effect is that less dithiocarbamate fungicide is required to achieve control of agricultural pests, when compared to the same dithiocarbamate fungicide that is not complexed into a macromolecular complex.

In some embodiments, the weight ratio between the polycation and the dithiocarbamate fungicide is between 1:50 to 1:80. In some embodiments, the ratio between the polycation and the dithiocarbamate fungicide is between 1:60 to 1:70. In some embodiments, the ratio between the polycation and the dithiocarbamate fungicide is between 1:60 to 1:64.5. In some embodiments, the ratio between the polycation and the dithiocarbamate fungicide is 1:64.

In some embodiments, the weight ratio between the polycation and the mancozeb is between 1:50 to 1:80. In some embodiments, the weight ratio between the polycation and the mancozeb is between 1:60 to 1:70. In some embodiments, the weight ratio between the polycation and the mancozeb is between 1:60 to 1:64.5. In some embodiments, the weight ratio between the polycation and the mancozeb is 1:64.

In some embodiments, the polycation and the mancozeb has neutral zeta potential. In some embodiments, neutral zeta potential refers to ±5 Mv. In some embodiments, the zeta potential is measured in absence of additional acceptable agricultural additives.

In some embodiments, the zeta potential is measured in after preparing the macromolecular complex.

In some embodiments, the macromolecular complex is characterized by intermolecular, non-covalent interactions between the polycation and the dithiocarbamate fungicide. In some embodiments, the macromolecular complex is characterized by intermolecular, non-covalent interactions between donor and acceptor groups of the polycation and the dithiocarbamate fungicide.

In some embodiments, the intermolecular, non-covalent interactions are electrostatic interactions.

In some embodiments, the electrostatic interactions are ionic interactions, hydrogen bonds and van der Waals forces.

In some embodiments, the macromolecular complex is characterized by ionic interactions between donor and acceptor groups of the polycation and the dithiocarbamate fungicide. In some embodiments, the intermolecular, non-covalent interactions between the polycation and the dithiocarbamate fungicide are ionic interactions.

In some embodiments, the van der Waals forces are dipole-dipole interactions between the polycation and the dithiocarbamate fungicide.

A non-bioactive polycation preferably is or comprises cationic starch, poly(allylamine), chitosan, a chitosan derivative such as thiolated chitosan, 5-methyl-pyrrolidinone-chitosan, and chitosan oligosaccharide, epsilon-p-L-lysine, DEAE-dextran, or mixtures thereof, to form a macromolecular complex with a dithiocarbamate fungicide, preferably with mancozeb. Preferably, said non-bioactive polycation is selected from the group consisting of cationic starch, poly(allylamine), chitosan and chitosan derivatives. Preferably, said non-bioactive polycation is poly(allylamine). Preferably, said non-bioactive polycation is chitosan. In some embodiments, the polycation is chitosan (CTS), epsilon-poly-L-lysine (ϵ-PLL), poly allyl amine (PAA), or any combination thereof. In some embodiments, the polycation is chitosan (CTS). In some embodiments, the polycation is poly allyl amine (PAA). In some embodiments, the polycation is epsilon-poly-L-lysine (ϵ-PLL).

Preferred bioactive macromolecular complexes according to the invention comprising a dithiocarbamate fungicide are formed by chitosan or chitosan derivatives and mancozeb, poly(allylamine) and mancozeb, cationic starch and mancozeb, and/or DEAE-dextran and mancozeb. The electrostatic attraction between the protonated amino groups of the polycation and the negative charges of mancozeb is the main driving force in the formation of such macromolecular complexes. Preferred bioactive macromolecular complexes according to the invention comprising a bioactive ingredient are formed by chitosan and mancozeb. Preferred bioactive macromolecular complexes according to the invention comprising a bioactive ingredient are formed by poly(allylamine) (PAA) and mancozeb.

In some embodiments, the macromolecular complex comprises up to 1 part of polyanion per 6 parts of the dithiocarbamate fungicide by weight.

In some embodiments, the polyanion is a lignin compound.

In some embodiments, the lignin compound is lignosulfonate. In some embodiments, the lignin compound is sodium lignosulfonate. In some embodiments, the lignin compound is calcium lignosulfonate.

In some embodiments, the macromolecular complex is substantially free of polyanion. In some embodiments, the macromolecular complex is free of polyanion.

In some embodiments, the macromolecular complex has a particle size d50 of less than 30 microns. In some embodiments, the macromolecular complex has a particle size d50 of between 4-30 microns. In some embodiments, the macromolecular complex has a particle size d50 of less than 2 microns. In some embodiments, the macromolecular complex has a particle size d50 of 0.5-1.5 microns. In some embodiments, the macromolecular complex has a particle size d50 of 1-2 microns. In some embodiments, the macromolecular complex has a particle size d50 of 1 micron. In some embodiments, the macromolecular complex has a particle size d50 of 1.5 micron. In some embodiments, the macromolecular complex has a particle size d50 of 2 micron.

In some embodiments, the macromolecular complex has a particle size d90 of 1-15 microns. In some embodiments, the macromolecular complex has a particle size d90 of between 5-10 microns. In some embodiments, the macromolecular complex has a particle size d90 of 9-10 microns. In some embodiments, the macromolecular complex has a particle size d90 of 9.5 microns. In some embodiments, the macromolecular complex has a particle size d90 of between 1-7 microns. In some embodiments, the macromolecular complex has a particle size d90 of between 3-5. microns. In some embodiments, the macromolecular complex has a particle size d90 of 4 microns. In some embodiments, the macromolecular complex has a particle size d90 of between 2-5 microns. In some embodiments, the macromolecular complex has a particle size d90 of 2-3 microns. In some embodiments, the macromolecular complex has a particle size d90 of 3.5 microns. In some embodiments, the macromolecular complex has a particle size d90 of 3 microns. In some embodiments, the macromolecular complex has a particle size d90 of 1-2 microns. In some embodiments, the macromolecular complex has a particle size d90 of 1.7 microns.

The particle size described herein is volume-based.

In some embodiments, the particle size is measured using laser diffraction.

In some embodiments, the polyelectrolyte is a polycation. In some embodiments, the polyelectrolyte is a polyanion.

Said polyelectrolyte and the dithiocarbamate fungicide are preferably present in a macromolecular complex of the invention in a ratio between 1:5 and 1:100 (w/w), more preferred in a ratio between 1:6 and 1:100, more preferred in a ratio between 1:10 and 1:90, more preferred in a ratio between 1:20 and 1:80 (w/w), such as between 1:50 and 1:70.

The molar ratio between the dithiocarbamate fungicide and the polyelectrolyte preferably is between 300:1 and 5:1, such as between 200:1 and 140:1 and between 100:1 and 10:1 such as 30:1.

In some embodiments, the macromolecular complex comprises the polycation and the dithiocarbamate fungicide in a ratio between 1:5 and 1:300 (w/w).

In some embodiments, the macromolecular complex comprises the polycation and the dithiocarbamate fungicide in a ratio between 1:60 and 1:70 (w/w).

In some embodiments, the macromolecular complex between the polycation and the dithiocarbamate fungicide is in an aqueous solution.

In some embodiments, the polycation and the dithiocarbamate fungicide are mixed in an aqueous solution to from the macromolecular complex.

Said mixing preferably is performed under slightly acidic conditions. The positively charged polycations interact electrostatically with the dithiocarbamate fungicide to form a macromolecular complex.

In some embodiments, the macromolecular complex is made by pre-mixing the polycation and the dithiocarbamate fungicide prior to addition of the polyanion.

In some embodiments, the macromolecular complex is made by adding the polycation to a pre-mix of the dithiocarbamate fungicide and the polyanion.

In some embodiments, the pre-mix of the dithiocarbamate fungicide and the polyanion contains up to 1 part of polyanion per 6 parts of the dithiocarbamate fungicide. In some embodiments, the pre-mix of the dithiocarbamate fungicide and the polyanion contains up to 1 part of polyanion per 8 parts of the dithiocarbamate fungicide. In some embodiments, the pre-mix of the dithiocarbamate fungicide and the polyanion contains up to 1 part of polyanion per 10 parts of the dithiocarbamate fungicide. In some embodiments, the pre-mix of the dithiocarbamate fungicide and the polyanion contains up to 1 part of polyanion per 20 parts of the dithiocarbamate fungicide. In some embodiments, the pre-mix of the dithiocarbamate fungicide and the polyanion contains up to 1 part of polyanion per 25 parts of the dithiocarbamate fungicide. In some embodiments, the pre-mix of the dithiocarbamate fungicide and the polyanion contains up to 1 part of polyanion per 50 parts of the dithiocarbamate fungicide. In some embodiments, the pre-mix of the dithiocarbamate fungicide and the polyanion contains up to 1 part of polyanion per 100 parts of the dithiocarbamate fungicide. In some embodiments, the pre-mix of the dithiocarbamate fungicide and the polyanion contains up to 1 part of polyanion per 1000 parts of the dithiocarbamate fungicide.

Thus, the present invention also provides a macromolecular complex comprising (i) a dithiocarbamate fungicide, (ii) a polycation, and (iii) a polyanion, wherein the macromolecular complex has any one or any combination of the following features:
a. the macromolecular complex is characterized by intermolecular, non-covalent interactions between the polycation and the dithiocarbamate fungicide, and wherein the macromolecular complex has more intermolecular, non-covalent interactions between the polycation and the dithiocarbamate fungicide compared to a macromolecular complex comprising the same type and amount of polycation, polyanion and dithiocarbamate fungicide made by pre-mixing the polycation and the polyanion to form a polyelectrolyte matrix prior to addition of the dithiocarbamate fungicide,
b. an aqueous solution comprising the macromolecular complex comprises more zinc and/or magnesium ions compared to an aqueous solution of a macromolecular complex comprising the same type and amount of polycation, polyanion and dithiocarbamate fungicide made by pre-mixing the polycation and the polyanion to form a polyelectrolyte matrix prior to addition of the dithiocarbamate fungicide,
c. the macromolecular complex has improved leaf adhesion compared to a macromolecular complex comprising the same type and amount of polycation, polyanion and dithiocarbamate fungicide made by pre-mixing the polycation and the polyanion to form a polyelectrolyte matrix prior to addition of the dithiocarbamate fungicide,
d. the macromolecular complex has improved rainfastness compared to a macromolecular complex comprising the same type and amount of polycation, polyanion and dithiocarbamate fungicide made by pre-mixing the polycation and the polyanion to form a polyclectrolyte matrix prior to addition of the dithiocarbamate fungicide,
e. the macromolecular complex has decreased drift compared to a macromolecular complex comprising the same type and amount polycation, polyanion and dithiocarbamate fungicide made by pre-mixing the polycation and the polyanion to form a polyelectrolyte matrix prior to addition of the dithiocarbamate fungicide,
f. the macromolecular complex is more fungicidally effective compared to a macromolecular complex comprising the same type and amount of polycation, polyanion and dithiocarbamate fungicide made by pre-mixing the polycation and the polyanion to form a polyelectrolyte matrix prior to addition of the dithiocarbamate fungicide when the dithiocarbamate fungicide is applied at the same amount.
g. the macromolecular complex has the same fungicidal efficacy compared to a macromolecular complex comprising the same type and amount of polycation, polyanion and dithiocarbamate fungicide made by pre-mixing the polycation and the polyanion to form a polyelectrolyte matrix prior to addition of the dithiocarbamate fungicide when the dithiocarbamate fungicide is applied at a lower amount, and
h. the macromolecular complex has increased bioavailability compared to a macromolecular complex comprising the same type and amount of polycation, polyanion and dithiocarbamate fungicide made by pre-mixing the polycation and the polyanion to form a polyelectrolyte matrix prior to addition of the dithiocarbamate fungicide.

In some embodiments, the amount of intermolecular, non-covalent interactions between the polycation and the dithiocarbamate fungicide is determined using metal analysis. In some embodiments, the amount of intermolecular, non-covalent interactions between the polycation and the dithiocarbamate fungicide is determined by measuring the displaced magnesium ions and zinc ions in the aqueous solution after the polycation ion and the dithiocarbamate are combined to form the macromolecular complex.

### 4.3 Compositions

A composition according to the invention further has improved physical properties, different morphology and particle size, as demonstrated for example by electron microscopy, when compared to a free dithiocarbamate fungicide, preferably mancozeb.

The present invention also provides a composition comprising a macromolecular complex according to the invention.

The present invention also provides a composition comprising a macromolecular complex, wherein the macromolecular complex comprises (i) a dithiocarbamate fungicide and (ii) a polycation. Said macromolecular complex preferably comprises (i) mancozeb and (ii) a polycation.

A composition according to the invention preferably is in the form of a suspension concentrate (SC), a water dispersible granule (WG), a wettable powder (WP), a dispersion concentrate (DC), a dry powder seed treatment (DS), a water slurriable powder (WS), or a flowable seed treatment (FS). Preferably, a composition of the invention is in the form of a suspension concentrate, or in the form of water dispersible granules. A most preferred composition is a suspension concentrate.

The concentration of a polyelectrolyte in a composition according to the invention is preferably between 0.1 and 100 g/kg. In some embodiments, the concentration of the polycation in the composition is between 0.1 and 100 g/kg.

In some preferred embodiments, the concentration of the macromolecular complex in a composition is between 1 and 50 g/kg, more preferred between 5 and 15 g/kg.

The concentration of the polyelectrolyte in a composition according to the invention is preferably 0.01-10% by weight based on the total weight of the stable composition, more preferably 0.1-5% by weight based on the total weight of the stable composition, such as 0.5-1.5% by weight based on the total weight of the stable composition.

In some embodiments, the concentration of the polycation in the composition is 0.01-10% by weight based on the total weight of the composition. In some embodiments, the concentration of the polycation in the composition is 0.1-5% by weight based on the total weight of the composition. In some embodiments, the concentration of the polycation in the composition is 0.1-1.5% by weight based on the total weight of the composition. In some embodiments, the concentration of the polycation in the composition is 0.1-1% by weight based on the total weight of the composition. In some embodiments, the concentration of the polycation in the composition is about 0.5% by weight based on the total weight of the composition. In some embodiments, the concentration of chitosan in the composition is about 0.5% by weight based on the total weight of the composition. In some embodiments, the concentration of the polycation in the composition is about 1% by weight based on the total weight of the composition. In some embodiments, the concentration of PAA in the composition is about 1% by weight based on the total weight of the composition.

The concentration of the dithiocarbamate fungicide in a composition according to the invention is preferably between 10 and 1000 g/L, more preferred between 100 and 500 g/L such as between 300 and 400 g/L. In some embodiments, the concentration of the dithiocarbamate fungicide in the composition is between 350 and 450 g/L. In some embodiments, the concentration of the dithiocarbamate fungicide in the composition is about 360 g/L. In some embodiments, the concentration of the dithiocarbamate fungicide in the composition is about 390-420 g/L. In some embodiments, the concentration of the dithiocarbamate fungicide in the composition is between 350 and 450 g/L.

The concentration of the dithiocarbamate fungicide in a composition according to the invention preferably is 10-80% by weight based on the total weight of the composition, more preferably 10-50% by weight based on the total weight of the composition, such as 25-40% by weight based on the total weight of the stable composition.

In some embodiments, the concentration of the dithiocarbamate fungicide in the composition is 30-45% by weight based on the total weight of the composition. In some embodiments, the concentration of the dithiocarbamate fungicide in the composition is 30-40% by weight based on the total weight of the composition. In some embodiments, the concentration of the dithiocarbamate fungicide in the composition is 30-35% by weight based on the total weight of the composition. In some embodiments, the concentration of the dithiocarbamate fungicide in the composition is 35-40% by weight based on the total weight of the composition. In some embodiments, the concentration of the dithiocarbamate fungicide in the composition is 40-45% by weight based on the total weight of the composition. In some embodiments, the concentration of the dithiocarbamate fungicide in the composition is about 30% by weight based on the total weight of the composition. In some embodiments, the concentration of the dithiocarbamate fungicide in the composition is about 35% by weight based on the total weight of the composition. In some embodiments, the concentration of the dithiocarbamate fungicide in the composition is about 40% by weight based on the total weight of the composition. In some embodiments, the concentration of the dithiocarbamate fungicide in the composition is about 45% by weight based on the total weight of the composition.

In some embodiments, the concentration of the dithiocarbamate fungicide is up to 45% by weight based on the total weight of the composition.

In some embodiments, the concentration of the dithiocarbamate fungicide is more than 30% by weight based on the total weight of the composition.

In some embodiments, the concentration of the dithiocarbamate fungicide is between 30-45% by weight based on the total weight of the composition.

In some embodiments, the concentration of the dithiocarbamate fungicide in the composition comprises a is between 350 and 450 g/L.

In some embodiments, the weight ratio between the polycation and the dithiocarbamate fungicide is between 1:50 to 1:80. In some embodiments, the ratio between the polycation and the dithiocarbamate fungicide is between 1:60 to 1:70. In some embodiments, the ratio between the polycation and the dithiocarbamate fungicide is between 1:60 to 1:64.5. In some embodiments, the ratio between the polycation and the dithiocarbamate fungicide is 1:64.

In some embodiments, the weight ratio between the polycation and the mancozeb is between 1:50 to 1:80. In some embodiments, the ratio between the polycation and the mancozeb is between 1:60 to 1:70. In some embodiments, the ratio between the polycation and the mancozeb is between 1:60 to 1:64.5. In some embodiments, the ratio between the polycation and the mancozeb is 1:64.

In some embodiments, an aqueous composition comprising the polycation and the dithiocarbamate fungicide has neutral zeta potential, where neutral zeta potential refers to 0 mv±5 mv.

In some embodiments, the polycation and the mancozeb has neutral zeta potential. In some embodiments, neutral zeta potential refers to ±5 mv.

In some embodiments, the composition comprises a macromolecular complex according to the invention and at least one agriculturally acceptable additive. The addition of an additive affects the chemically and physically stability of the compositions. Said additives may, for example, improve the stability of the composition.

In some embodiments, the additive is selected from buffers, acidifiers, defoaming agents, thickeners, drift retardants, surfactant, pigments, wetting agents, safeners, and preservatives. Said additives include, but are not limited to, surfactants, pigments, wetting agents, as well as safeners, or such preservatives as bacteriostats or bactericides.

In some embodiments, agriculturally acceptable additive may include but is not limited to surfactants, wetting agent, antifoams, solvents, co-solvent, light stabilizers, UV absorbers, radical scavengers and antioxidants, adhesives, neutralizers, thickeners, binders, sequestrates, biocides, buffers preservatives, and anti-freeze agents.

In some embodiments, the agriculturally acceptable additive is an agriculturally acceptable carrier. In some embodiments, the composition comprises at least one agriculturally acceptable carrier.

Said agriculturally acceptable carrier preferably includes a stabilizer, a wetting agent, a dispersant, an antifreezing agent, an antifoaming agent and/or a thickening agent. The addition of small amounts of one or more agriculturally acceptable carriers may affect parameters such as stability, efficacy and/or rainfastness of a composition according to the invention. The addition of small amounts of one or more agriculturally acceptable carriers preferably increases stability, efficacy and/or rainfastness of a composition according to the invention.

In some embodiments, the agriculturally acceptable carrier is water.

In some embodiments, the composition comprises 40-80% by weight of water. In some embodiments, the composition comprises 50-70% by weight of water. In some embodiments, the composition comprises 50-55% by weight of water. In some embodiments, the composition comprises 40-80% by weight of water. In some embodiments, the composition comprises about 51% by weight of water. In some embodiments, the composition comprises about 62% by weight of water.

In some embodiments, the composition is an aqueous composition. In some embodiments, the composition comprising any one of the macromolecular complexes described herein is an aqueous composition. The present invention also provides an aqueous composition comprising any one or any combination of the macromolecular complexes described herein

The present invention also provides an aqueous composition comprising any one or any combination of the macromolecular complexes described herein, water and agriculturally acceptable additive.

In some embodiments, the concentration of the dithiocarbamate in the aqueous composition is more than 30% by weight based on the total weight of the composition and the composition further comprises a stabilizer.

In some embodiments, the concentration of the dithiocarbamate in the aqueous composition is more than 30% by weight based on the total weight of the composition, the dispersant is sodium lignosulfonate and the composition further comprises a stabilizer.

In some embodiments, the concentration of mancozeb in the aqueous composition is more than 30% by weight based on the total weight of the composition and the composition further comprises a stabilizer.

In some embodiments, the concentration of mancozeb in the aqueous composition is more than 30% by weight based on the total weight of the composition, the dispersant is sodium lignosulfonate and the composition further comprises a stabilizer.

In some embodiments, an acid is used to obtain solubilized polycation.

In some embodiments, the acid is a C1-C6 carboxylic acid.

In some embodiments, the acid has a pKa lower than 5.

The acid may be, but is not limited to, acetic acid, lactic acid or citric acid. In some embodiments, the acid is selected from the group consisting of acetic acid, lactic acid, citric acid and any combination thereof.

The present invention also provides an aqueous composition comprising (1) macromolecular complex comprising (i) a dithiocarbamate fungicide, (ii) a polycation, (2) water, and (3) at least one agriculturally acceptable additive.

In some embodiments, the agriculturally acceptable additive is dispersant. In some embodiments, the composition comprises at least one dispersant.

A dispersant, when present, is preferably selected from Morwet® D425, lignin sulphonate, an alkylpolysaccharide, a styrene acrylic polymer, an acrylic co-polymer and ethoxylated tristyrenephenol phosphate, for example polyethoxylated fosforic acid. A composition of the invention may also comprise two or more different dispersants. A dispersant is preferably present in an amount of between 0 to up to 10% (w/v), more preferred between 0.01 to up to 5% (w/v), more preferred between 0.02 to up to 1% (w/v), more preferred about 0.05% (w/v).

In some embodiments, the dispersant is a modified acrylic polymer, non-modified acrylic acid, sulfonate polymer or any combination thereof.

In some embodiments, the modified acrylic polymer is modified styrene acrylic acid, polymethyl methacrylate-polyethylene glycol graft copolymer or any combination thereof. In some embodiments, modified acrylic polymer is modified styrene acrylic polymer. In some embodiments, the modified styrene acrylic polymer is Atlox Metasperse™ 500L (sold by Croda). In some embodiments, the modified acrylic polymer is polymethyl methacrylate-polyethylene glycol graft copolymer. In some embodiments, the polymethyl methacrylate-polyethlene glycol graft copolymer is Atlox™ 4913 (sold by Croda).

In some embodiments, the sulfonate polymer is lignin, sodium lignosulfonate calcium lignosulfonate and combination thereof. In some embodiments, the sulfonate polymer is sodium salt of naphthalene sulfonate condensate. In some embodiments, the sodium salt of naphthalene sulfonate condensate is Morwet D-425 (sold by Nouryon).

In some embodiments, the dispersant is sulfonate polymer.

In some embodiments, the sulfonate polymer is lignin.

In some embodiments, the dispersant is lignosulfonate, a modified acrylic polymer or a combination thereof.

In some embodiments, the dispersant is lignosulfonate.

In some embodiments, the dispersant is sodium lignosulfonate.

In some embodiments, lignosulfonate is part of the macromolecular complex and lignosulfonate is the dispersant.

In some embodiments, the concentration of the dispersant in the composition is 0-15% by weight based on the total weight of the composition.

In some embodiments, the concentration of the dispersant in the composition is 0-12% by weight based on the total weight of the composition. In some embodiments, the concentration of the dispersant in the composition is 1-12% by weight based on the total weight of the composition. In some embodiments, the concentration of the dispersant in the composition is 0-10% by weight based on the total weight of the composition. In some embodiments, the concentration of the dispersant in the composition is 1-5% by weight based on the total weight of the composition. In some embodiments, the concentration of the dispersant in the composition is 5-10% by weight based on the total weight of the composition. In some embodiments, the concentration of the dispersant is about 5% by weight based on the total weight of the composition. In some embodiments, the concentration of the dispersant is about 6% by weight based on the total weight of the composition. In some embodiments, the concentration of the dispersant is about 7% by weight based on the total weight of the composition. In some embodiments, the concentration of the dispersant is about 8% by weight based on the total weight of the composition. In some embodiments, the concentration of the dispersant is about 9% by weight based on the total weight of the composition. In some embodiments, the concentration of the dispersant is about 10% by weight based on the total weight of the composition.

In some embodiments, the dispersant is lignosulfonate.

In some embodiments, the concentration of the lignosulfonate in the composition is 0-12% by weight based on the total weight of the composition. In some embodiments, the concentration of the lignosulfonate in the composition is 1-12% by weight based on the total weight of the composition. In some embodiments, the concentration of the lignosulfonate in the composition is 0-10% by weight based on the total weight of the composition. In some embodiments, the concentration of the lignosulfonate in the composition is 1-5% by weight based on the total weight of the composition. In some embodiments, the concentration of the lignosulfonate in the composition is 5-10% by weight based on the total weight of the composition. In some embodiments, the concentration of the lignosulfonate is about 5% by weight based on the total weight of the composition. In some embodiments, the concentration of the lignosulfonate is about 6% by weight based on the total weight of the composition. In some embodiments, the concentration of the lignosulfonate is about 7% by weight based on the total weight of the composition. In some embodiments, the concentration of the lignosulfonate is about 8% by weight based on the total weight of the composition. In some embodiments, the concentration of the lignosulfonate is about 9% by weight based on the total weight of the composition. In some embodiments, the concentration of the lignosulfonate is about 10% by weight based on the total weight of the composition.

A composition according to the invention may further comprise at least one pH adjuster or buffering agent such as organic or inorganic bases and/or organic or inorganic acids.

In some embodiments, the composition comprises one or more physical stabilizers such as buffers, acidifiers, defoaming agents, thickeners and drift retardants.

In some embodiments, the composition comprises at least one stabilizer. In some embodiments, the agriculturally acceptable additive is a stabilizer.

A stabilizer, when present, is preferably selected from carboxylic acids such as citric acid, acetic acid, and/or dodecylbenzensulfonic acid, orthophosphoric acid dodecylbenzensulfonic acid and suitable salts thereof. A composition of the invention may also comprise two or more different stabilizers. A stabilizer is preferably present in an amount of between 0 to up to 10% (w/v), more preferred between 0.01 to up to 5% (w/v), more preferred between 0.02 to up to 1% (w/v), more preferred about 0.05% (w/v).

In some embodiments, the stabilizer is an acid. In some embodiments, the acid is acetic acid. Acids are used to obtains dissolution of some polycation. For example, chitosan is an aminoglycan consisting of beta-(1right4)-linked D-glucosamine residues. In acidic environment, global protonation of the 2-amino groups creates cationic chitosan.

In some embodiments, the concentration of the acid in the composition is 0-5% by weight based on the total weight of the composition. In some embodiments, the concentration of the acid in the composition is 0.01-5% by weight based on the total weight of the composition. In some embodiments, the concentration of the acid in the composition is 0.1-0.5% by weight based on the total weight of the composition. In some embodiments, the concentration of the acid in the composition is about 0.3% by weight based on the total weight of the composition. In some embodiments, the concentration of the acid in the composition is 1-3% by weight based on the total weight of the composition. In some embodiments, the concentration of the acid in the composition is 1.5-2% by weight based on the total weight of the composition.

In some embodiments, the composition comprises at least one anti-foam agent. In some embodiments, the agriculturally acceptable additive is an anti-foam agent.

An anti-foam agent, when present, is preferably selected from polymethylsiloxane, polydimethylsiloxane, simethicone octanol, and silicone oils. A composition of the invention may also comprise two or more different anti-foam agents. An anti-foam agent is preferably present in an amount of between 0 to up to 10% (w/v), more preferred between 0.05 to up to 5% (w/v), more preferred between 0.1 to up to 1% (w/v), more preferred about 0.05% (w/v).

In some embodiments, the anti-foam agent is silicone-based.

In some embodiments, the concentration of the anti-foam forming agent is 0.01-5% by weight based on the total weight of the composition. In some embodiments, the concentration of the anti-foam forming agent is 0.1-1% by weight based on the total weight of the composition. In some embodiments, the concentration of the anti-foam forming agent is about 0.4% by weight based on the total weight of the composition. In some embodiments, the concentration of the anti-foam forming agent is about 0.5% by weight based on the total weight of the composition.

In some embodiments, the composition comprises at least one antifreezing agent. In some embodiments, the agriculturally acceptable additive is an antifreezing agent.

An antifreezing agent, when present, is preferably selected from glycerine, ethylene glycol, hexyleneglycol and propylene glycol. A composition of the invention may also comprise two or more different antifreezing agents. An antifreezing agent is preferably present in an amount of between 0 to up to 10% (w/v), more preferred between 0.01 to up to 5% (w/v), more preferred between 0.02 to up to 1% (w/v), more preferred about 0.05% (w/v).

In some embodiments, the antifreezing agent is propylene glycol.

In some embodiments, the concentration of the antifreezing agent in the composition is 1-10% by weight based on the total weight of the composition. In some embodiments, the concentration of the antifreezing agent in the composition is 1-5% by weight based on the total weight of the composition. In some embodiments, the concentration of the antifreezing agent in the composition is about 4% by weight based on the total weight of the composition. In some embodiments, the concentration of the antifreezing agent in the composition is about 5% by weight based on the total weight of the composition.

In some embodiments, the composition comprises at least one surfactant. In some embodiments, the agriculturally acceptable additive is a surfactant.

Surfactants may include but arc not limited to ionic or non-ionic surface active agents. Examples of surfactants are alkyl-end-capped ethoxylate glycol, alkyl-end-capped alkyl block alkoxylate glycol, dialkyl sulfosuccinate, phosphated esters, alkyl sulfonates, alkyl aryl sulfonates, tristyrylphenol alkoxylates, natural or synthetic fatty acid alkoxylates, natural or synthetic fatty alcohols alkoxylates, alkoxylated alcohols (such as n-butyl alcohol poly glycol ether), block copolymers (such as ethylene oxide-propylene oxide block copolymers and ethylene oxide-butylene oxide block copolymers) or combinations thereof.

Examples of surfactants include but is not limited to dispersants, emulsifiers, wetting agents.

In some embodiments, the surfactant is a non-ionic surfactant.

In some embodiments, the concentration of the surfactant in the composition is 0-0.5% by weight based on the total weight of the composition. In some embodiments, the concentration of the surfactant in the composition is 0.001-0.5% by weight based on the total weight of the composition. In some embodiments, the concentration of the surfactant in the composition is 0.01-1% by weight based on the total weight of the composition. In some embodiments, the concentration of the surfactant in the composition is about 0.1% by weight based on the total weight of the composition.

In some embodiments, the surfactant is a non-ionic hydrocarbon-based surfactant.

In some embodiments, the concentration of the non-ionic hydrocarbon-based surfactant in the composition is 0.001-0.5% by weight based on the total weight of the composition. In some embodiments, the concentration of the non-ionic hydrocarbon-based surfactant in the composition is about 0.1% by weight based on the total weight of the composition. In some embodiments, the concentration of the non-ionic hydrocarbon-based surfactant in the composition is 0.001-0.1% by weight based on the total weight of the composition.

In some embodiments, the surfactant is not castor oil, ethoxylated (PEG-26 Castor Oil). In some embodiments, the surfactant is not tristyryphenol ethoxylate sulfate.

In some embodiments, the concentration of the surfactant in the composition is 2-5% w/w by weight based on the total weight of the total composition.

In some embodiments, when the polycation is chitosan, the composition further comprises a co-solvent. In some embodiments, the co-solvent is propylene glycol. In some embodiments, wherein the surfactant is anionic, the surfactant is added after the polycation is mixed with the dithiocarbamate fungicide. In some embodiments, wherein the surfactant is anionic, the surfactant is added to the polycation in parallel to the dithiocarbamate fungicide. In some embodiments, wherein the surfactant is nonionic, the surfactant can be added at any stage of the formulating process.

In some embodiments, wherein the composition comprises at least one wetting agent. In some embodiments, the agriculturally acceptable additive is a wetting agent.

A wetting agent, when present, is preferably selected from di-octylsuccinate, polyoxyethylene/polypropylene and tri-stearyl sulphonate/phosphate. A composition of the invention may also comprise two or more different wetting agents. A wetting agent is preferably present in an amount of between 0 to up to 10% (w/v), more preferred between 0.01 to up to 5% (w/v), more preferred between 0.02 to up to 1% (w/v), more preferred about 0.05% (w/v).

In some embodiments, the wetting agent is polyalkylene oxide block copolymer. In some embodiments, the wetting agent is butyl block copolymer. In some embodiments, the butyl block copolymer is Atlas™ G5002L (sold by Croda).

In some embodiments, the concentration of the wetting agent in the composition is 1-10% by weight based on the total weight of the composition. In some embodiments, the concentration of the wetting agent in the composition is 0-5% by weight based on the total weight of the composition. In some embodiments, the concentration of the wetting agent in the composition is 1-5% by weight based on the total weight of the composition. In some embodiments, the concentration of the wetting agent in the composition is 1-3% by weight based on the total weight of the composition. In some embodiments, the concentration of the wetting agent in the composition is about 2% by weight based on the total weight of the composition.

In some embodiments, the composition comprises at least one rheology modifier. In some embodiments, the agriculturally acceptable additive is a rheology modifier.

In some embodiments, the rheology modifier is a thickener. In some embodiments, the composition comprises at least one thickener.

A thickening agent, when present, is preferably selected from agar, alginic acid, alginate, carrageenan, gellan gum, xanthan gum, succinoglycan gum, guar gum, acetylated distarch adipate, acetylated oxidised starch, arabinogalactan, ethyl cellulose, methyl cellulose, locust bean gum, starch sodium octenylsuccinate, and triethyl citrate. A composition of the invention may also comprise two or more different thickening agents. A thickening agent is preferably present in an amount of between 0 to up to 10% (w/v), more preferred between 0.01 to up to 5% (w/v), more preferred between 0.02 to up to 1% (w/v), more preferred about 0.05% (w/v).

In some embodiments, the thickener is xanthan gum.

In some embodiments, the rheology modifier is Rhodopol® 23 (sold by Solvay). In some embodiments, the rheology modifier is xanthan gum.

In some embodiments, the concentration of the rheology modifier in the composition is 0.01-10% by weight based on the total weight of the composition. In some embodiments, the concentration of the rheology modifier in the composition is 1-6% by weight based on the total weight of the composition. In some embodiments, the concentration of the rheology modifier in the composition is 2-5% by weight based on the total weight of the composition. In some embodiments, the concentration of the rheology modifier in the composition is about 2.5% by weight based on the total weight of the composition. In some embodiments, the concentration of the rheology modifier in the composition is about 5% by weight based on the total weight of the composition.

In some embodiments, the composition comprises at least one thickener and at least one biocide. In some embodiments, the amount of the thickener and the biocide in the composition is up to 1% by weight based on the total weight of the composition.

In some embodiments, the agriculturally acceptable additive is a preservative. In some embodiments, the composition comprises at least one preservative.

In some embodiments, the preservative is a biocide. In some embodiments, the composition comprises at least one biocide.

In some embodiments, the concentration of the preservative in the composition is 0.01-5% by weight based on the total weight of the composition. In some embodiments, the concentration of the preservative in the composition is 0.01-1% by weight based on the total weight of the composition. In some embodiments, the concentration of the preservative in the composition is about 0.1% by weight based on the total weight of the composition.

In some embodiments, the composition comprises at least one additional bioactive ingredient, preferably an additional insecticide, fungicide and/or herbicide.

In some embodiments, the composition is substantially free of an agriculturally acceptable organic solvent. In some embodiments, the composition is aqueous.

In some embodiments, the composition is a suspension concentrate.

In some embodiments, the suspension concentrate composition comprises:
a. 3045% w/w of mancozeb,
b. 0.1-1% w/w of chitosan,
c. 0-10% w/w of lignosulfonate,
d. 0-0.5% w/w of a non-ionic hydrocarbon-based surfactant,
e. 1-10% w/w of a propylene glycol,
f. 0-5% w/w of at least one acid,
g. 0.1-1% w/w of silicone-based anti-foam agent,
h. 0.01-1% w/w of a biocide,
i. 0-5% w/w of a modified styrene acrylic polymer,
j. 0-5% w/w of a polyalkylene oxide block copolymer,
k. 1-10% w/w of a rheology modifier, and
l. 50-70% w/w of water.

In some embodiments, the suspension concentrate comprises:
a. 35% w/w of mancozeb.
b. 0.5% w/w of chitosan,
c. 4.2% w/w of propylene glycol.
d. 0.4% w/w of silicone-based anti-foam agent,
e. 2% w/W of a modified styrene acrylic polymer,
f. 2% w/w of a polyalkylene oxide block copolymer,
g. 0.083% w/w of a biocide,
h. 5% w/w of a rheology modifier, and
i. 51% w/w of water.

In some embodiments, the suspension concentrate comprises:
a. 40.7% w/v of mancozeb,
b. 0.64% w/v of chitosan,
c. 7.62% w/v of sodium lignosulfonate,
d. 0.38% w/v of acetic acid,
e. 0.51% w/v of silicone-based anti-foam agent,
f. 5.33 w/v of propylene glycol,
g. 0.1 w/v of a biocide.
h. 2.54% w/v of a rheology modifier, and
i. 62.99% w/v of water.

In some embodiments, the suspension concentrate comprises:
a. 40.7% w/v of mancozeb,
b. 0.64% w/v of chitosan,
c. 0.13% w/v of a non-ionic hydrocarbon-based surfactant,
d. 7.62% w/v of sodium lignosulfonate,
e. 0.38% w/v of acetic acid,
f. 0.51% w/v of silicone-based anti-foam agent,
g. 5.33 w/v of propylene glycol,
h. 0.1 w/v of a biocide,
i. 2.54% w/v a rheology modifier, and
j. 62.86% w/v of water.

In some embodiments, the suspension concentrate comprises:
a. 37% w/w of mancozeb tech.,
b. 0.5% w/w of chitosan,
c. 6.0% w/w of sodium lignosulfonate,
d. 0.3% w/w of acetic acid,
e. 0.4% w/w of silicone-based anti-foam agent,
f. 4.2% w/w of propylene glycol,
g. 0.1% w/w of a biocide,
h. 0.04% w/w of a rheology modifier (100% solid undiluted basis), and
i. 51.56% w/w of water.

In some embodiments, the suspension concentrate comprises:
a. 37% w/w of mancozeb tech.,
b. 0.5% w/w of chitosan,
c. 0.1% w/w of a non-ionic hydrocarbon-based surfactant,
d. 6.0% w/w of sodium lignosulfonate,
e. 0.3% w/w of acetic acid.
f. 0.4% w/w of silicone-based anti-foam agent,
g. 4.2% w/w of propylene glycol,
h. 0.1% w/w of a biocide,
i. 0.04% w/w a rheology modifier (100% solid undiluted basis), and
j. 51.46% w/w of water.

Mancozeb tech, available commercially contains mancozeb and inert additives. In some embodiments, the mancozeb tech. contains 86.7% w/w of mancozeb. When the mancozeb tech. contains 86.7% w/w of mancozeb and the composition comprises a 37% w/w of mancozeb tech., the composition comprises 32% w/w of mancozeb.

The invention also provides a pesticidal delivery system comprising any one of any combination of the macromolecular complexes described herein.

The present invention provides a concentrate composition comprising a (1) a macromolecular complex comprising (i) a dithiocarbamate fungicide and (ii) a polycation, and (2) an aqueous carrier.

The present invention also provides a suspension concentrate comprising (1) a macromolecular complex comprising (i) a dithiocarbamate fungicide and (ii) a polycation, and (2) an aqueous carrier.

The present invention also provides a composition comprising a macromolecular complex comprising (i) a dithiocarbamate fungicide, (ii) a polycation, and (iii) less than 4% by weight of a polyanion based on the total weight of the composition.

In some embodiments, the dithiocarbamate fungicide is mancozeb. In some embodiments, the polycation is chitosan. In some embodiments, the polycation is PAA. In some embodiments, the polyanion is lignosulfonate.

In some embodiments, the concentration of the polyanion in the composition is less than 3% by weight based on the total weight of the composition. In some embodiments, the concentration of the polyanion in the composition is less than 2.5% by weight based on the total weight of the composition. In some embodiments, the concentration of the polyanion in the composition is less than 2% by weight based on the total weight of the composition. In some embodiments, the concentration of the polyanion in the composition is less than 1.5% by weight based on the total weight of the composition. In some embodiments, the concentration of the polyanion in the composition is less than 1% by weight based on the total weight of the composition. In some embodiments, the concentration of the polyanion in the composition is less than 0.5% by weight based on the total weight of the composition. In some embodiments, the composition is free of polyanion.

A composition according to the invention provides a stable aqueous suspension comprising a high concentration of a dithiocarbamate fungicide, preferably mancozeb, up to about 45% (w/v), with improved fungicidal activity compared to commercially available formulations of said dithiocarbamate fungicide, in the presence of relatively low amounts of adjuvants as agriculturally acceptable carriers.

In some embodiments, the macromolecular complex is made by pre-mixing the polycation and the dithiocarbamate fungicide prior to addition of the polyanion.

In some embodiments, the macromolecular complex is made by adding the polycation to a pre-mix of the dithiocarbamate fungicide and the polyanion.

In some embodiments, the pre-mix of the dithiocarbamate fungicide and the polyanion contains up to 1 part of polyanion per 6 parts of dithiocarbamate fungicide. In some embodiments, the pre-mix of the dithiocarbamate fungicide and the polyanion contains up to 1 part of polyanion per 8 parts of dithiocarbamate fungicide. In some embodiments, the pre-mix of the dithiocarbamate fungicide and the polyanion contains up to 1 part of polyanion per 10 parts of dithiocarbamate fungicide. In some embodiments, the pre-mix of the dithiocarbamate fungicide and the polyanion contains up to 1 part of polyanion per 20 parts of dithiocarbamate fungicide. In some embodiments, the pre-mix of the dithiocarbamate fungicide and the polyanion contains up to 1 part of polyanion per 50 parts of dithiocarbamate fungicide. In some embodiments, the pre-mix of the dithiocarbamate fungicide and the polyanion contains up to 1 part of polyanion per 100 parts of dithiocarbamate fungicide. In some embodiments, the pre-mix of the dithiocarbamate fungicide and the polyanion contains up to 1 part of polyanion per 1000 parts of dithiocarbamate fungicide.

In some embodiments, the composition comprises a polyanion. In some embodiments, the polyanion is used as dispersant.

The present invention also provides a composition comprising (i) a macromolecular complex comprising a dithiocarbamate fungicide, a polycation, and a polyanion, wherein the macromolecular complex is characterized by intermolecular, non-covalent interactions between the polycation and the dithiocarbamate, and (ii) at least one agriculturally acceptable additive, wherein the composition has any one or any combination of the following features:
a. the composition has improved leaf adhesion compared to a composition comprising a macromolecular complex comprising the same type and amount of polycation, polyanion and dithiocarbamate fungicide made by pre-mixing the polycation and the polyanion to form a polyelectrolyte matrix prior to addition of the dithiocarbamate fungicide,
b. the composition has improved rainfastness compared to a composition comprising a macromolecular complex comprising the same type and amount of polycation, polyanion and dithiocarbamate fungicide made by pre-mixing the polycation and the polyanion to form a polyelectrolyte matrix prior to addition of the dithiocarbamate fungicide,
c. the composition has decreased drift compared to a composition comprising a macromolecular complex comprising the same type and amount polycation, polyanion and dithiocarbamate fungicide made by pre-mixing the polycation and the polyanion to form a polyelectrolyte matrix prior to addition of the dithiocarbamate fungicide,
d. the composition is more fungicidally effective compared to a composition comprising a macromolecular complex comprising the same type and amount of polycation, polyanion and dithiocarbamate fungicide made by pre-mixing the polycation and the polyanion to form a polyelectrolyte matrix prior to addition of the dithiocarbamate fungicide when the dithiocarbamate fungicide is applied at the same amount,
e. the composition has the same fungicidal efficacy compared to a composition comprising a macromolecular complex comprising the same type and amount of polycation, polyanion and dithiocarbamate fungicide made by pre-mixing the polycation and the polyanion to form a polyelectrolyte matrix prior to addition of the dithiocarbamate fungicide when the dithiocarbamate fungicide is applied at a lower amount, and
f. the composition has increased bioavailability compared to a composition comprising a macromolecular complex comprising the same type and amount of polycation, polyanion and dithiocarbamate fungicide made by pre-mixing the polycation and the polyanion to form a polyelectrolyte matrix prior to addition of the dithiocarbamate fungicide.

A composition according to the invention may comprise an additional bioactive ingredient, also termed additional agrochemical, such as a growth regulator, a bio-stimulant, a fungicide, a herbicide, an insecticide, an acaricide, a molluscicide, a miticide, a rodenticide; and/or an bactericide.

In some embodiments, the macromolecular complex, composition or delivery system is tank mixed with an additional agrochemical. In some embodiments, the macromolecular complex, composition or delivery system is applied sequentially with the additional agrochemical. In some embodiments, the macromolecular complex, composition or delivery system is applied simultaneously with the additional agrochemical.

Additional agrochemicals that may be used with the macromolecular complex, composition or delivery system of the present invention are described below.

Various agrochemicals may be used as additional bioactive ingredient. Exemplary among such agrochemicals without limitation are crop protection agents, for example pesticides, safeners, plant growth regulators, repellents, bio-stimulants and preservatives such as bacteriostats or bactericides.

A composition of the invention may also comprise two or more additional bioactive ingredients, such as two or more fungicides, two or more herbicides, two or more insecticides, two or more acaricides, two or more bactericides, or combinations thereof, such as at least one antifungal compound and at least one insecticide, at least one antifungal compound and at least one herbicide, at least one antifungal compound and at least one acaricide, at least one antifungal compound and at least one bactericide, at least one herbicide and at least one insecticide, at least one herbicide and at least one acaricide, at least one herbicide and at least one bactericide, at least one insecticide and at least one acaricide, at least one insecticide and at least one bactericide, and at least one acaricide and at least one bactericide. Some bioactive ingredients have a wide range of target organisms, as is known to the skilled person, and are therefore include in more than one subgroup of bioactive ingredients. Said at least one additional bioactive ingredient preferably is present in a concentration of between 0.1 and 90 w/v %, more preferred between 1 and 70 w/v %, more preferred between 10 and 50 w/v %.

Said additional bioactive ingredient preferably is an insecticide, a fungicide and/or an herbicide.

A preferred additional insecticide is a carbamate such as carbofuran, propoxur, methomyl, bendiocarb, formetanate, oxamyl, and aldicarb, an organochlorine such as methoxychlor, kelthane, lindane, toxaphene, and cyclodiene insecticides such as aldrin, dicldrin, endrin, mircx, chlordane, heptachlor, and endosulfan, an organophosphate such as parathion, malathion, methyl parathion, chlorpyrifos, diazinon, dichlorvos, phosmet, fenitrothion, tetrachlorvinphos, azamethiphos, azinphos-methyl, and terbufos, a formamidine such as amitraz, chlordimeform, fornetanate, formparanate, medimeform, and semiamitraz, an organosulfur such as dipymetitrone, an avermectin such as ivermectin, doramectin, selamectin, milbemycin oxime and moxidectin, a neonicotinoid such as acetamiprid, clothianidine, imidacloprid, nitenpyram, nithiazine, thiacloprid and thiamethoxam and/or a pyrethroid insecticide such as allethrin, bifenthrin, cyfluthrin, cypermethrin, cyphenothrin, deltamethrin, esfenvalerate, etofenprox, fenpropathrin, fenvalerate, flucythrinate, flumethrin, finiprothrin, lambda-cyhalothrin, metofluthrin, permethrin, resmethrin, silafluofen, sumithrin, tau-fluvalinate, tefluthrin, tetramethrin, tralomethrin, and transfluthrin.

A preferred additional fungicide is selected from sodium ortho-phenylphenate, 2-phenylphenol; 8-hydroxyquinoline sulphate; acibenzolar-5-methyl; actinovate; aldimorph; amidoflumet; ampropylfos; ampropylfos-potassium; andoprim; anilazine; azoxystrobin; benalaxyl; benodanil; benomyl (methyl 1-(butylcarbamoyl)benzimidazol-2-ylcarbamate); benthiavalicarb-isopropyl; benzamacril; benzamacril-isobutyl; bilanafos, binapacryl; biphenyl; blasticidin-S; boscalid; bupirimate; buthiobate; butylamine; calcium polysulphide; capsimycin; captafol; captan (N-(trichloromethylthio)cyclohex-4-ene-1,2-dicarboximide); carbendazim; carboxin; carpropamid; carvone; chinomethionat; chlobenthiazone; chlorfenazole; chloroneb; chlorothalonil; chlozolinate; cis-1-(4-chlorophenyl)-2-(1H-1,2,4-triazol-1-yl)-cycloheptanol; clozylacon; a conazole fungicide such as, for example. (RS)-1-(β-allyloxy-2,4-dichlorophenethyl)imidazole (imazalil; Janssen Pharmaceutica NV, Belgium) and N-propyl-N-[2-(2,4,6-trichlorophenoxy)ethyl]imidazole-1-carboxamide (prochloraz); cyazofamid; cyflufenamid; cy moxanil; cyprodinil; cyprofuram; Dagger G; debacarb; dichlofluanid; dichlone; dichlorophen; diclocymet; diclomezine; dicloran; diethofencarb; diflumetorim; dimethirimol; dimethomorph; dimoxystrobin; dinocap; diphenylamine; dipyrithione; ditalimfos; dithianon; dodine; drazoxolon; edifenphos; ethaboxam; ethirimol; etridiazole; famoxadone; fenamidone; fenapanil; fenfuram; fenhexamid; fenitropan; fenoxanil; fenpiclonil; fenpropidin; fenpropimorph; fluazinam (3-chloro-N-(3-chloro-5-trifluoromethyl-2-pyridyl)-α,α,α-trifluoro-2,6-dinitro-p-toluidine); flubenzimine; fludioxonil; flumetover; flumorph; fluoromide; fluoxastrobin; flurprimidol; flusulfamide; flutolanil; folpet (N-(trichloromethylthio)phthalimide); fosetyl-A1; fosetyl-sodium; fuberidazole; furalaxyl; furametpyr; furcarbanil; furmecyclox; guazatine; hexachlorobenzene; hymexazol; iminoctadine triacetate; iminoctadine tris(albesilate); iodocarb; iprobenfos; iprodione; iprovalicarb; irumamycin; isoprothiolane; isovaledione; kasugamycin; kresoxim-methyl; mandipropamid, meferimzone; mepanipyrim; mepronil; metalaxyl; metalaxyl-M; methasulfocarb; methfiroxam; methyl 1-(2,3-dihydro-2,2-dimethyl-1H-inden-1-yl)-1H-imidazole-5-carboxylate; methyl 2-[[[cyclopropyl[(4-methoxyphenyl)imino]methyl]thio]-methyl]-.alph-a.-(methoxymethylene)benzeneacetate; methyl 2-[2-[3-(4-chlorophenyl)-1-methyl-allylideneaminooxymethyl]phenyl]-3-meth-oxyacrylate; metiram; metominostrobin; metrafenone; metsulfovax; mildiomycin; monopotassium carbonate; myclozolin; N-(3-ethyl-3,5,5-trimethylcyclohexvl)-3-formylamino-2-hydroxybenzamide; N-(6-methoxy-3-pyridinyl)cyclopropanecarboxamide; a polyene fungicide such as natamcyin; N-butyl-8-(1,1-dimethylethyl)-1-oxaspiro[4.5]decan-3-amine; nitrothal-isopropyl; noviflumuron; ofurace; orysastrobin; oxadixyl; oxolinic acid; oxycarboxin; oxyfenthiin; pencycuron; penthiopyrad; phosdiphen; phosphite salts such as disodium phosphite and potassium phosphite, phthalide; picobenzamid; picoxystrobin; piperalin; polyoxins; polyoxorim; procymidone; propamocarb; propanosine-sodium; propineb; proquinazid; pyraclostrobin; pyrazophos; pyrimethanil; pyroquilon; pyroxyfur; pyrrolnitrine, quinconazole; quinoxyfen; quintozene; silthiofam; sodium tetrathiocarbonate; spiroxamine; sulphur; tecloftalam; tecnazene; tetcyclacis; thiazole fungicide such as, for example, 2-(thiazol-4-yl)benzimidazole (thiabendazole), thicvofen; thifluzamide; thiophanate-methyl; tiadinil; tioxymid; tolclofos-methyl; tolylfluanid; triazbutil; triazoxide; tricyclamide; tricyclazole; tridemorph; trifloxystrobin; validamycin A; vinclozolin; zoxamide; (2S)— N-[2-[4-[[3-(4-chlorophenyl)-2-propynyl]oxy]-3-methoxyphenyl]ethyl]-3-met-hyl-2-[(methylsulphonyl)amino]butanamide; 1-(1-naphthalenyl)-1H-pyrrole-2,5-dione; 2,3,5,6-tetrachloro-4-(methylsulphonyl)pyridine; 2,4-dihydro-5-methoxy-2-methyl-4-[[[[1-[3-(trifluoromethyl)phenyl]-ethyli-dene]amino]oxy]methyl]phenyl]-3H-1,2,3-triazol-3-one; 2-amino-4-methyl-N-phenyl-5-thiazolecarboxamide; 2-chloro-N-(2,3-dihydro-1,1,3-trimethyl-1H-inden-4-yl)-3-pyridinecarboxam-ide; 3,4,5-trichloro-2,6-pyridinedicarbonitrile; 3-[(3-bromo-6-fluoro-2-methyl-1H-indol-1-yl)sulphonyl]-N,N-dimethyl-1H-1,-2,4-triazole-1-sulphonamide, and/or mixtures thereof.

A most preferred additional fungicide is natamycin. A composition of the invention may also comprise two or more additional fungicides, such as, for example, natamycin and a strobilurin type of fungicides such as azoxystrobin, natamycin and a triazole type of fungicides such as cyproconazole, natamycin and a succinate dehydrogenase inhibitor type of fungicides such as boscalid, natamycin and a pthalimide/pthalonitrile type of fungicide such as chlorothalonil, natamycin and captan, natamycin and a benzimidazole type of fungicide such as thiabendazole, natamycin and a carbamate type of fungicides such as propamocarb, natamycin and a carboxamide type of fungicides such as fenoxanil, natamycin and a dicarboxamide type of fungicide such as iprodione, natamycin and a morpholine type of fungicide such as dimethamorph, natamycin and an organophosphate type of fungicide such as fosetyl, natamycin and an azole type of fungicide such as prothioconazole, natamycin and a phenylamide type of fungicide such as metalaxyl, natamycin and a fungicide not belonging to a specific group of fungicides such as fludioxynil and/or folpet.

A preferred additional herbicide is selected from an inhibitor of amino acid synthesis such as inhibitors of 5-enolpyruvyl-shikimate-3-phosphate synthase, acetolactate synthase and glutamine synthetase such as a glyphosate, a sulfonylurea, an imidazolinone, a glufosinate and/or a 1,2,4-triazol[1,5A]pyrimidine; a photosynthetic inhibitor that binds D-1:quinone-binding protein, including anilides, benzimidazoles, biscarbamates, pyridazinones, triazinediones, triazines, triazinones, uracils, substituted ureas, quinones, hydroxvbcnzonitriles, and several unclassified heterocycles; inhibitors of acetyl-CoA carboxylase such as aryloxyphenoxy alkanoic acids and cyclohexanediones; inhibitors of cellular division such as phosphoric amide and dinitroaniline; inhibitors of the terpenoid synthesis pathway such as substituted pyridazinones, m-phenoxybenzamides, fluridone, difunone, 4-hydroxypyridine, aminotriazole amitrole, 6-methyl pyrimidine, isoxazolidinone; inhibitors of dihydropteroate synthase such as asulam, and/or mixtures thereof.

Such preferred additional herbicide is preferably selected from bcnzobicyclon, mesotrione, sulcotrione, tefuryltrione, tembotrione, 2,4-dichlorophenoxyacetic acid, 3,6-dichloro-2-methoxybenzoic acid (dicamba), 4-hydroxy-3-[[2-(2-methoxyethoxy)methyl]-6-(trifluoromethyl)-3-pyridinyl]carbonyl]-bicyclo[3.2.1]-oct-3-en-2-one (bicyclopyrone), ketospiradox or the free acid thereof, benzofenap, pyrasulfotole, pyrazolynate, pyrazoxyfen, topramezone, [2-chloro-3-(2-methoxyethoxy)-4-(methylsulfonyl)phenyl](l-ethyl-5-hydroxy-1H-pyrazol-4-yl)-methanone, (2,3-dihydro-3,3,4-trimethyl-1,1-dioxidobenzo[b]thien-5-yl)(5-hydroxy-1-methyl-1H-pyrazol-4-yl)-methanone, isoxachlortole, isoxaflutole, a-(cyclopropylcarbonyl)-2-(methylsulfonyl)-oxo-4-chloro-benzenepropanenitrile, and a-(cyclopropylcarbonyl)-2-(methylsulfonyl)-oxo-4-(trifluoromethyl)-benzenepropanenitrile.

Preferred combinations with a macromolecular complex comprising a polyelectrolyte and a dithiocarbamate such as zinc; manganese(2+); N-[2-(sulfidocarbothioylamino)ethyl]carbamodithioate are dimethomorph, cymoxanil, carbendazim, imidacloprid, zoxamide and metalaxyl.

Preferred additional pesticides which may be combined with a macromolecular complex comprising a polyelectrolyte and a dithiocarbamate such as zinc; manganese(2+); N-[2-(sulfidocarbothioylamino)ethyl]carbamodithioate are one or more of dimethomorph, cymoxanil, carbendazim, imidacloprid, zoxamide and metalaxyl.

In some embodiments, the additional fungicides are strobilurin fungicide and azole fungicides. Strobilurin fungicide may be, but is not limited to, picoxystrobin, azoxystrobin or a combination thereof.

Azole fungicide may be, but is not limited to, tebuconazole, prothioconazole, or a combination thereof.

In some embodiments, the macromolecular complex of the present invention is combined with two additional fungicides. In some embodiments, the macromolecular complex of the present invention is combined with picoxystrobin and tebuconazole. In some embodiments, the macromolecular complex of a polyelectrolyte and mancozeb is combined with picoxystrobin and tebuconazole. In some embodiments, the macromolecular complex of a polyelectrolyte and mancozeb is combined with prothioconazole. In some embodiments, the macromolecular complex of a polyclectrolyte and mancozeb is combined with picoxystrobin and prothioconazole.

### 4.4 Methods for Preparation of a Macromolecular Complex

The invention further provides a method for producing a macromolecular complex according to the invention, comprising (a) providing an aqueous composition of a polycation, (b) mixing a dithiocarbamate fungicide into the aqueous composition, while keeping the pH of the mixture between pH=3-6, preferably between 3-4, by addition of an acid, (c) thereby producing a macromolecular complex of a polycation and a dithiocarbamate fungicide.

The invention further provides a process for producing a macromolecular complex, comprising the following steps:

(a) providing an aqueous composition of a polycation,

(b) mixing a dithiocarbamate fungicide into the aqueous composition, while keeping the pH of the mixture between pH=3-6, by addition of an acid, and

(c) thereby producing a macromolecular complex of a polycation and a dithiocarbamate fungicide in an aqueous composition.

In some embodiments, the aqueous composition of step (c) has neutral zeta potential, where neutral zeta potential refers to ±10 Mv, preferable ±5 Mv

In some embodiments, the polycation is chitosan. In some embodiments, the polycation is PAA.

In some embodiments, the dithiocarbamate fungicide is mancozeb.

In some embodiments, step (b) comprises keeping the pH of the mixture between 3-4.

In some embodiments, the macromolecular complex is substantially free of polyanion and step (b) comprises obtaining a batch of the dithiocarbamate fungicide that is substantially free of polyanion and mixing the batch with the aqueous composition of step (a).

In some embodiments, the macromolecular complex is free of polyanion and step (b) comprises obtaining a batch of the dithiocarbamate fungicide that is free of polyanion and mixing the batch with the aqueous composition of step (a).

In some embodiments, the macromolecular complex comprises mancozeb and is free of polyanion and step (b) comprises obtaining a batch of mancozeb that is free of polyanion and mixing the batch with the aqueous composition of step (a).

In some embodiments, the macromolecular complex comprises mancozeb and is free of lignosulfonate and step (b) comprises obtaining a batch of mancozeb that is free of lignosulfonate and mixing the batch with the aqueous composition of step (a).

In some embodiments, the macromolecular complex comprises up to 1 part of polyanion per 6 parts of the dithiocarbamate fungicide by weight and step (b) comprises obtaining a batch of the dithiocarbamate fungicide that contains up to 1 part of polyanion per 6 parts of the dithiocarbamate fungicide by weight and mixing the batch with the aqueous composition of step (a).

In some embodiments, the macromolecular complex comprises up to 1 part of polyanion per 8 parts of the dithiocarbamate fungicide by weight and step (b) comprises obtaining a batch of the dithiocarbamate fungicide that contains up to 1 part of polyanion per 8 parts of the dithiocarbamate fungicide by weight and mixing the batch with the aqueous composition of step (a). In some embodiments, step (b) comprises using a batch of the dithiocarbamate fungicide that contains up to 1 part of polyanion per 8 parts of the dithiocarbamate fungicide by weight and mixing the batch with the aqueous composition of step (a).

In some embodiments, the macromolecular complex comprises up to 1 part of polyanion per 10 parts of the dithiocarbamate fungicide by weight and step (b) comprises obtaining a batch of the dithiocarbamate fungicide that contains up to 1 part of polyanion per 10 parts of the dithiocarbamate fungicide by weight and mixing the batch with the aqueous composition of step (a).

In some embodiments, the macromolecular complex comprises up to 1 part of polyanion per 20 parts of the dithiocarbamate fungicide by weight and step (b) comprises obtaining a batch of the dithiocarbamate fungicide that contains up to 1 part of polyanion per 20 parts of the dithiocarbamate fungicide by weight and mixing the batch with the aqueous composition of step (a).

In some embodiments, the macromolecular complex comprises up to 1 part of polyanion per 25 parts of the dithiocarbamate fungicide by weight and step (b) comprises obtaining a batch of the dithiocarbamate fungicide that contains up to 1 part of polyanion per 25 parts of the dithiocarbamate fungicide by weight and mixing the batch with the aqueous composition of step (a).

In some embodiments, the macromolecular complex comprises up to 1 part of polyanion per 50 parts of the dithiocarbamate fungicide by weight and step (b) comprises obtaining a batch of the dithiocarbamate fungicide that contains up to 1 part of polyanion per 50 parts of the dithiocarbamate fungicide by weight and mixing the batch with the aqueous composition of step (a).

In some embodiments, the macromolecular complex comprises up to 1 part of polyanion per 100 parts of the dithiocarbamate fungicide by weight and step (b) comprises obtaining a batch of the dithiocarbamate fungicide that contains up to 1 part of polyanion per 100 parts of the dithiocarbamate fungicide by weight and mixing the batch with the aqueous composition of step (a).

In some embodiments, the macromolecular complex comprises up to 1 part of polyanion per 1000 parts of the dithiocarbamate fungicide by weight and step (b) comprises obtaining a batch of the dithiocarbamate fungicide that contains up to 1 part of polyanion per 1000 parts of the dithiocarbamate fungicide by weight and mixing the batch with the aqueous composition of step (a).

In some embodiments, the polyanion is lignosulfonate.

In some embodiments, the dithiocarbamate fungicide is mancozeb.

In some embodiments, the process further comprises a step of milling or grinding the resultant macromolecular complex to reduce their particle size to any of the particle sizes described herein.

Said methods or processes for producing a composition according to the invention may further comprise a step of milling or grinding the resultant macromolecular complex to reduce their particle size to an average particle size (volume based) d50 below 2 micron.

In some embodiments, the process further comprises milling or grinding the resultant macromolecular complex to reduce their particle size such that the particles have a d50 of 1-2 microns. In some embodiments, the process further comprises milling or grinding the resultant macromolecular complex to reduce their particle size such that the particles have a d90 of 2-3 microns.

Keeping or adjusting a pH can be achieved by adding acid, base and buffer. Said acid may include, but is not limited to, hydrochloric acid.

Said aqueous composition of a polycation can be generated by solubilizing the polycation in an aqueous acidic solution comprising an acid such as, for example, lactate, hydrochloric acid, phosphorous acid and/or ascorbic acid. The amount of acid that is required to solubilize the polycation depends on the polycation, as is known to a skilled person. For example, for solubilizing chitosan, in general, about 6 ml 37% HCl is required to obtain a solution of 10 gram chitosan in 1 liter of water. As an alternative, a polycation is dissolved in an aqueous solution, preferably water, for example by gently shaking at 20-23° C. overnight, whereby a salt such as sodium chloride is preferably added to the aqueous solution at a concentration between 1 mM and 1 M, preferably about 100 mM.

During mixing, the temperature is preferably kept between 0° C. and 100° C., more preferred between 10° C. and 60° C. more preferred kept at ambient temperature (15-25° C.). The resulting mixture is preferably stirred during formation of the macromolecular complex. Following formation of the macromolecular complex, a dispersant such as modified styrene acrylic polymer and/or a wetting agent such as butyl block copolymer is preferably added.

The relative amounts of a polycation and a dithiocarbamate fungicide that are combined in step b) of a method according to the invention is between 1:5 and 1:300 (w/w), more preferred in a ratio between 1:10 and 1:200, more preferred in a ratio between 1:20 and 1:80 (w/w).

The final pH value of the resulting composition may be adjusted to a pH value of between 3-12, more preferred between 4-9, most preferred between 5-8.

Said macromolecular complex of a polyelectrolyte and a negatively charged, ionizable, protonated, polar, or delta-charged bioactive ingredient which is a dithiocarbamate fungicide, preferably zinc; manganese(2+); N-[2-(sulfidocarbothioylamino)ethyl]carbamodithioate may be characterized as a regular, homogeneous precipitate that can be formulated as a stable suspension or emulsion concentrate. For this, the macromelecular complex may be milled or grinded, for example using a Dynomill®, to reduce the particle size of the resultant macromolecular complex particles. The resultant macromolecular complex particles preferably have a d50 below 5 micron (volume based), preferably 2 micron or less. Said low d50 value improves their morphology, and may increase their wettability, dispersability and stability of the formulation as well as adhesiveness to plant surface with improved rainfastness.

Said macromolecular complex improves the biological efficacy of the dithiocarbamate fungicide such that less of the dithiocarbamate fungicide is required to achieve control of agricultural pests, when compared to the same dithiocarbamate fungicide that is not complexed into a macromolecular complex. In addition, the inclusion in a macromolecular complex may improve rainfastness and provides longer duration by slow release of the dithiocarbamate fungicide, as is demonstrated in the examples.

The present invention also provides a macromolecular complex produced using any one of the processes or methods described herein.

The present invention also provides a macromolecular complex produced using any one of the processes or methods described herein.

The present invention also provides a process for producing a composition comprising any one of the macromolecular complexes described herein and an agriculturally acceptable additive, wherein the process comprises the following steps:

(a) obtaining the macromolecular complex,
(b) mixing the macromolecular complex obtained in step (a) with agriculturally acceptable additive, and
(c) thereby producing the composition comprising the macromolecular complex and the agriculturally acceptable additive.

In some embodiments, the macromolecular complex is obtained by preparing the macromolecular complex using any one of the methods and processes disclosed herein.

As used herein, the term “additive” refers to an inert component of a composition. Agriculturally acceptable additive includes agriculturally acceptable carrier.

Agriculturally acceptable additives are described herein above. Any one or any combination of the agriculturally acceptable additives described herein above may be mixed with the macromolecular complex to produce the corresponding composition.

In some embodiments, the agriculturally acceptable additive a dispersant and step (b) comprises mixing the dispersant with the macromolecular complex obtained in step (a).

In some embodiments, the dispersant is lignosulfonate, a modified acrylic polymer or any combination hereof. In some embodiments, the modified acrylic polymer is modified styrene acrylic acid, polymethyl methacrylate-polyethylene glycol graft copolymer or any combination thereof.

In some embodiments, the composition comprises a stabilizer, anti-foam agent, antifreezing agent, surfactant, wetting agent, preservative and/or rheology modifier, and step (b) comprises mixing the stabilizer, anti-foam agent, antifreezing agent, surfactant, wetting agent, preservative and/or rheology modifier with the macromolecular complex obtained in step (a).

In some embodiments the composition comprises water and step (b) comprises mixing the water with the macromolecular complex obtained in step (a).

In some embodiments, wherein the surfactant is anionic, the surfactant is added after the polycation is mixed with the dithiocarbamate fungicide. In some embodiments, wherein the surfactant is anionic, the surfactant is added to the polycation in parallel to the dithiocarbamate fungicide. In some embodiments, wherein the surfactant is nonionic, the surfactant can be added at any stage of the formulating process.

In some embodiments, the formulating process refer to (a) preparing the macromolecular complex comprising polycation and dithiocarbamate fungicide and (b) adding the acceptable inert agricultural additive such as wetting agent, anti foaming agent and rheology modifier.

In some embodiments, a co solvent is added at step (a) of preparing the macromolecular complex.

The present invention also provides a composition prepared using any one of the processes described herein.

### 4.5 Methods of Use

The invention also provides a method of treating a plant, or a part of a plant, against a pathogen, comprising contacting the plant, or part of the plant, with a macromolecular complex, composition, and/or delivery system described herein.

The invention also provides a method of increasing crop yield comprising contacting the plant, or part of the plant with a macromolecular complex, composition, and/or delivery system described herein.

The invention also provides a method of improving plant vigor comprising contacting the plant, or part of the plant with a macromolecular complex, composition, and/or delivery system described herein.

In some embodiments, the method of treating the plant, or the part of a plant against a pathogen comprises protecting the plant, or a part of a plant, against the pathogen, comprising contacting the plant, or part of the plant, with the macromolecular complex, composition, and/or delivery system described herein.

In some embodiments, the method of treating the plant, or the part of a plant against a pathogen comprises preventing, reducing and/or eliminating the presence of the pathogen on the plant, or part of the plant, comprising contacting the plant, or part of the plant, with the macromolecular complex, composition, and/or delivery system described herein.

In some embodiment, the method of treating the plant, or the part of a plant against a pathogen comprises controlling diseases caused by phytopathogenic fungi in plants or on propagation material thereof, which method comprises contacting the plants, or propagation material thereof, with the macromolecular complex, composition, and/or delivery system described herein.

In some embodiment, the method of treating the plant, or the part of a plant against a pathogen comprises preventing, reducing and/or eliminating the presence of a pathogen on a plant, or a part of a plant, comprising contacting said plant, or part of said plant, with the macromolecular complex, composition, and/or delivery system described herein.

In some embodiments, the method of treating the plant, or the part of a plant against a pathogen comprises controlling pest comprising contacting (i) the pest or a locus thereof, (ii) a plant or a locus or propagation material thereof. (iii) soil, and/or (iv) an area in which pest infestation is to be prevented with the macromolecular complex, composition, and/or delivery system described herein.

In some embodiments, the method of treating the plant, or the part of a plant against a pathogen comprises improving pest control comprising applying any one of the compositions, complexes or delivery systems described herein to a plant/or soil.

In some embodiments, the method of treating the plant, or the part of a plant against a pathogen comprises prolonging a controlling effect of a dithiocarbamate fungicide, comprising applying any one of the compositions, complexes or delivery systems described herein to a plant/or soil.

In some embodiments, the pathogen is phytopathogenic fungi and the method comprises controlling diseases caused by phytopathogenic fungi in the plant or on propagation material thereof comprising contacting the plant, or propagation material thereof, with the macromolecular complex, composition, and/or delivery system described herein.

The invention further provides a method of protecting a plant or plant part against a pathogen, comprising contacting said plant or said plant part with a diluted aqueous composition according to this invention.

The invention further provides a method of preventing, reducing and/or eliminating the presence of a pathogen on a plant, or a part of a plant, comprising contacting said plant, or part of said plant, with an aqueous composition according to this invention.

The invention further provides a method of controlling diseases caused by phytopathogenic fungi in plants or on propagation material thereof, which method comprises contacting the plants, or propagation material thereof, with a composition according to the invention, including an aqueous diluted composition.

The present invention also provides a method of controlling pest comprising contacting (i) the pest or a locus thereof, (ii) a plant or a locus or propagation material thereof, (iii) soil, and/or (iv) an area in which pest infestation is to be prevented with a macromolecular complex of the invention. Said macromolecular complex of the invention preferably is provided as a composition according to the invention, and/or a delivery system according to the invention.

The present invention also provides a method for improving pest control comprising applying any one of the compositions, complexes or delivery systems described herein to a plant/or soil.

The present invention also provides a method for prolonging a controlling effect of a dithiocarbamate fungicide, comprising applying any one of the compositions, complexes or delivery systems described herein to a plant/or soil.

The present invention also provides use of the macromolecular complex, composition, and/or delivery system described herein for treating a plant, or a part of a plant, against a pathogen.

Said method or use of the macromolecular complex, comprising a dithiocarbamate fungicide and a polycation, or a delivery system or composition thereof may result in a reduced rate of application of the dithiocarbamate fungicide.

The terms “reduced rate of application” and “increasing biological activity” may refer to a rate of application that is more than 20%, preferably more than 50%, reduced, when compared to the rate of application of the same dithiocarbamate fungicide as a free dithiocarbamate fungicide.

Said reduced rate of application may refer to an application rate of 5 mg dithiocarbamate fungicide(a.i.)/ha to 2.5 kg a.i./ha, preferably 1 g a.i./ha to 2 kg a.i./ha.; such as a rate of 750 g a.i./ha.; a rate of 605 g a.i./ha., a rate of 500 g a.i./ha. In some embodiments, the macromolecular complex, composition, and/or delivery system is applied at an amount of 0.01-5 g/ha of the dithiocarbamate fungicide. In some embodiments, the macromolecular complex, composition, and/or delivery system is applied at an amount of 0.01-3 g/ha of the dithiocarbamate fungicide. In some embodiments, the macromolecular complex, composition, and/or delivery system is applied at an amount of 0.01-2 g/ha of the dithiocarbamate fungicide. In some embodiments, the macromolecular complex, composition, and/or delivery system is applied at an amount of 0.01-1 g/ha of the dithiocarbamate fungicide.

In some embodiments, the macromolecular complex, composition, and/or delivery system is applied at an amount of 0.01-5 g/ha of mancozeb. In some embodiments, the macromolecular complex, composition, and/or delivery system is applied at an amount of 0.01-3 g/ha of mancozeb. In some embodiments, the macromolecular complex, composition, and/or delivery system is applied at an amount of 0.01-2 g/ha of mancozeb. In some embodiments, the macromolecular complex, composition, and/or delivery system is applied at an amount of 0.01-1 g/ha of mancozeb.

In some embodiments, the macromolecular complex, composition, and/or delivery system is applied at an amount of 0.018 g/ha of mancozeb. In some embodiments, the macromolecular complex, composition, and/or delivery system is applied at an amount of 0.97 g/ha of mancozeb. In some embodiments, the macromolecular complex, composition, and/or delivery system is applied at an amount of 0.39 g/ha of mancozeb. In some embodiments, the macromolecular complex, composition, and/or delivery system is applied at an amount of 1.56 g/ha of mancozeb.

A macromolecular complex according to the invention is suitable for the control of pests that are encountered in horticulture, agriculture, and forestry. The macromolecular complexes are active against normally sensitive and resistant pest species and during all or individual stages of development. Prior to use, a composition comprising a macromolecular complex according to the invention is preferably dissolved or dispersed in water, or diluted with water, to provide an aqueous composition comprising between 0.001 and 10 w/v % of the dithiocarbamate fungicide. If required, an agriculturally acceptable carrier such as a sticking agent is added to the diluted aqueous composition.

A composition according to the invention is preferably diluted 2-5000 times, preferably about 200 times, with an aqueous solvent, preferably water, to contain between 0.0001 and 10% (w/v) of the dithiocarbamate fungicide, prior to contacting a plant, plant part or soil with the composition.

To control agricultural pests, the invention provides a use of a composition comprising a macromolecular complex according to the invention for the protection of a plant, or a part of a plant, against a pathogen. In order to achieve this effect, said plant or plant part, or a soil, is contacted with said composition, including a diluted aqueous composition. Said composition is used, for example, to control powdery mildew and downy mildew infections on food/feed crops, including tree fruits, vegetable crops, field crops, grapes, ornamental plants, and sod farms. Further use, for example, is to control scab, including common scab, apple scab and black scab on potatoes, pear scab, and powdery scab, brown rot of peaches, currant and gooseberry leaf spot, peanut leafspot, and mildew on roses. Other uses include protection of greenhouse grown flowers and ornamentals, home vegetable gardens and residential turf. In addition, said composition, including a diluted aqueous composition, may be contacted with isolated fruits, nuts, vegetables, and/or flowers.

For said use and said methods, the composition, including a diluted aqueous composition, is preferably sprayed over a plant, or part thereof. Spraying applications using automatic systems are known to reduce labor costs and are cost-effective. Methods and equipment well-known to a person skilled in the art can be used for that purpose. The composition, including diluted aqueous composition, can be regularly sprayed, when the risk of infection is high. When the risk of infection is lower, spray intervals may be longer.

Other methods suitable for contacting plants or parts thereof with a composition of the invention are also a part of the present invention. These include, but are not limited to, dipping, watering, drenching, introduction into a dump tank, vaporizing, atomizing, fogging, fumigating, painting, brushing, misting, dusting, foaming, spreading-on, packaging and coating (e.g. by means of wax or electrostatically). In addition, the composition, including a diluted aqueous composition, may be injected into the soil.

For example, a plant of part thereof may be coated with a diluted aqueous composition comprising a dithiocarbamate fungicide according to the invention by submerging the plant or part thereof in a diluted aqueous composition to protect the plant of part thereof against a pathogen and/or to prevent, reduce and/or eliminate the presence of a pathogen on a plant, or a part of a plant. A preferred part of a plant that is coated with a composition according to the invention, or with a dilution thereof, is seed. A further preferred part of a plant that is coated with a composition according to the invention, or with a dilution thereof, is leaf. A further preferred part of a plant that is coated with a composition according to the invention, or with a dilution thereof, is a fruit, preferably a post-harvest fruit such as, for example, a citrus fruit such as orange, mandarin and lime, a pome fruit such as apple and pear, a stone fruit such as almond, apricot, cherry, damson, nectarine, tomato, watermelon, a tropical fruit such as banana, mango, lychee and tangerine. A preferred fruit is a citrus fruit, such as orange and/or a tropical fruit such as banana.

The invention provides a method for (i) increasing biological activity of a dithiocarbamate fungicide on a target, (ii) increasing uptake of a dithiocarbamate fungicide into a target, (iii) increasing penetration of a dithiocarbamate fungicide into a target, (iv) increasing retention of a dithiocarbamate fungicide by a target, (v) increasing absorbance of a dithiocarbamate fungicide by a target, and/or (vi) increasing or enhancing bioavailability of a dithiocarbamate fungicide to a target, wherein the method comprises interacting the dithiocarbamate fungicide with a polycation prior to application of the dithiocarbamate fungicide to a plant, a plant part, and/or soil.

In some embodiments, the method comprises interacting the dithiocarbamate fungicide with the polycation through complexation by non-covalent electrostatic interaction prior to application of the dithiocarbamate fungicide to the plant, plant part, and/or soil.

In some embodiments, the method comprises interacting the dithiocarbamate fungicide with the polycation to form a macromolecular complex prior to application of the dithiocarbamate fungicide to the plant, plant part, and/or soil.

In some embodiments, the method comprises complexing or encapsulating the dithiocarbamate fungicide partially or completely within the polycation prior to application of the dithiocarbamate fungicide to the plant, plant part, and/or soil.

The invention provides the use of a macromolecular complex, a composition or a delivery system of the present invention for (i) increasing biological activity of a dithiocarbamate fungicide on a target, (ii) increasing uptake of a dithiocarbamate fungicide into a target, (iii) increasing penetration of a dithiocarbamate fungicide into a target, (iv) increasing retention of a dithiocarbamate fungicide by a target, (v) increasing absorbance of a dithiocarbanate fungicide by a target, and/or (vi) increasing or enhancing bioavailability of a dithiocarbanate fungicide to a target.

In some embodiments, the target is a plant. In some embodiments, the target is a plant part. In some embodiments, the target is a fungus.

The invention provides a method for (i) reducing drift of a dithiocarbamate fungicide, (ii) increasing leaf adhesion of a dithiocarbamate fungicide, (iii) increasing rainfastness of a dithiocarbamate fungicide, (iv) increasing persistence of a dithiocarbamate fungicide, and/or (v) reducing phytotoxicity of a dithiocarbamate fungicide, wherein the method comprises interacting the dithiocarbamate fungicide with a polycation prior to application of the dithiocarbamate fungicide.

In some embodiments, the method comprises interacting the dithiocarbamate fungicide with a polycation through complexation by non-covalent electrostatic interaction.

In some embodiments, the method comprises interacting the dithiocarbamate fungicide with a polycation to form a macromolecular complex.

The invention provides the use of a macromolecular complex, a composition or a delivery system of the present invention for (i) reducing drift of a dithiocarbamate fungicide, (ii) increasing leaf adhesion of a dithiocarbamate fungicide, (iii) increasing rainfastness of a dithiocarbamate fungicide, and/or (iv) increasing persistence of a dithiocarbamate fungicide.

The invention also provides a method for reducing phytotoxicity of a dithiocarbamate fungicide on a plant, comprising interacting the dithiocarbamate fungicide with a polycatione through complexation by intermolecular electrostatic interactions prior to application of the dithiocarbamate fungicide to a plant, part of a plant and/or soil.

An aspect of the invention provides a use of the macromolecular complex, composition, and/or delivery system according to the invention, comprising a dithiocarbamate fungicide and a polycation, for increasing biological activity of the dithiocarbamate fungicide.

An aspect of the invention provides a use of the macromolecular complex according to the invention, comprising a dithiocarbamate fungicide and a polycation, for increasing biological activity of the dithiocarbamate fungicide.

Said use of a macromolecular complex of the invention, comprising a dithiocarbamate fungicide and a polycation, may result in a reduced rate of application of the dithiocarbamate fungicide.

The present invention also provides a method for increasing biological activity of a dithiocarbamate fungicide as a fungicide on a fungus comprising interacting the fungicide with a polyelectrolyte through complexation by intermolecular electrostatic interactions prior to application of the fungicide to a plant, part of a plant and/or soil.

The present invention also provides a method for increasing biological activity of a dithiocarbamate fungicide on a fungus comprising interacting the dithiocarbamate fungicide with a polyelectrolyte through complexation by intermolecular electrostatic interactions prior to application of the dithiocarbamate fungicide to a plant, part of a plant and/or soil.

The present invention also provides a method for increasing fungicidal activity of a dithiocarbamate fungicide on a fungus comprising interacting the dithiocarbamate fungicide with a polyelectrolyte through complexation by intermolecular electrostatic interactions prior to application of the dithiocarbamate fungicide to a plant, part of a plant and/or soil.

In some embodiments, the dithiocarbamate fungicide is mancozeb.

The present invention also provides a method for increasing penetration of a dithiocarbamate fungicide into a target, comprising interacting the dithiocarbamate fungicide with a polycation through complexation by intermolecular electrostatic interactions prior to application of the dithiocarbamate fungicide to the target.

The present invention also provides a method for increasing uptake of a dithiocarbamate fungicide by a target, comprising interacting the dithiocarbamate fungicide with a polycation through complexation by intermolecular electrostatic interactions prior to application of the dithiocarbamate fungicide to a plant, part of a plant and/or soil.

The present invention also provides a method for increasing penetration of a dithiocarbamate fungicide into a target, comprising interacting the dithiocarbamate fungicide with a polycation through complexation by intermolecular electrostatic interactions prior to application of the dithiocarbamate fungicide to the target.

The present invention also provides a method for increasing uptake of a dithiocarbamate fungicide by a target, comprising interacting the dithiocarbamate fungicide with a polycation through complexation by intermolecular electrostatic interactions prior to application of the dithiocarbamate fungicide to a plant, part of a plant and/or soil.

The invention also provides a method for reducing drift of a dithiocarbamate fungicide comprising interacting the dithiocarbamate fungicide with a polycation to form a macromolecular complex, preferably by complexing or entrapping the dithiocarbamate fungicide partially or completely within the polycation, prior to application of the dithiocarbamate fungicide to a plant, plant part, and/or soil.

The invention also provides a method for increasing leaf adhesion of a dithiocarbamate fungicide comprising interacting the dithiocarbamate fungicide with a polycation to form a macromolecular complex, preferably by complexing or entrapping the dithiocarbamate fungicide partially or completely within the polycation, prior to application of the dithiocarbamate fungicide to a plant, plant part, and/or soil.

The invention also provides a method for increasing rainfastness of a dithiocarbamate fungicide comprising interacting the dithiocarbamate fungicide with a polycation to form a macromolecular complex, preferably by complexing or entrapping the dithiocarbamate fungicide partially or completely within the polycation, prior to application of the dithiocarbamate fungicide to a plant, plant part, and/or soil.

The invention also provides a method for increasing persistence of dithiocarbamate fungicide comprising interacting the dithiocarbamate fungicide with a polycation to form a macromolecular complex, preferably by complexing or entrapping the dithiocarbamate fungicide partially or completely within the polycation, prior to application of the dithiocarbamate fungicide to a plant, plant part, and/or soil.

In some embodiments, the target is a plant. In some embodiments, the target is a pest. In some embodiments, the pest is a fungus.

The present invention also provides a method for increasing bioavailability of a dithiocarbamate fungicide comprising interacting the dithiocarbamate fungicide with a polycation by complexing the dithiocarbamate fungicide with the polycation or encapsulating the dithiocarbamate fungicide within the polycation prior to application of the dithiocarbamate fungicide to a plant, part of a plant and/or soil.

The present invention also provides a method for increasing the biological activity of a dithiocarbamate fungicide on a pest comprising interacting the dithiocarbamate fungicide with a polycation through complexation by intermolecular electrostatic interactions prior to application of the dithiocarbamate fungicide to a plant, part of a plant and/or soil.

The term “increasing biological activity” refers to curative, knock down, preventive and/or persistence performance.

The present invention also provides a method for increasing uptake of a dithiocarbamate fungicide by a target, comprising interacting the dithiocarbamate fungicide with a polycation through complexation by intermolecular electrostatic interactions prior to application of the dithiocarbamate fungicide to a plant, part of a plant and/or soil.

The present invention also provides a method for increasing penetration of a dithiocarbamate fungicide into a target, comprising interacting the dithiocarbamate fungicide with polycation through complexation by electrostatic intermolecular interactions prior to application of the dithiocarbamate fungicide to the target.

In some embodiments, the target is a plant. In some embodiments, the target is a pest. In some embodiments, the pest is a fungus.

The present invention also provides a method for increasing absorbance of a dithiocarbamate fungicide by a plant tissue, comprising interacting the dithiocarbamate fungicide with a polycation through complexation by intermolecular electrostatic interactions prior to application of the dithiocarbamate fungicide to a plant, part of a plant and/or soil.

The present invention also provides a method for increasing biological activity of a dithiocarbamate fungicide on a pest comprising interacting the dithiocarbamate fungicide with a polycation through complexation by intermolecular electrostatic interactions prior to application of the dithiocarbamate fungicide to a plant, part of a plant and/or soil.

The present invention also provides a method for increasing the uptake of dithiocarbamate fungicide by a plant, comprising interacting the dithiocarbamate fungicide with a polycation through complexation by intermolecular electrostatic interactions prior to application of the dithiocarbamate fungicide to the plant, part of a plant and/or soil.

The present invention also provides a method for increasing the bioavailability of a dithiocarbamate fungicide, comprising interacting the dithiocarbamate fungicide with a polyelectrolyte by complexing or encapsulating molecules of the dithiocarbamate fungicide with or within molecules of the polycation prior to application of the dithiocarbamate fungicide to a plant, part of a plant and/or soil.

The present invention also provides a method for increasing the biological activity of a dithiocarbamate fungicide on a plant comprising interacting the dithiocarbamate fungicide with a polycation through non-covalent electrostatic interaction prior to application of the dithiocarbamate fungicide to a plant, part of a plant and/or soil.

The present invention also provides a method of increasing uptake of a dithiocarbamate fungicide by a plant, increasing penetration of a dithiocarbamate fungicide into a plant, increasing retention of a dithiocarbamate fungicide by a plant and/or increasing bioavailability of a dithiocarbamate fungicide to a plant comprising interacting the dithiocarbamate fungicide with a polycation through complexation by non-covalent electrostatic interaction prior to application of the dithiocarbamate fungicide to the plant, part of a plant and/or soil.

The present invention also provides a method for increasing the biological activity of a dithiocarbamate fungicide on a plant comprising interacting the dithiocarbamate fungicide with a polycation through complexation by electrostatic intermolecular interaction prior to application of the dithiocarbamate fungicide to a plant, and/or soil.

The present invention also provides a method of increasing uptake of a dithiocarbamate fungicide by a plant, increasing penetration of a dithiocarbamate fungicide into a plant, increasing retention of a dithiocarbamate fungicide by a plant and/or increasing bioavailability of a dithiocarbamate fungicide to a plant comprising interacting the dithiocarbamate fungicide with a polycation through complexation by electrostatic intermolecular interaction prior to application of the dithiocarbamate fungicide to the plant, part of a plant and/or soil. The method preferably comprises interacting the dithiocarbamate fungicide with the polycation through non-covalent electrostatic interaction prior to the application.

The invention provides the use of a complex according to the invention for increasing the biological activity of a dithiocarbamate fungicide.

The invention provides the use of a macromolecular complex according to the invention for increasing the biological activity of a dithiocarbamate fungicide.

The present invention also provides a method for increasing the bioavailability of a dithiocarbamate fungicide, comprising interacting the dithiocarbamate fungicide with a polycation by complexing or encapsulating molecules of the dithiocarbamate fungicide entirely or partially within molecules of the polycation prior to application of the dithiocarbamate fungicide to a plant, part of a plant and/or soil.

The invention provides the use of a complex according to the invention for enhancing the biological activity of a dithiocarbamate fungicide.

The invention provides the use of a macromolecular complex according to the invention for enhancing the biological activity of a dithiocarbamate.

The present invention also provides a method for enhancing the bioavailability of a dithiocarbamate fungicide, comprising interacting the dithiocarbamate fungicide with a polycation by complexing or encapsulating molecules of the dithiocarbamate fungicide entirely or partially within molecules of the polycation prior to application of the dithiocarbamate fungicide to a plant, part of a plant and/or soil.

The invention provides the use of a complex according to the invention for increasing the fungicidal activity of a dithiocarbamate fungicide.

The invention provides the use of a complex according to the invention complex for increasing the biological activity of a dithiocarbamate fungicide.

The invention provides the use of a macromolecular complex according to the invention for increasing the fungicidal activity of a dithiocarbamate fungicide.

The invention provides the use of a macromolecular complex according to the invention complex for increasing the biological activity of a dithiocarbamate fungicide.

The invention provides the use of a complex according to the invention for enhancing the fungicidal activity of a dithiocarbamate fungicide.

The invention provides the use of a complex according to the invention for enhancing the biological activity of a dithiocarbamate fungicide.

In some embodiments, dithiocarbamate fungicide is mancozeb.

The invention provides the use of a complex according to the invention for increasing the fungicidal activity of mancozeb.

The invention provides the use of a complex according to the invention for increasing the biological activity of mancozeb.

The invention provides the use of a complex according to the invention for enhancing the fungicidal activity of mancozeb.

The invention provides the use of a complex according to the invention for enhancing the biological activity of mancozeb.

The invention provides the use of a complex according to the invention for prolonging the fungicidal effect of a dithiocarbamate fungicide.

The invention provides the use of a complex according to the invention for prolonging the fungicidal effect of mancozeb.

The invention provides the use of a complex according to the invention for enhancing the fungicidal activity of a dithiocarbamate fungicide.

The invention provides the use of a complex according to the invention for enhancing the biological activity of a dithiocarbamate fungicide.

The invention provides the use of a complex according to the invention for increasing the fungicidal activity of mancozeb.

The invention provides the use of a macromolecular complex according to the invention for enhancing the fungicidal activity of a dithiocarbamate fungicide.

The invention provides the use of a macromolecular complex according to the invention for enhancing the biological activity of a dithiocarbamate fungicide.

The invention provides the use of a macromolecular complex according to the invention for increasing the fungicidal activity of mancozeb.

The invention provides the use of a macromolecular complex according to the invention for increasing the biological activity of mancozeb.

The invention provides the use of a macromolecular complex according to the invention for enhancing the fungicidal activity of mancozeb.

The invention provides the use of a macromolecular complex according to the invention for enhancing the biological activity of mancozeb.

The invention provides the use of a macromolecular complex according to the invention for increasing the biological activity of mancozeb.

The invention provides the use of a macromolecular complex according to the invention for enhancing the fungicidal activity of mancozeb.

The invention provides the use of a macromolecular complex according to the invention for enhancing the biological activity of mancozeb.

The invention provides the use of a macromolecular complex according to the invention for prolonging the fungicidal effect of a dithiocarbamate fungicide.

The invention provides the use of a macromolecular complex according to the invention for prolonging the fungicidal effect of mancozeb.

The use of at least one polyelectrolyte for formulating an aqueous suspension concentrate comprising dithiocarbamate fungicide.

The use of at least one polyelectrolyte for formulating an aqueous suspension concentrate comprising mancozeb.

The use of at least one dispersant and macromolecular complex for formulating an aqueous suspension concentrate comprising dithiocarbamate fungicide.

The use of at least one dispersant and macromolecular complex for formulating an aqueous suspension concentrate comprising mancozeb.

In some embodiments, molecules of the dithiocarbamate fungicide are entirely complexed with molecules of the polycation by electrostatic interaction prior to application. In some embodiments, molecules of the dithiocarbamate fungicide are partially complexed with molecules of the polycation prior to application. In some embodiments, molecules of the dithiocarbamate fungicide are entirely encapsulated within the polycation to form a macromolecular complex prior to application. In some embodiments, molecules of the bioactive ingredient which is dithiocarbamate fungicide are partially encapsulated within the polycation to form a macromolecular complex prior to application.

The present invention also provides a method for pest control by preventive and/or knock down treatment of a plant disease caused by an insect comprising contacting a plant, a locus thereof or propagation material thereof with an effective amount of any one of the herein disclosed macromolecular complexes comprising the insecticide.

In some embodiments, at least 20% of the molecules of the dithiocarbamate fungicide are complexed by electrostatic interaction with the molecules of the polycation prior to application. In some embodiments, at least 20% of the molecules of the dithiocarbamate fungicide are encapsulated within the polycation to form the complex prior to application.

The present invention also provides a method for pest control by preventive, curative or persistence treatments of a plant disease caused by phytopathogenic fungi comprising contacting a plant, a locus thereof or propagation material thereof with an effective amount of any one of the compositions, complexes or delivery system disclosed herein.

The present invention also provides a method for controlling unwanted insects comprising applying to an area infested with said insects an effective amount of at least one of any one of the compositions, complexes or delivery system disclosed herein.

The present invention also provides a method for controlling unwanted weed comprising applying to an area infested with said weed an effective amount of at least one of any one of the compositions, complexes or delivery system disclosed herein.

The present invention also provides a method for pest control by preventive, curative and/or persistence treatment of a plant disease caused by phytopathologic fungi comprising contacting a plant, a locus thereof or propagation material thereof with an effective amount of any one of the herein disclosed macromolecular complexes comprising a dithiocarbamate fungicide. Said dithiocarbamate fungicide may include, but is not limited to, mancozeb, zineb, thiram, ziram, ferbam, metiram, propineb, and maneb.

The invention provides the use of a complex according to the invention for increasing uptake of a dithiocarbamate fungicide into a plant, increasing penetration of a dithiocarbamate fungicide into a plant, increasing retention of a dithiocarbamate fungicide by a plant and/or increasing the bioavailability of a dithiocarbamate fungicide to a plant.

The invention provides the use of a complex according to the invention for increasing the bioavailability of a dithiocarbamate fungicide.

The invention provides the use of a complex according to the invention for increasing the bioavailability of dithiocarbamate fungicides.

The invention provides the use of a macromolecular complex according to the invention for increasing uptake of a dithiocarbamate fungicide, into a plant, increasing penetration of a dithiocarbamate fungicide into a plant, increasing retention of a dithiocarbamate fungicide by a plant and/or increasing the bioavailability of a dithiocarbamate fungicide to a plant.

The invention provides the use of a macromolecular complex according to the invention for increasing the bioavailability of a dithiocarbamate fungicide.

The invention provides the use of a macromolecular complex according to the invention for increasing the bioavailability of dithiocarbamate fungicides.

The invention also provides the use of a polycation for decreasing phytotoxicity of a dithiocarbamate fungicide.

The described (macromolecular) complexes, compositions and/or delivery systems may be applied to healthy or diseased plants. The described (macromolecular) complexes, compositions and/or delivery systems can be used on various plants including but not limited to crops, seeds, bulbs, propagation material, or ornamental species.

The present invention provides a method of controlling a disease caused by phytopathogenic fungi on plants or propagation material thereof, comprising contacting the plants, the locus thereof or propagation material thereof with at least one of the herein defined macromolecular complexes, compositions or delivery systems.

The present invention provides a method for increasing the bioavailability of a dithiocarbamate fungicide, comprising interacting the dithiocarbamate fungicide with a polycation to form a macromolecular complex prior to application of the dithiocarbamate fungicide to a plant, plant part, and/or soil.

In some embodiments, the polycation interacts with the dithiocarbamate fungicide by complexing or encapsulating the dithiocarbamate fungicide partially or completely within the polycation.

The present invention provides use of any one of the compositions described herein for the protection of a plant, or a part of a plant, against a pathogen.

In some embodiments, the composition is sprayed over a plant or a part of a plant.

In some embodiments, the plant part is leaf, seed or/and fruit.

The present invention provides a method of treating a plant, or a part of a plant, against a pathogen, comprising contacting the plant, or part of the plant, with any one or any combination of the macromolecular complexes described herein, and/or any one or any combination of the compositions described herein.

In some embodiments, the macromolecular complex or composition is applied at an amount of 0.01-2 g/ha of the dithiocarbamate fungicide.

In some embodiments, the dithiocarbamate fungicide is mancozeb.

The present invention also provides a method of protecting a plant, or a part of a plant, against a pathogen, comprising contacting said plant, or part of said plant, with any one or any combination of the compositions described herein.

The present invention also provides a method of preventing, reducing and/or eliminating the presence of a pathogen on a plant, or a part of a plant, comprising contacting said plant, or part of said plant, with any one of the compositions described herein.

In some embodiments, the plant part is leaf, seed or/and fruit.

The present invention also provides a method of controlling diseases caused by phytopathogenic fungi in plants or on propagation material thereof which comprises contacting the plants, or propagation material thereof, with any one or any combination the compositions described herein.

The present invention also provides a method for reducing drift of a dithiocarbamate fungicide comprising interacting the dithiocarbamate fungicide with a polycation to form a macromolecular complex prior to application of the dithiocarbamate fungicide to a plant, plant part, and/or soil.

The present invention also provides a method for increasing rainfastness of a dithiocarbamate fungicide comprising interacting the dithiocarbamate fungicide with a polycation to form a macromolecular complex prior to application of the dithiocarbamate fungicide to a plant, plant part, and/or soil.

The present invention also provides a method for increasing persistence of a dithiocarbamate fungicide comprising interacting the dithiocarbamate fungicide with a polycation to form a macromolecular complex prior to application of the dithiocarbamate fungicide to a plant, plant part, and/or soil.

In some embodiments, the fungus is one of Leaf Blotch of Wheat (Mycosphaerella graminicola; anamorph; Septoria tritici), Wheat Brown Rust (Puccinia triticina), Stripe Rust (Puccinia striiformis f. sp. tritici), Scab of Apple (Venturia inaequalis), Blister Smut of Maize (Ustilago maydis), Powdery Mildew of Grapevine (Uncinula necator), Barley scald (Rhynchosporium secalis), Blast of Rice (Magnaporthe grisea), Rust of Soybean (Phakopsora pachyrhizi). Glume Blotch of Wheat (Leptosphaeria nodorum), Powdery Mildew of Wheat (Blumeria graminis f. sp. tritici), Powdery Mildew of Barley (Blumeria graminis f. sp. hordei), Powdery Mildew of Cucurbits (Erysiphe cichoracearum), Anthracnose of Cucurbits (Glomerella lagenarium), Leaf Spot of Beet (Cercospora beticola), Early Blight of Tomato (Alternaria solani), and Net Blotch of Barley (Pyrenophora teres).

The present invention provides a method for controlling unwanted insects comprising applying to an area infested with said insects at least one of the herein defined macromolecular complexes, compositions or delivery systems.

Insects may include but are not limited to sucking insects and chewing insects.

Sucking insects may include but are not limited to aphids and stink bugs, chewing insects may include, but are not limited to, lepidoptera, helicoverpa, pollen beetle and other chewing insects such as diamondback moth.

In some embodiments, the insect is one of Isopoda (Oniscus asellus, Armadillidium vulgare, Porcellio scaber), Diplopoda (Blaniulus guttulatus), Chilopoda (Geophilus carpophagus, Scutigera spp), Symphyla (Scutigerella immaculata), Thysanura (Lepisma saccharina), Collembola (Onychiurus armatus), Orthoptera (Acheta domesticus, Gryllotalpa spp., Locusta migratoria migratorioides, Melanoplus spp., Schistocerca gregaria), Blattaria (Blatta orientalis, Periplaneta americana, Leucophaea maderae, Blattella germanica), Dermaptera (Forficula auricularia), Isoptera (Reticulitermes spp), Phthiraptera (Pediculus humanus corporis, Haematopinus spp., Linognathus spp., Trichodectes spp., Damalinia spp), Thysanoptera (Hercinothrips femoralis, Thrips tabaci, Thrips palmi, Frankliniella occidentalis), Heteroptera (Eurygaster spp., Dysdercus intermedius, Piesma quadrata, Cimex lectularius, Rhodnius prolivus, Triatoma spp.), Homoptera (Aleurodes brassicae, Bemisia tabaci, Trialeurodes vaporariorum, Aphis gossypii, Brevicoryne brassicae, Cryptomyzus ribis, Aphis fabae, Aphis pomi, Eriosoma lanigerum, Hyalopterus arundinis, Phylloxera vastatrix, Pemphigus spp., Macrosiphum avenae, Myzus spp., Phorodon humuli, Rhopalosiphum padi, Empoasca spp., Euscelis bilobatus, Nephotettix cincticeps, Lecanium comi, Saissetia oleae, Laodelphax striatellus, Nilaparvata lugens, Aonidiella aurantii, Aspidiotus hederae, Pseudococcus spp., Psylla spp), Lepidoptera (Pectinophora gossypiella, Bupalus piniarius, Chematobia brumata, Lithocolletis blancardella, Hyponomeuta padella, Plutella xylostella, Malacosoma neustria, Euproctis chrysorrhoea, Lymantria spp., Bucculatrix thurberiella, Phyllocnistis citrella, Agrotis spp., Euxoa spp., Feltia spp., Earias insulana, Heliothis spp., Mamestra brassicae, Panolis flammea, Spodoptera spp., Trichoplusia ni. Carpocapsa pomonella, Pieris spp., Chilo spp., Pyrausta nubilalis, Ephestia kuehniella, Galleria mellonella, Tineola bisselliella, Tinea pellionella, Hofmnannophila pseudospretella, Cacoecia podana, Capua reticulana, Choristoneura fumiferana, Clysia ambiguella, Homona magnanima, Tortrix viridana, Cnaphalocerus spp., and Oulema oryzae),

From the order of the Coleoptera, for example, Anobium punctatum, Rhizopertha dominica, Bruchidius obtectus, Acanthoscelides obtectus, Hylotrupes bajulus, Agelastica alni, Leptinotarsa decemlineata, Phaedon cochleariae, Diabrotica spp., Psylliodes chrysocephala, Epilachna varivestis, Atomaria spp., Oryzaephilus surinamensis. Anthonomus spp., Sitophilus spp., Otiorrhynchus sulcatus, Cosmopolites sordidus, Ceuthorrhynchus assimilis, Hvpera postica, Dermestes spp., Trogoderma spp., Anthrenus spp., Attagenus spp., Lyctus spp., Meligethes aeneus, Ptinus spp., Niptus hololeucus, Gibbium psylloides, Tribolium spp., Tenebrio molitor. Agriotes spp., Conoderus spp., Melolontha spp., Amphimallon solstitialis, Costelytra zealandica, Lissorhoptrus oryzophilus), Hymenoptera (Diprion spp., Hoplocampa spp., Lasius spp., Monomorimn pharaonis, Vespa spp), Diptera (Aedes spp., Anopheles spp., Culex spp., Drosophila melanogaster, Musca spp., Fannia spp., Calliphora erythrocephala, Lucilia spp., Chrysomyia spp., Cuterebra spp., Gastrophilus spp., Hyppobosca spp., Stomoxys spp., Oestrus spp., Hypoderma spp., Tabanus spp., Tannia spp., Bibio hortulanus, Oscinella frit, Phorbia spp., Pegomyia hyoscyami, Ceratitis capitata, Dacus oleae. Tipula paludosa, Hylemyia spp., Liriomyza spp), Siphonaptera (Xenopsylla cheopis, Ceratophyllus spp), Arachnida (Scorpio maurus, Latrodectus mactans, Acarus siro, Argas spp., Ornithodoros spp., Dermanyssus gallinae, Eriophyes ribis, Phyllocoptruta oleivora, Boophilus spp., Rhipicephalus spp., Amblyomma spp., Hyalomma spp., xodes spp., Psoroptes spp., Choriopres spp., Sarcoptes spp., Tarsonemus spp., Bryobia praetiosa, Panonychus spp., Tetranychus spp., Hemitarsonemus spp., Brevipalpus spp), plant-parasitic nematodes (Pratylenchus spp., Radopholus similis, Ditylenchus dipsaci, Tylenchulus semipenetrans, Heterodera spp., Globodera spp., Meloidogyne spp., Aphelenchoides spp., Longidorus spp., Xiphinema spp., Trichodorus spp., and Bursaphelenchus spp).

In some embodiments, the weed is one of Alopecurus myosuroides (ALOMY). Lolium perenne (LOLPE), Matricaria recutita (MATCH). Papaver rhoeas (PAPRH), and Veronica persica (VERPE).

In some embodiments, the treatment with the macromolecular complex is pre-emergence.

In some embodiments, the treatment with the macromolecular complex is post-emergence.

In some embodiments, the macromolecular complex, composition and/or delivery system according to the invention is applied as a foliar application.

In some embodiments, the macromolecular complex, composition and/or delivery system according to the invention is applied as a soil application.

In some embodiments, the pesticide is applied at a rate effective for controlling a pest. In some embodiments, the pesticide is applied at a rate effective for preventing infestation of the pest. In some embodiments, the pesticide is applied at a rate effective for curing infestation of the pest.

In some embodiments, a method of the invention is effective for preventing infestation of a pest. In some embodiments, the method is effective for curing infestation of the pest. In some embodiments, the method is effective for increasing the pesticidal activity of the pesticide, wherein the pesticide is which is dithiocarbamate fungicide. In some embodiments, the method is effective for prolonging the pesticidal effect of the pesticide, wherein the pesticide is which is dithiocarbamate fungicide. In some embodiments, the method is effective for increasing uptake of the pesticide by the plant, increasing penetration of the pesticide into the plant, increasing retention of the pesticide by the plant, and/or increasing the bioavailability of the pesticide to the plant, wherein the pesticide is which is dithiocarbamate fungicide.

In some embodiments, a method of the invention is effective for decreasing the half maximal effective concentration (EC50) of the dithiocarbamate fungicide. In some embodiments, the method is effective for decreasing the EC50 by at least 10%. In some embodiments, the method is effective for decreasing the EC50 by at least 25%. In some embodiments, the method is effective for decreasing the EC50 by at least 35%. In some embodiments, the method is effective for decreasing the EC50 by at least 50%.

In some embodiments, a method of the invention is effective for decreasing the LC50 of the dithiocarbamate fungicide. In some embodiments, the method is effective for decreasing the LC50 by at least 10%. In some embodiments, the method is effective for decreasing the LC50 by at least 25%. In some embodiments, the method is effective for decreasing the LC50 by at least 50%. In some embodiments, the method is effective for decreasing the LC50 by at least 75%. In some embodiments, the method is effective for decreasing the LC50 by at least 90%.

In some embodiments, a method of the invention is effective for decreasing the LC90 of the dithiocarbamate fungicide. In some embodiments, the method is effective for decreasing the LC90 by at least 10%. In some embodiments, the method is effective for decreasing the LC90 by at least 25%. In some embodiments, the method is effective for decreasing the LC90 by at least 50%. In some embodiments, the method is effective for decreasing the LC90 by at least 75%. In some embodiments, the method is effective for decreasing the LC90 by at least 90%.

In some embodiments, a method of the invention further comprises applying at least one additional agrochemical to a pest, a plant part, a plant, the locus, or propagation material thereof.

In some embodiments, a macromolecular complex, composition or delivery system is tank mixed with an additional agrochemical. In some embodiments, the macromolecular complex, composition or delivery system is applied sequentially with the additional agrochemical.

In some embodiments, the macromolecular complex, composition or delivery system is tank mixed with an additional adjuvant. In some embodiments, the macromolecular complex, composition or delivery system is applied sequentially with an additional adjuvant.

In some embodiments, the adjuvant is selected from group consisting of plant oil derivatives. In some embodiments, the plant oil derivative is a vegetable oil derivative.

In some embodiments, the vegetable oil derivative is a soybean oil methyl ester.

Each embodiment disclosed herein is contemplated as being applicable to each of the other disclosed embodiments. Thus, all combinations of the various elements described herein are within the scope of the invention. In addition, the elements recited in macromolecular complex embodiments can be used in the composition, method, use, process, delivery system embodiments described herein and vice versa.

The invention is illustrated by the following examples without limiting it thereby.

### EXPERIMENTAL SECTION

Several types of polyelectrolytes were tested in the experiments described herein below: chitosan (CTS), polyallylamine (PAA) and poly-L-lysine as polycations, in combination with mancozeb.

The polycation-mancozeb macromolecular complexes were formulated in aqueous compositions at different final concentrations of the polycation (0.01 to 10%) and the mancozeb (10-90%). The macromolecular complexes were thus prepared at several weight and molar ratios between the mancozeb and the polycation in the range of 300:1 to 5:1.

### Example 1. Effect of the Polycation Chitosan (CTS) or Poly Allyl Amine (PAA) on the Structure of Mancozeb Particles

### Materials and Methods

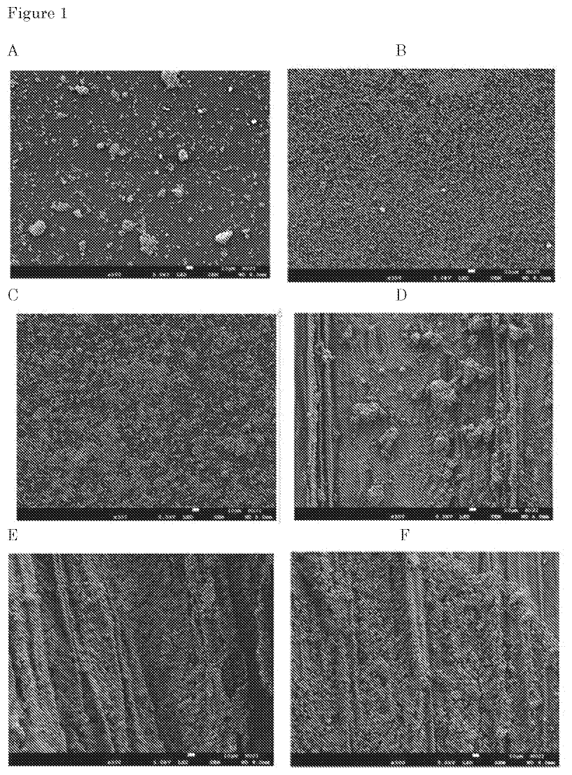

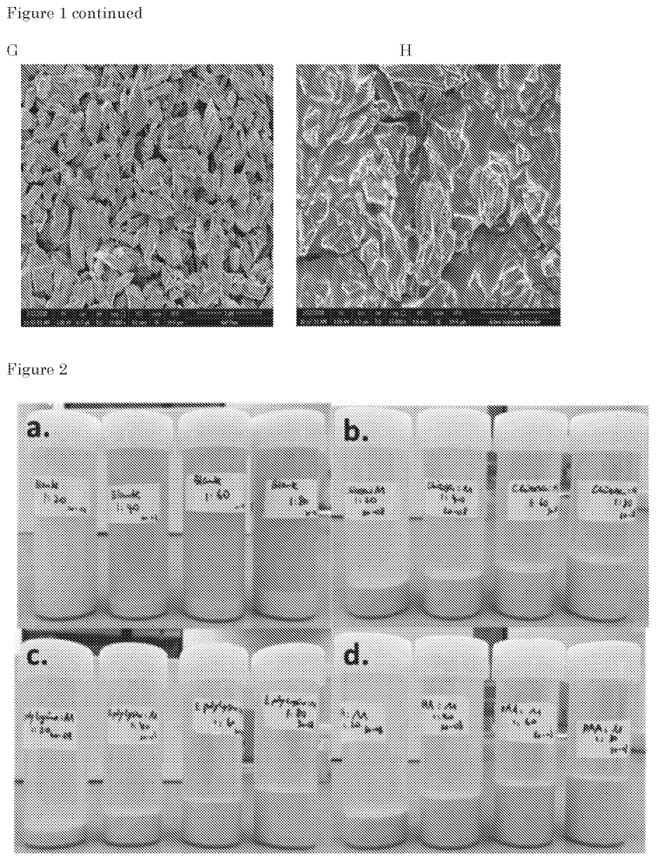

Mancozeb powder was added to a chitosan solution or polyallylamine solution at a pH of 4 using acid (e.g. hydrochloric acid). The ratio of chitosan:mancozeb was 1:64 (based on weigh/weight % of dry material). The ratio of polyallylamine:mancozeb was 1:64 (based on weigh/weight % of dry material). The control was mancozeb powder in water. The chitosan:mancozeb dispersion was mixed using a mechanical stirring device for 10 minutes. The resultant samples of chitosan-mancozeb, polyallylamine-mancozeb and of the control mancozeb were analyzed by Scanning Electron Microscopy (SEM) and pictures were taken (see FIG. 1).

### Results

The SEM pictures show that the particle structure after mixing with chitosan was very different from the control particle structure without chitosan. The SEM pictures revealed that in the Mancozeb control, particles of various size and shapes are randomly distributed. In the presence of chitosan, particles gather in a more organized structure supporting the macromolecular complex formation hypothesis.

### Conclusion

Dissolved chitosan and polyallylamine interact with mancozeb particles in an aqueous solution at pH 3 to 4 leading to a major change in morphology of the particles that improve their physical properties, increase their wettability, dispersability and stability of the formulation as well as adhesiveness to plastic and plant surfaces with improved rainfastness compared to free non-complexed marketed Manzidan 800 WG (see FIG. 1).

### Example 2. Interaction of Chitosan (CTS), Epsilon-Poly-L-Lysine (ϵ-PLL) and Poly Allyl Amine (PAA) with Mancozeb (MZ)

### Materials and Methods

To a 1 g/l polycation solution (either chitosan (CTS), ϵ-poly-L-lysine (r-PLL) or polyallylamine (PAA)), MZ powder was added to 20, 40, 60, 80 g/l of MZ, providing ratios 1:20, 1:40, 1:60 and 1:80 based on weigh/weight % of dry material (polycation:MZ). Mancozeb added to an aqueous solution served as a control. The dispersions were mixed for 10 min with a vortexing device. After standing 2 h on the lab bench the interaction layer of mancozeb complexed to the polycations and of mancozeb without polycation (control) were analyzed. In FIG. 2, pictures of the resulting sedimentation layers are presented.

### Results

All polycations tested are water soluble. The dispersion of mancozeb in water without polycations forms a relatively small sediment layer on the bottom of the bottle. If the water soluble polycations were added to the dispersions of mancozeb and mixed at a slightly acidic pH, an interaction of the polycations with the mancozeb was formed leading to a large increase in the sedimentation layer on the bottom of the bottles (more than two-fold increase).

### Conclusion

The dissolved polycations interact with mancozeb particles as is shown by the increased layer of sediment indicating the formation of a macromolecular complex.

### Example 3. Effect of Polycations on the Zeta Potential of Mancozeb Dispersions

Zeta potential is an indicator for complexation and stability of a dispersion. A zeta potential close to zero between −10 mV and +10 Mv indicates a maximum interaction between polyelectrolytes and MZ. The Zeta potential is the charge that develops at the interface between a solid surface and its liquid medium. Zeta potential values give a value of the net charge (in mV) on particle surfaces.

### Materials and Methods

To a 1 g/l aqueous polycation solution (chitosan (CTS), ϵ-poly-L-lysine or polyallylamine (PAA)), 5, 40, 60, 80 and 120 g/l of MZ powder was added, resulting in ratios 1:5, 1:40, 1:60, 1:80 and 1:120 (based on weigh/weight % of dry material), respectively. Mancozeb added to an aqueous solution served as a control. The dispersions were mixed for 10 min on a vortexing device.

The different polycation-mancozeb incubations were analyzed for the Zeta potential with a Zetasizer Nano (Malvern Instruments. United Kingdom).

### Results

Table 1 shows zeta potential measured for pure mancozeb and for different polyelectrolytes in ratio of polycation to mancozeb between 1:5 to 1:120. It was found that maximal complexation is when the ratio of polycation to mancozeb is between 1:40 to 1:80 and preferably 1:60 to 1:70.

TABLE 1
Results of zeta potential analysis of a mancozeb (MZ)
dispersion with and without the polycations chitosan
(CTS), poly allylamine (PAA) and ε-poly L lysine (εPLL).

| | | MZ + CTS | MZ + PAA |
|---|---|---|---|
| Ratio | MZ | macromolecular | macromolecular |
| polycation:mancozeb | only | complex | complex |
| 1:5 | −18.2 | 19.4 | 39.5 |
| 1:40 | −20.6 | 11.9 | 4.3 |
| 1:60 | −20.5 | 0.11 | 0.6 |
| 1:80 | −18.9 | −5.0 | −13.3 |
| 1:120 | −18.3 | −15.27 | −14.4 |

### Example 4. Fungicidal Efficacy of Macromolecular Complexes of Mancozeb with Chitosan (CTS) or Poly Allyl Amine (PAA) Compared to Control Mancozeb Towards Phakopsora pachyrhizi Strain THAI1 on Soybean Leaves on Whole Plants, Biological Experiment 1

Five compositions comprising mancozeb were prepared and their fungicidal efficacy and rainfastness, when applied at different rates, were evaluated and compared. The five compositions are as follows:
DT-CE-M2-300-01T: composition comprising mancozeb-lignosulfonate-chitosan macromolecular complex (a comparative macromolecular complex composition)
DT-CE-M2-300-02T: composition comprising mancozeb-lignosulfonate-PAA macromolecular complex (a comparative macromolecular complex composition)
DT-CE-M2-300-03T: composition comprising mancozeb particles without polyelectrolyte (a comparative composition)
DT-CE-M2-300-04T: composition comprising mancozeb-PAA macromolecular complex (a macromolecular complex of the present invention composition)
DT-CE-M2-300-05T: composition comprising mancozeb-chitosan macromolecular complex (a macromolecular complex of the present invention composition)

The following is a lab scale procedure for the preparation of the compositions comprising macromolecular complexes of the present invention:
1) Dissolve polycation (chitosan or poly-allyamine) in water and 1,2 propanediol while stirring in acidic conditions using for example 0.4% w/v of acetic acid.
2) Add the mancozeb portion-wise and mix for an additional 15-30 minutes.
3) Add antifoaming. Silcolapse 426R.
4) Add Metasperse 500L and Atlas G5002L and mix for 15-30 minutes.
5) Milling for 5 min with dispermat.
6) Add the 2% in water Rhodopol 23 pregel and the biocide (Acticide MBS) to the post milled suspension and mix until a homogeneous formulation is obtained, 30-60 minutes

The following is a lab scale procedure for the preparation of compositions comprising the comparative macromolecular complexes:
1) Dissolve Polycation (Chitosan or Poly-allyamine) in water and 1,2 propanediol while stirring in acidic conditions using for example 0.4% w/v of acetic acid.
2) Add polyanion (Borresperse CA) into the polycation solution and mix for an additional 15-30 minutes.
3) Add the mancozeb portion-wise and mix for an additional 15-30 minutes.
4) Add antifoaming, Silcolapse 426R.
5) Add Metasperse 500L and Atlas G5002L and mix for 15-30 minutes.
6) Milling for 5 min with dispermat.
7) Add the 2% in water Rhodopol 23 pregel and the biocide (Acticide MBS) to the post milled suspension and mix until a homogeneous formulation is obtained, 30-60 minutes

### Note:

All the addition and mixing time were performed using a mechanical stirrer.
The milling was performed using a Dispermat SL Nano with a 50 mL milling chamber full for≈80% of ZrO₂ beads 0.75-1.0 mm in size.
   Typical in-process parameters are summarized in Table 2 below.

TABLE 2
Typical in-process parameters

| | | | Viscosity |
|---|---|---|---|
| | Particles size | | mPas (Brookfield |
| Steps | d₅₀ | d₉₀ | SP-63) |
| End of step 2-PEM suspension | 7 | 67 | 50 |
| End of step 3-After addition of AI | 1.2 | 2.5 | 500 |
| End of step 5-After addition of | 1.6 | 3.8 | 50 |
| surfactants | | | |
| End of step 6-After milling | 1.1 | 2.6 | 150 |
| End of step 7-After Xanthan gum | 1.1 | 2.6 | 300 |
| dispersion | | | |

### Materials and Methods

To a 5 g/L polycation solution in water (either CTS, ϵ-PLL or PAA), mancozeb powder was added to provide ratios 1:20, 1:40, 1:60 and 1:80 polycation:MZ (based on weigh/weight % of dry material) at a pH of 3-6, preferably 3-4. The dispersions were mixed for 10 min with a mechanical stirrer. A Dynomill was used to reduce the particle size of the resultant complex particles to a d50 below 2 microns.

The resultant mancozeb-PAA macromolecular complex prototype was formulated to obtain an aqueous suspension concentrate composition (DT-CE-M2-300-04T, shown in Table 3) that can be further diluted in a tank mixer prior to spraying by the user. The physicochemical properties of DT-CE-M2-300-04T is shown in Table 4.

### Preparation Method for DT-CE-M2-300-04T:

1) Dissolution of PAA in water and 1,2 propanediol cosolvent while stirring in acidic conditions using for example 0.4% w/v of acetic acid.
2) Addition of mancozeb portion-wise and mixing for an additional 15-30 minutes period.
3) Addition of antifoaming, Rhodorsil 426R.
4) Addition of dispersant Metasperse 500L and Atlas G5002L and mixing for 15-30 minutes.
5) Milling for 5 min with Dispermat SL Nano milling machine in a 50 ml milling chamber with ZrO₂ beads of 0.75-1.0 mm in size.

TABLE 3
Composition comprising maneozeb-chitosan macromolecular
complex prototype (DT-CE-M2-300-04T)

| Ingredients | G/I | w/w % |
|---|---|---|
| Distilled Water | 664.8 | 55.1% |
| Mancozeb 91% | 360.0 | 29.8% |
| PAA 50% | 11.2 | 0.9% |
| Atlas G5002L | 24.0 | 2.2% |
| metasperse 500L | 24.0 | 1.9% |
| Rhodorsil 426R | 5.0 | 0.5% |
| propan 1,2 diol | 50.0 | 4.5% |
| acticide MBS | 1.000 | 0.086% |
| Rhodopol 23 | 60.0 | 4.9% |
| Total | 1200.0 | 100.00% |

TABLE 4
Physicochemical properties of DT-CE-M2-300-04T

| Viscosity (cP) | | Particle size (μm) | | | density |
|---|---|---|---|---|---|
| S63 R12 rpm | S63 R60 rpm | d0.5 | d0.9 | pH | (wth DMA) |
| 760 | 340 | 1.9 | 9.5 | 6.39 | 1.187 |

The resultant mancozeb-chitosan macromolecular complex prototype was formulated to obtain an aqueous suspension concentrate composition (DT-CE-M2-300-05T, shown in Table 5) that can be further diluted in a tank mixer prior to spraying by the user. The physicochemical properties of DT-CE-M2-300-05T is shown in Table 6.

### Preparation Method for DT-CE-M2-300-05T:

1) Dissolution of chitosan in water and 1,2 propanediol cosolvent while stirring in acidic conditions using for example 0.4% w/v of acetic acid
2) Addition of mancozeb portion-wise and mixing for an additional 15-30 minutes period.
3) Addition of antifoaming, Rhodorsil 426R.
4) Addition of dispersant Metasperse 500L and Atlas G5002L and mixing for 15-30 minutes.
5) Milling for 5 min with Dispermat SL Nano milling machine in a 50 ml milling chamber with ZrO₂ beads of 0.75-1.0 mm in size.
6) Addition of 2% in water Rhodopol 23 pregel and the biocide (Acticide MBS) to the post milled suspension and mixing until a homogeneous formulation is obtained, 30-60 minutes.

TABLE 5
Composition comprising mancozeb-chitosan macromolecular
complex prototype (DT-CE-M2-300-05T)

| Ingredients | G/I | w/w % |
|---|---|---|
| Distilled Water | 670.4 | 55.5% |
| Mancozeb 91% | 360.0 | 29.8% |
| Chitosan (WSC-2 GTC) | 5.6 | 0.5% |
| Metasphere 500L | 24.0 | 2.2% |
| Atlas G5002L | 24.0 | 12.0% |
| Rhodorsil 426R | 5.0 | 0.5% |
| propan 1,2 diol | 50.0 | 4.4% |
| acticide MBS | 1.000 | 0.079% |
| Rhodopol 23 | 60.0 | 5.1% |
| Total | 1200.0 | 100.00% |

TABLE 6
Physicochemical properties of DT-CE-M2-300-05T

| Viscosity (cP) | | Particle size (μm) | | | density |
|---|---|---|---|---|---|
| S63 R12 rpm | S63 R60 rpm | d0.5 | d0.9 | pH | (DMA) |
| 1330 | 448 | 1.5 | 4.1 | 6.42 | 1.193 |

For comparative purposes, a composition comprising mancozeb-lignosulfonate-chitosan macromolecular complex (DT-CE-M2-300-01T, shown in Table 7) was prepared and its physicochemical properties are summarized in Tables 8.

### Preparation Method for DT-CE-M2-300-01T:

1) Dissolution of chitosan in water and 1.2 propanediol cosolvent while stirring in acidic conditions using for example 0.4% w/v of acetic acid.
2) Add lignosulfonate into the chitosan solution and mix for an additional 15-30 minutes.
3) Addition of mancozeb portion-wise and mixing for an additional 15-30 minutes period.
4) Addition of antifoaming, Rhodorsil 426R.
5) Addition of dispersant Metasperse L and Atlas G5002L and mixing for 15-30 minutes.
6) Milling for 5 min with Dispermat SL Nano milling machine in a 50 ml milling chamber with ZrO₂ beads of 0.75-1.0 mm in size.
7) Addition of 2% in water Rhodopol 23 pregel and the biocide (Acticide MBS) to the post milled suspension and mixing until a homogeneous formulation is obtained, 30-60 minutes.

TABLE 7
Composition comprising comparative mancozeb-lignosulfonate-
chitosan macromolecular complex (DT-CE-M2-300-01T)

| Ingredients | G/I | w/w % |
|---|---|---|
| Distilled Water | 642.4 | 53.2% |
| Mancozeb 91% | 360.0 | 30.1% |
| Chitosan (WSC-2 GTC) | 156 | 0.5% |
| CaLS (Starlig-Ca) | 28.0 | 2.3% |
| Metasphere 500L | 24 .0 | 2.1% |
| Atlas G5002L | 24.0 | 2.1% |
| Rhodorsil 426R | 5.0 | 0.5% |
| propan 1,2 diol | 50.0 | 4.1% |
| acticide MBS | 1.000 | 10.084% |
| Rhodopol 23 | 60.0 | 5.2% |
| Total | 1200.0 | 100.00% |

TABLE 8
Physicochemical properties of DT-CE-M2-300-01T

| Viscosity (cP) | | Particle size (μm) | | | density |
|---|---|---|---|---|---|
| S63 R12 rpm | S63 R60 rpm | d0.5 | d0.9 | pH | (DMA) |
| 915 | 392 | 1.7 | 9.3 | 6.35 | 1.214 |

For comparative purposes, a composition comprising mancozeb-lignosulfonate-PAA macromolecular complex (DT-CE-M2-300-02T, shown in Table 9) was prepared and its physiochemical properties are summarized in Table 10.

Preparation method for DT-CE-M2-300-02T:
1) Dissolution of PAA in water and 1,2 propanediol cosolvent while stirring in acidic conditions using for example 0.4% w/v of acetic acid
2) Add lignosulfonate into the chitosan solution and mix for an additional 15-30 minutes.
3) Addition of mancozeb portion-wise and mixing for an additional 15-30 minutes period.
4) Addition of antifoaming, Rhodorsil 426R.
5) Addition of dispersant Metasperse 500L and Atlas G5002L and mixing for 15-30 minutes.
6) Milling for 5 min with Dispermat SL Nano milling machine in a 50 ml milling chamber with ZrO₂ beads of 0.75-1.0 mm in size.
7) Addition of 2% in water Rhodopol 23 pregel and the biocide (Acticide MBS) to the post milled suspension and mixing until a homogeneous formulation is obtained, 30-60 minutes.

TABLE 9
Composition comprising comparative mancozeb-lignosulfonate-
PAA macromolecular complex (DT-CE-M2-300-021)

| Ingredients | G/I | w/w % |
|---|---|---|
| Distilled Water | 636.9 | 53.1% |
| Mancozeb 91% | 360.0 | 29.9% |
| Chitosan (WSC-2 GTC) | 11.2 | 1.0% |
| CaLS (Starlig-Ca) | 27.9 | 2.3% |
| Metasphere 500L | 24.0 | 2.1% |
| Atlas G5002L | 24.0 | 2.1% |
| Rhodorsil 426R | 5.0 | 0.5% |
| propan 1,2 diol | 50.0 | 4.1% |
| acticide MBS | 1.000 | 0.081% |
| Rhodopol 23 | 60.0 | 5.0% |
| Total | 1200.0 | 100.00% |

TABLE 10
Physicochemical properties of DT-CE-M2-300-02T

| Viscosity (cP) | | Particle size (μm) | | | |
|---|---|---|---|---|---|
| S63 R12 rpm | S63 R60 rpm | d0.5 | d0.9 | pH | density (DMA |
| 1070 | 344 | 1.7 | 9.9 | 6.34 | 1.216 |

Finally, as a control, a composition of mancozeb particles without polyelectrolyte (DT-CE-M2-300-03T, shown in Table 11) was prepared. The physicochemical properties of DT-CE-M2-300-03T is shown in Table 12.

TABLE 11
Composition of mancozeb particles without
polyelectrolyte (DT-CE-M2-300-03T)

| Ingredients | G/I | w/w % |
|---|---|---|
| Distilled Water | 676.0 | 56.0% |
| Mancozeb 91% | 360.0 | 30.1% |
| Metasphere 500L | 24.0 | 2.2% |
| Atlas G5002L | 24.0 | 2.2% |
| Rhodorsil 426R | 5.0 | 0.5% |
| propan 1,2 diol | 50.0 | 4.7% |
| acticide MBS | 1.000 | 0.085% |
| Rhodopol 23 | 60.0 | 4.9% |
| Total | 1200.0 | 100.00% |

TABLE 12
Physicochemical properties of DT-CE-M2-300-03T

| Viscosity (cP) | | Particle size (μm) | | | density |
|---|---|---|---|---|---|
| S63 R12 rpm | S63 R60 rpm | d0.5 | d0.9 | pH | (DMA) |
| 250 | 122 | 1.4 | 4.2 | 6,49 | 1.198 |

The mancozeb-chitosan macromolecular complexes and mancozeb-PAA macromolecular complexes were analyzed towards Phakopsora pachyrhizi strain THAI1 on soybean leaves on whole plants.

The fungicidal efficacy of mancozeb as solid composition (commercial Dithan) was compared to the fungicidal efficacy of the composition comprising mancozeb-lignosulfonate-chitosan macromolecular complex (DT-CE-M2-300-01T), composition comprising mancozeb-lignosulfonate-PAA macromolecular complex (DT-CE-M2-300-021), composition comprising mancozeb-PAA macromolecular complexes (DT-CE-M2-300-04T), and composition comprising mancozeb-chitosan macromolecular complexes (DT-CE-M2-300-051), each at five rates (0.00625 Kg/ha-0.00156 Kg/ha-0.00039 Kg/ha-0.000097 Kg/ha and 0.000018 Kg/ha, corresponding to 31.25-7.81-1.95-0.49 and 0.12 mg a.i./L or ppm).

Twenty-four hours (24 h) after treatment (preventive treatment), soybean true leaves were inoculated with a calibrated uredospores suspension of the reference P. pachyrhizi strain THAI1. The inoculated soybean leaves were incubated in a climatic chamber.

Disease assessments were carried out 21 days post inoculation (dpi) and 28 dpi by measuring the length of the necrosis of the leaf fragment. The severity of infection was then determined as a percentage of the total length of the leaf fragment.

Test 1: In a curative treatment test, a first pair of unfolded true leaves (unifoliolate leaves on the first node) of soybean seedlings that are susceptible for an Asian rust cultivar (RASO4, RAGT) at the Biologische Bundesanstalt, Bundessortenamt und Chemische Industrie (BBCI) 12 growth stage, were cut and treated on their adaxial face with water (control), with each of the mancozeb macromolecular complex formulations DT-CE-M2-300-01T (mancozeb formulated in polyelectrolyte complex of lignosulfonate-chitosan), DT-CE-M2-300-02T (mancozeb formulated in polyelectrolyte complex of lignosulfonate-poly allyl amine), DT-CE-M2-300-03T (mancozeb control), DT-CE-M2-300-04T (mancozeb-poly allyl amine macromolecular complex according to the invention) and DT-CE-M2-300-05T (mancozeb-chitosan macromolecular complex according to the invention) at 260 g/Kg or L of mancozeb) or the reference mancozeb (Dithan Neotec. WG) at 750 g/Kg of Mancozeb at five rates (0.00625 Kg/ha, 0.00156 Kg/ha, 0.00039 Kg/ha, 0.000097 Kg/ha and 0.000018 Kg/ha, corresponding to 31.25, 7.81, 1.95, 0.49 and 0.12 mg active ingredient (a.i.)/L or ppm). It is noted that these tests were performed in a lab on detached leaves and using a susceptible strain of Asian rust. The amounts are much lower when compared to normal use of mancozeb in field trials.

The fungicides were prepared in a volume of water corresponding to 150 l/ha and sprayed with a hand sprayer. Control true leaves were treated with distilled water. After treatment, soybean leaves were let to dry at room temperature and then placed adaxial face up on 120×120 cm Petri dishes containing 0.4% water agar supplemented with antibiotic (anti-bacterial) and anti-senescing product (3 replicates per treatment).

Test 2: In a preventive treatment test, composition comprising mancozeb-chitosan macromolecular complexes (DT-CE-M2-300-05T), composition comprising mancozeb-PAA macromolecular complexes (DT-CE-M2-300-04T) and composition comprising mancozeb-lignosulfonate-chitosan macromolecular complexes (DT-CE-M2-300-01T) were prepared as described in Test 1. Control mancozeb, mancozeb-chitosan macromolecular complexes, mancozeb-PAA macromolecular complexes and mancozeb-lignosulfonate-chitosan macromolecular complexes were each sprayed over wheat plants by the aim of a hand sprayer. Control plants were treated with distilled water. Three replicated (pots) of 6 wheat plants each were used for each condition tested.

After treatment, wheat plants were left to dry at room temperature for 1 hour and then placed in a climatic chamber with a temperature of 24° C. day/18° C. night, photoperiod of 16 h light/8 hour dark and relative humidity of 65%.

Wheat leaf fragments of the first leaf were cut and transferred to a Petri dish containing adapted water agar (6 leaf fragments per Petri dish). Leaf fragments were inoculated with a calibrated pyenospores suspension of Zymoseptoria tritici strain Mg StA.

One (1) or three (3) days after the inoculation of soybean leaves with the pathogen, inoculated soybean leaf fragments were washed with 40 mm of distilled water. The fungicidal activity of composition comprising macromolecular complexes with mancozeb and control mancozeb DITHAN NEOTEC compositions was measured.

### Results Test 1

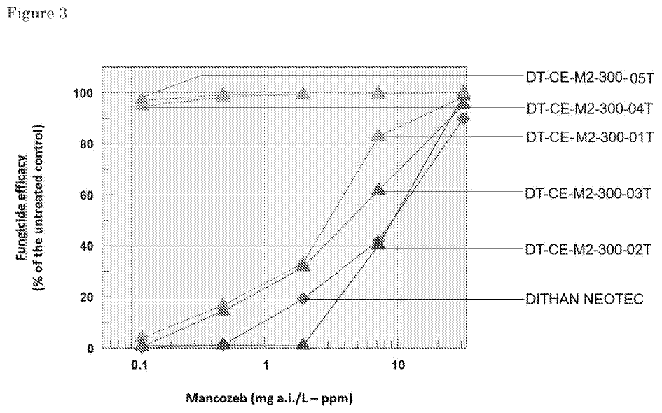

Results show that the macromolecular complexes with mancozeb according to the invention brings an added value in terms of treatment towards P. pachyrhizi strain THAI1, when compared to the control. The efficacy results are shown in Tables 13 and 14, and in FIG. 3. Especially, compositions DT-CE-M2-300-04T and DT-CE-M2-300-05T outperformed control mancozeb over the whole range, as is clearly shown in FIG. 3. The EC50 values of DT-CE-M2-300-04T and DT-CE-M2-300-05T were <0.12 ppm (see Table 14).

It was surprising that the compositions comprising mancozeb-chitosan and mancozeb-PAA macromolecular complexes according to the invention showed improved fungicidal efficacy compared to DT-CE-M2-300-01T and DT-CE-M2-300-02T which was formulated using mancozeb-lignosulfonate-chitosan macromolecular complexes and mancozeb-lignosulfonate-PAA macromolecular complexes, respectively. It is reasonable to expect that when mancozeb is replaced with another dithiocarbamate fungicide, a similar improvement in fungicidal efficacy will be observed. However, it is unclear whether this surprising improvement in fungicidal efficacy will be present when the dithiocarbamate fungicide is replaced with another bioactive ingredient.

TABLE 13
Dose-response effect (AUDPC) of DT-CE-M2-300-01T, DT-CE-M2-300-02T, DT-CE-M2-300-03T,
DT-CE-M2-300-04T and DT-CE-M2-300-05T and Dithan Neotec applied preventively,
towards P. pachyrhizi strain THAI1 on soybean leaves in controlled conditions.

| Product | 0 Kg a.i./ha | 0.000018 Kg/ha | 0.00097 Kg/ha | 0.00039 Kg/ha | 0.00156 Kg/ha | 0.00625 Kg/ha |
|---|---|---|---|---|---|---|
| DT-CE-M2-300-01T | 1125.8a^{α} | 1081.2a (4.0%) | 936.5b (16.8%) | 752.5c (33.2%) | 192.5f (82.9%) | 17.5h (98.4%) |
| DT-CE-M2-300-02T | 1125.8a | 1114.2a (1.0%) | 1113.7a (1.1%) | 1114.2a (1.0%) | 672.9d (40.2%) | 14.0h (98.8%) |
| DT-CE-M2-300-03T | 1125.8a | 1119.2a (0.6%) | 962.5b (14.5%) | 770.0c (31.6%) | 431.7e (61.7%) | 51.3g (95.4%) |
| DT-CE-M2-300-04T | 1125.8a | 58.3g (94.8%) | 18.7h (98.3%) | 7.0h (99.4%) | 8.2h (99.3%) | 0.0h (100.0%) |
| DT-CE-M2-300-05T | 1125.8a | 33.8g (97.0%) | 9.3h (99.2%) | 7.0h (99.4%) | 3.5h (99.7%) | 0.0h (100.0%) |
| Dithan Neotec | 1125.8a | 1123.3a (0.2%) | 1112.5a (1.2%) | 910.0b (19.2%) | 651.7d (42.1%) | 113.2f (89.9%) |

TABLE 14
EC₅₀ values of DT-CE-M2-300-01T, DT-CE-M2-300-02T,
DT-CE-M2-300-03T, DT-CE-M2-300-04T and
DT-CE-M2-300-05T and Dithan Neotec applied preventively,
towards P. pachyrhizi strain THAI1 on soybean leaves in
controlled conditions

| Product | EC₅₀ |
|---|---|
| DT-CE-M2-300-01T | 2.1 mg a.i./L or ppm |
| | (0.00042 Kg a.i./ha) |
| DT-CE-M2-300-02T | 9.1 mg a.i./L or ppm |
| | (0.000182 Kg a.i./ha) |
| DT-CE-M2-300-03T | 4.2 mg a.i./L or ppm |
| | (0.00084 Kg a.i./ha) |
| DT-CE-M2-300-04T | <0.12 mg a.i./L or ppm |
| | (0.000018 Kg a.i./ha) |
| DT-CE-M2-300-05T | <0.12 mg a.i./L or ppm |
| | (0.000018 Kg a.i./ha) |
| Dithan Neotec | 9.02.1 mg a.i./L or ppm |
| | (0.000180 Kg a.i./ha) |

### Conclusion Test 1

It was found that the mancozeb macromolecular complexes according to the invention had a higher efficiency than the reference commercial mancozeb towards P. pachyrhizi strain THAI1.

### Results Test 2

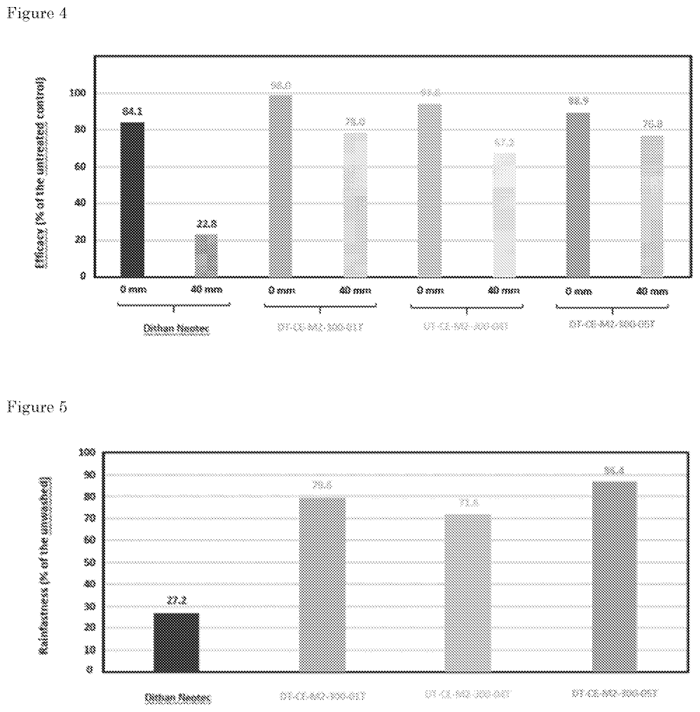

The mancozeb-chitosan macromolecular complex and the mancozeb-PAA macromolecular complex according to the invention showed improved persistent efficacy in terms of treatment towards P. pachyrhizi strain THAI1, when compared to the control. As is shown in FIG. 4, all macromolecular complexes with mancozeb showed higher efficacy already before washing the leaves with 40 mm of distilled water, when compared to the control. These differences are dramatically increased after washing the leaves with 40 mm of distilled water, as is shown by the at least three-fold increase in efficacy for all macromolecular complexes with mancozeb, when compared to the control mancozeb DITHAN NEOTEC. The rainfastness of the macromolecular complexes with mancozeb, when compared to the control mancozeb DITHAN NEOTEC is further illustrated in FIG. 5. In particular, the mancozeb-chitosan macromolecular complex showed the highest rainfastnesss.

It was surprising that the composition comprising mancozeb-chitosan macromolecular complexes according to the invention showed improved rainfastness compared to DT-CE-M2-300-01T which was formulated using mancozeb-lignosulfonate-chitosan macromolecular complexes. It is reasonable to expect that when mancozeb is replaced with another dithiocarbamate fungicide, a similar improvement in rainfastness will be observed. However, it is unclear whether this surprising improvement in rainfastness will be present when the dithiocarbamate fungicide is replaced with another bioactive ingredient.

### Conclusion Test 2

It was found that the mancozeb macromolecular complexes according to the invention had improved rainfastness, when compared to the reference commercial mancozeb, and showed higher efficacy as compared to the reference commercial mancozeb, towards P. pachyrhizi strain THAI1 after washing of treated leaves. These data show that the mancozeb-macromolecular complexes according to the invention show prolonged biological activity, in comparison to the reference commercial mancozeb.

### Example 5. Persistency of Composition Comprising Mancozeb-Chitosan Macromolecular Complexes (Composition of Table 5 Above) Compared to Control Mancozeb

### Materials and Methods

Compositions comprising mancozeb macromolecular complexes and control mancozeb compositions were produced and tested at two rates (4.69 g a.i/ha and 1.17 g a.i g/ha, corresponding to 31.25 and 7.81 mg a.i/L or ppm). The fungicides were prepared in a volume of water corresponding to 150 l/ha and sprayed with a hand sprayer. Control true soybean leaves were treated with distilled water, 3 replicates per treatment.

After treatment soybean leaves were let dry at room temperature and then placed adaxial face up on 120×120 mm Petri dishes containing 0.4% water supplemented with antibiotic and anti-senescing product (3 replicates per treatment).

One (1), two (2) and three (3) weeks after treatment soybean true leaves plants were inoculated with a calibrated urediospores suspension of the reference P. pachyrhizi strain THAI1. The inoculated soybean leaves were incubated in a climatic chamber.

### Results

The fungicidal activity of the mancozeb macromolecular complexes and control, free non-complexed commercial mancozeb, was determined.

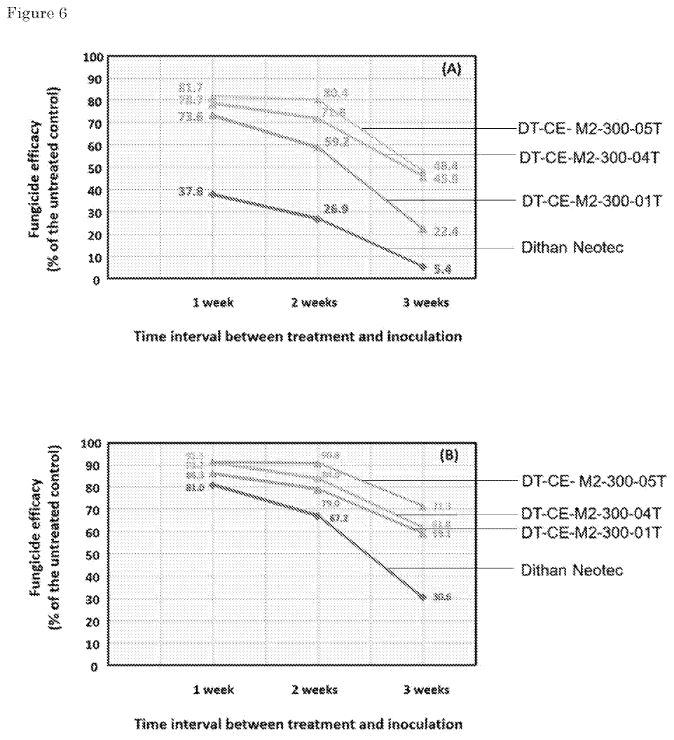

The results shown in FIG. 6 indicate that the mancozeb macromolecular complexes according to the invention bring an added value in terms of persistence treatment compared to the reference free non-complexed commercial Dithan SC towards P. pachyrhizi strain THAI1. FIG. 6(A) shows the fungicide efficacy of compositions comprising mancozeb macromolecular complexes and control mancozeb compositions applied at 1.17 g a.i./ha, corresponding 7.81 mg a.i/L or ppm. FIG. 6(B) shows the fungicide efficacy of composition comprising mancozeb macromolecular complexes and control mancozeb compositions applied at 4.69 g a.i./ha, corresponding to 31.25 mg a.i./L or ppm.

It was surprising that the composition comprising mancozeb-chitosan and mancozeb-PAA macromolecular complexes according to the invention showed improved persistence compared to DT-CE-M2-300-01T which was formulated using mancozeb-lignosulfonate-chitosan macromolecular complexes. It is reasonable to expect that when mancozeb is replaced with another dithiocarbamate fungicide, a similar improvement in persistence will be observed. However, it is unclear whether this surprising improvement in persistence will be present when the dithiocarbamate is replaced with another bioactive ingredient.

### Conclusion

It was found that the mancozeb macromolecular complexes according to the invention had improved persistent efficacy, when compared to the reference commercial mancozeb and mancozeb-lignosulfonate-chitosan macromolecular complexes (DT-CE-M2-300-01T).

### Example 6. First Optimized Composition of Mancozeb-Chitosan Macromolecular Complexes

An optimized composition of mancozeb-chitosan macromolecular complex of the present invention and a comparative formulation were prepared. The compositions and their physicochemical properties are described below.

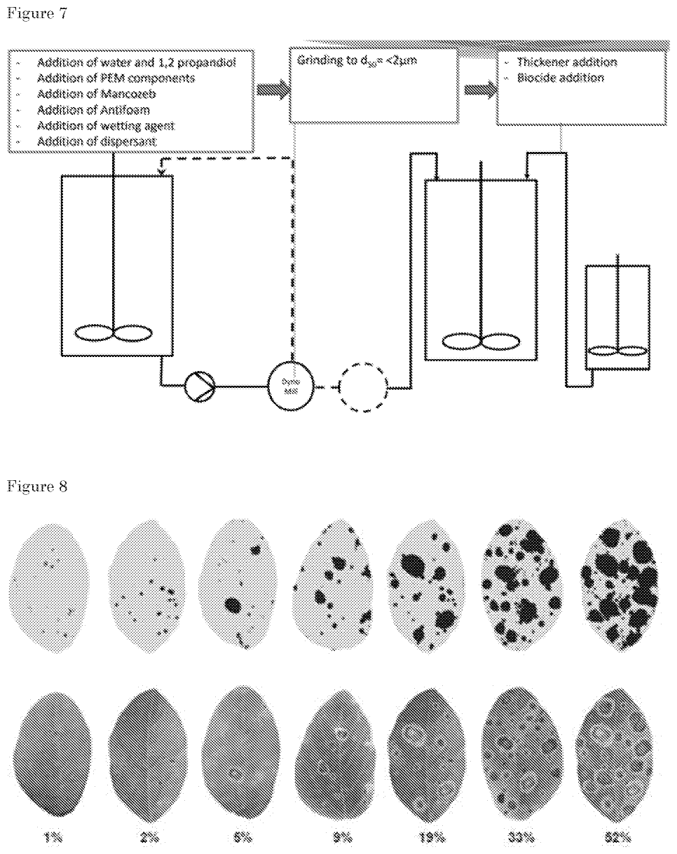

A schematic description of the procedure for the preparation of optimized compositions comprising macromolecular complexes of the present invention is shown in FIG. 7.

The mancozeb macromolecular complexes made in the previous examples had a mancozeb concentration of about 330 g/L. These optimized macromolecular complexes described below are made with an increased amount of mancozeb to provide a minimum mancozeb concentration of 350 g/L. The mancozeb loading was adjusted to meet a concentration of 360 g/L using the last available batch that has a purity of 92%.

An optimized composition of mancozeb-chitosan macromolecular complex [CF1651 (CF1600-62-18)] is provided in Table 15. The physicochemical properties of CF1651 (CF1600-62-18) is summarized in Table 16.

The procedure for preparing the optimized composition comprising chitosan-based macromolecular complexes is as follows:
1. Distilled water and 1.2 propandiol
2. Dissolution of chitosan
3. Addition of mancozeb portionwise
4. Addition of surfactants
5. Mechanical treatments (high shear mixing and/or milling)
6. Addition of viscosity modifiers (xantan gum or polymers)
7. Addition of Biocite

TABLE 15
Optimized composition comprising maneozeb-chitosan
macromolecular complex, CF1651 (CF1600-62-18)

| Ingredient | g/L | % w/w |
|---|---|---|
| Distilled Water | 639.4 | 53.3% |
| Mancozeb 92% | 391.0 | 32.6% |
| Chitosan (WSC-2 GTC) | 5.6 | 0.5% |
| Metasperse 500L | 24.0 | 2.0% |
| Atlas G5002L | 24.0 | 2.0% |
| Silcolapse 426R | 5.0 | 0.4% |
| Propan 1,2 diol | 50.0 | 4.2% |
| Acticide MBS | 1.000 | 0.083% |
| Rhodopol 23 (2% gel in water) | 60.0 | 5.0% |
| Total | 1200.0 | 100.0% |

TABLE 16
Physicochemical properties of
CF1651 (CF1600-62-18)

| | |
|---|---|
| pH | 6.44 |
| density (g/mL) | 1.206 |
| Viscosity (SP63-12 rpm-mPas) | 1100 |
| Viscosity (SP63-60 rpm-mPas) | 380 |
| Particle size (d₅₀-μm) | 1.0 |
| Particle size (d₉₀-μm) | 1.7 |

A comparative composition of mancozeb-lignosulfonate-chitosan macromolecular complex [CF1700 (CF1700-21-08)] is provided in Table 17. The physicochemical properties of CF1700 (CF1700-21-08) is summarized in Table 18.

TABLE 17
Comparative composition of mancozeb-lignosulfbnate-PAA
macromoleeular complex, CFI700 (CF 1700-21-08)

| Ingredient | g/I | % w/w |
|---|---|---|
| Distilled Water | 605.8 | 50.5% |
| Mancozeb 92% | 391.0 | 32.6% |
| PAA 50% | 11.2 | 0.9% |
| CAS (Borresperse CA) | 28.0 | 2.3% |
| Atlas G5002L | 24.0 | 2.0% |
| Metasperse 500L | 24.0 | 2.0% |
| Silcolapse 426R | 5.0 | 0.4% |
| Propan 1,2 diol | 50.0 | 4.2% |
| Acticide MBS | 1.000 | 0.08% |
| Rhodopol 23 (2% gel in water) | 60.0 | 5.0% |
| Total | 1200.0 | 100.00% |

TABLE 18
Physicochemical properties of CF1700 (CF1700-21-08)

| | |
|---|---|
| pH | 6.26 |
| density (g/mL) | 1.222 |
| Viscosity (SP63 - 12 rpm - mPas) | 1500 |
| Viscosity (SP63 - 60 rpm - mPas) | 460 |
| Particle size (d₅₀ - μm) | 1.0 |
| Particle size (d₉₀ - μm) | 1.7 |

The physicochemical data show that the mancozeb-chitosan macromolecular complex of the present invention CF1651 (CF1600-62-18) has a lower density and it is less viscous versus the comparative mancozeb-lignosulfonate-PAA macromolecular complex (CF1700 (CF1700-21-08).

### Example 7. Second Optimized Composition of Mancozeb-Chitosan Macromolecular Complexes

A second optimized composition of mancozeb-chitosan macromolecular complexes of the present invention and a comparative formulation were prepared. The compositions and their physicochemical properties are described below.

The second optimized composition of mancozeb-chitosan macromolecular complexes was produced with 3% instead of 2% of both dispersing and wetting agent and with 4% instead of 5% of xanthan gum pre-gel to overcome the viscosity increase issue observed in the previous prototypes.

The second optimized composition of mancozeb-chitosan macromolecular complexes of the present invention (CF 1655) is provided in Table 19. The physicochemical properties of CF1655 is summarized in Table 20.

TABLE 19
Composition of mancozeb-chitosan macromolecular
complexes of the present invention, CF1655

| Ingredient | G/l | w/w % | Function |
|---|---|---|---|
| Distilled Water | 603.4 | 50.3% | Continuos phase |
| Mancozeb 86.7% | 415.0 | 34.6% | AI |
| (Batch 0028-19-6720) | | | |
| Chitosan (WSC-2 GTC) | 5.6 | 0.5% | Polycation |
| Metasphere 500L | 36.0 | 3.0% | Dispersing agent |
| Atlas G5002L | 36.0 | 3.0% | Wetting agent |
| Silcolapse 426R | 5.0 | 0.4% | Antifoaming |
| propan 1,2 diol | 50.0 | 4.2% | Antifreeze-cosolvent |
| acticide MBS | 1.000 | 0.083% | Biocide |
| Rhodopol 23 | 48.0 | 4.0% | Rheology modifier |
| (2% gel inwater) | | | |
| Total | 1200.0 | 100.0% | |

TABLE 20
The physicochemical properties of CF1655

| | Batches | | |
|---|---|---|---|
| | 102-01 | 102-02 | 102-03 |
| pH pure | 6.4 | 6.4 | 6.4 |
| Density (g/mL) | 1.22 | 1.22 | 1.22 |
| Viscosity (SP63 - 12 rpm) | 880 | 740 | 110 |
| Viscosity (SP63 - 60 rpm) | 350 | 310 | 430 |
| DIN 4 CUP (s) | 30 | 25 | 35 |
| Particle size d₅₀ (μm) | 1.0 | 1.0 | 1.0 |
| Particle size d₉₀ (μm) | 2.5 | 2.6 | 2.4 |

A comparative composition of mancozeb-lignosulfonate-PAA macromolecular complex CF1705 is provided in Table 21. The physicochemical properties of CF1705 is summarized in Table 22.

TABLE 21
Composition of mancozeb-lignosulfonate-PAA
macromolecular complex, CF 1705

| Ingredient | G/l | w/w % | Function |
|---|---|---|---|
| Distilled Water | 566.8 | 47.2% | Continuos phase |
| Mancozeb 86.1% | 418.0 | 34.8% | AI |
| (Batch 242288) | | | |
| PAA 50% | 11.2 | 0.9% | Polycation |
| CaLS (Borresperse-Ca) | 28.0 | 2.3% | Polyanion |
| Atlas G5002L | 36.0 | 3.0% | Wetting agent |
| metasperse 500L | 36.0 | 3.0% | Dispersing agent |
| Silcolapse 426R | 5.0 | 0.4% | Antifoaming |
| propan 1,2 diol | 50.0 | 4.2% | Antifreeze- |
| | | | cosolvent |
| acticide MBS | 1.000 | 0.08% | Biocide |
| Rhodopol 23 | 48.0 | 4.0% | Rheology modifier |
| (2% gel in water) | | | |
| Total | 1200.0 | 100.00% | |

TABLE 22
Physicochemical properties of CF1705

| | Batches | | |
|---|---|---|---|
| | 26-01 | 26-02 | 26-03 |
| pH pure | 6.6 | 6.6 | 6.6 |
| Density (g/mL) | 1.23 | 1.24 | 1.24 |
| Viscosity (SP63 - 12 rpm) | 610 | 840 | 880 |
| Viscosity (SP63 - 60 rpm) | 260 | 350 | 360 |
| DIN 4 CUP (s) | 24 | 27 | 29 |
| Particle size d₅₀ (μm) | 1.1 | 1.1 | 1.1 |
| Particle size d₉₀ (μm) | 2.9 | 2.7 | 2.6 |

### Example 8. Toxicity Evaluation, Biological Experiment 2

CF1600-62 = DT-CE-M2-300-05T

| Ingredient | g/L | % w/w | Function | Physical state |
|---|---|---|---|---|
| Distilled Water | 611.4 | 51.0% | Continuos phase | Liquid |
| Propan 1,2 diol | 50.0 | 4.2% | Antifreeze-cosolvent | Low viscosity liquid |
| Chitosan | 5.6 | 0.5% | Polycation | Powder |
| Mancozeb 86% (360 g/L PURE) | 419.0 | 34.9% | Al | Powder |
| Silcolapse 426R | 5.0 | 0.4% | Antifoaming | Low viscosity liquid |
| Metasperse 500L | 24.0 | 2.0% | Dispersing agent | Medium viscosity liquid |
| Atlas G5002L | 24.0 | 2.0% | Wetting agent | High visoctiy liquid |
| Acticide MBS | 1.000 | 0.083% | Biocide | Liquid |
| Rhodopol 23 (2% gel in water) | 60.0 | 5.0% | Rheology modifier | Gel |
| Total | 1200.0 | 100.0% | | |

CF1600-62 = DT-CE-M2-300-02T

| Ingredient | g/L | % w/w | Function | Physical state |
|---|---|---|---|---|
| Distilled Water | 577.8 | 48.2% | Continuos phase | Liquid |
| Propan 1,2 diol | 50.0 | 4.2% | Antifreeze-cosolvent | Low viscosity liquid |
| Poly-allylamine HCl (50% in water) | 11.2 | 0.9% | Polycation | Medium viscosity liquid |
| Borresperse CA | 28.0 | 2.3% | Polyanion | Powder |
| Mancozeb 86% (360 g/L PURE) | 419.0 | 34.9% | Al | Powder |
| Silcolapse 426R | 5.0 | 0.4% | Antifoaming | Low viscosity liquid |
| Metasperse 500L | 24.0 | 2.0% | Dispersing agent | Medium viscosity liquid |
| Atlas G5002L | 24.0 | 2.0% | Wetting agent | High visoctiy liquid |
| Acticide MBS | 1.000 | 0.08% | Biocide | Liquid |
| Rhodopol 23 (2% gel in water) | 60.0 | 5.0% | Rheology modifier | Gel |
| Total | 1200.0 | 100.00% | | |

### Methodology

### Soybean Planting:

Sow soybean ant first half of December to guarantee a good SAR pressure.
Use 120 days soybean variety cycle.

### Assessments:

Severity: Assess the severity in the whole plot, considering the 3 plant parts (bottom, mid and upper). The final grade will be the mean of the 3 grades (bottom, mid and upper). If other disease is in the area, use the same criteria for SAR. Calibrate the rating according the photos in this protocol.
Take pictures of all the plots in the moments that the treatment can be differentiated
OBS: Is mandatory to assess in all time determined by the protocol to allow the AUCPD calculations, since the beginning of the disease attack
Do the harvest assessment in the (center of the plot (discard the borders) with at least 8 SQM per plot
   Statistical analysis: Use Tuckey 5%

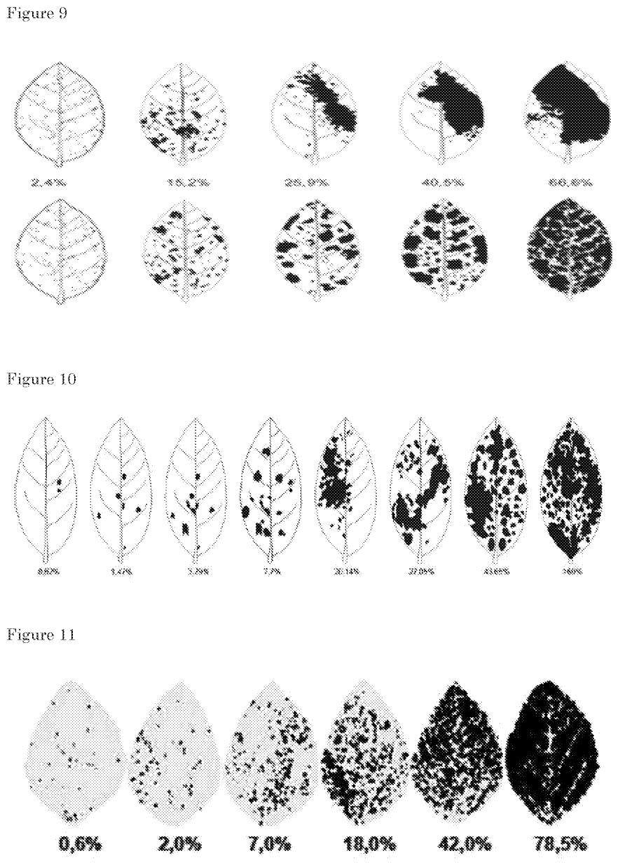

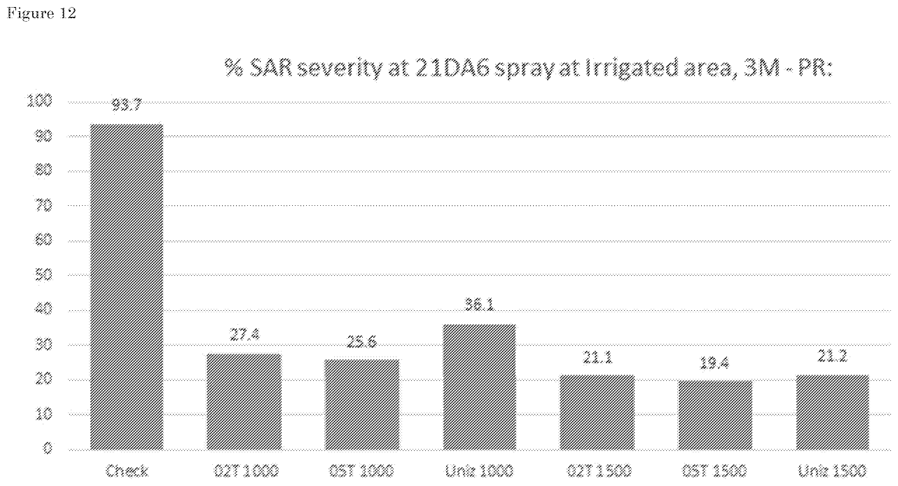

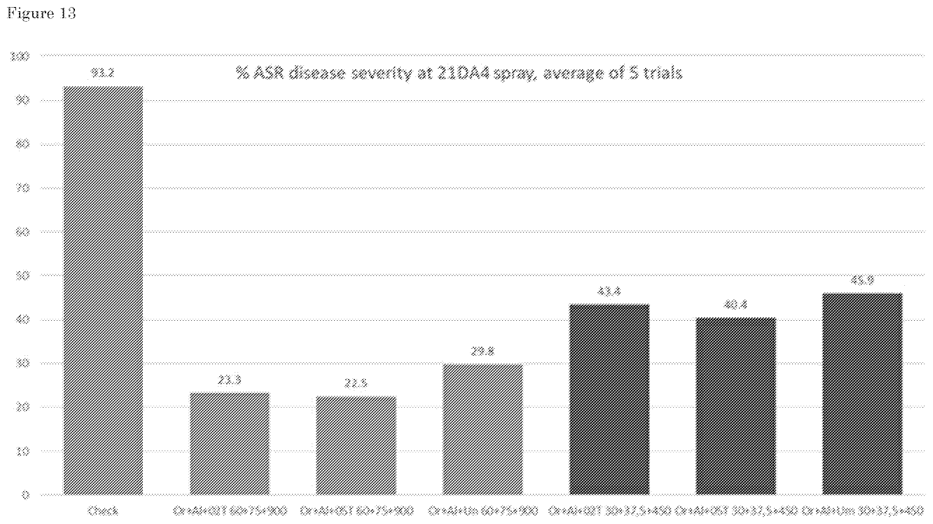

### Assessment Scale: see FIGS. 8-11

### Test 1. Efficacy of Mancozeb Macromolecular Complexes

Nr. of trials: 06 Contracted
Crop: Soybean (Glycine max)
Target: SAR (Phakopsora pachyrhizi).

### Treatments: see Table 23

TABLE 23

| | | | | g. | Rate |
|---|---|---|---|---|---|
| N. | Product | Form. | a.i. | a.a./ha | (mL or g/ha) |
| 1 | Check | — | — | — | — |
| 2 | DT CE M2 300 02T + | 347SC | mancozeb | 1.000 | 2.882 + 500 |
| | Rumba | | | | |
| 3 | DT CE M2 300 05T + | 323SC | mancozeb | 1.000 | 3.095 + 500 |
| | Rumba | | | | |
| 4 | Unizeb gold + Rumba | 750WG | mancozeb | 1.000 | 1.333 + 500 |
| 5 | Arkus | 400OD | mancozeb | 1.000 | 2500 |
| 6 | DT CE M2 300 02T + | 347SC | mancozeb | 1500 | 4.323 + 500 |
| | Rumba | | | | |
| 7 | DT CE M2 300 05T + | 323SC | mancozeb | 1500 | 4.644 + 500 |
| | Rumba | | | | |
| 8 | Unizeb gold + Rumba | 750WG | mancozeb | 1500 | 2.000 + 500 |
| 9 | Arkus | 400OD | mancozeb | 1500 | 3.750 |

Timing/Number of spray: start the first spray at RI (beginning of flowering) in preventive moment. Spray, 6 times, with an interval of 7 days.
Spray volume: 150 U/ha
Experimental design: RCBD
Plot size: 3 m×5 m
Nr. of replications: 04

### Assessments:

Severity: Assessment before all sprays and 7, 14 and 21 days after last spray. Assess the severity in the whole plot, considering the 3 plant parts (bottom, mid and upper). The final grade will be the mean of the 3 grades (bottom, mid and upper). If other disease is in the area, use the same criteria for SAR.
Calibrate the rating according the photos in this protocol.
Take pictures of all the plots in the moments that the treatment can be differentiated
OBS: Is mandatory to assess in all time determined by the protocol to allow the AUCPD calculations, since the beginning of the disease attack
Do the harvest assessment in the (center of the plot (discard the borders) with at least 8 SQM per plot
   Rainfall/irrigation: collect daily rainfall from 15 days before first spray till the harvest. For the irrigation trial, irrigate the equivalent of 20 mm 6 hours after each spray.
   Spray Equipment: back pack CO₂
   Statistical analysis: Tukey test (5%)
   Results are shown in FIG. 12.

### Test 2: Efficacy of Tank Mix of Mancozeb Macromolecular Complexes, Picoxystrobin and Tebuconazole

### Protocol: PpD-20-SJ-FI-001

Nr. of trials: 06 Contracted
Crop: Soybean (Glycine max)
Target: SAR (Phakopsora pachyrhizi).

### Treatments: see Table 24

TABLE 24

| | | | | | Rate |
|---|---|---|---|---|---|
| N. | Product | Form. | a.i. | g. a.i./ha | (mL or g/ha) |
| 1 | Check | — | — | — | — |
| 2 | Oranis + Alterne + | 250SC + | picoxi + tebucol + | 60 + 75 + 900 | 240 + 375 + |
| | DT CE M2 300 | 200EC + | mzb | | 2.594 + 0.5% v/v |
| | 02T + Rumba | 347SC | | | |
| 3 | Oranis + Alterne + | 250SC + | picoxi + tebucol + | 60 + 75 + 900 | 240 + 375 + |
| | DT CE M2 300 | 200EC + | mzb | | 2.786 + 0.5% v/v |
| | 05T + Rumba | 750WG | | | |
| 4 | Oranis + Alterne + | 250SC + | picoxi + tebucol + | 60 + 75 + 900 | 240 + 375 + |
| | Unizeb gold + | 200EC + | mzb | | 1.200 + 0.5% v/v |
| | Rumba | 400OD | | | |
| 5 | Oranis + Alterne + | 26.6 + 33.3 + | picoxi + tebucol + | 60 + 75 + 900 | 240 + 300 + |
| | Arkus + Rumba | 400 OD | mzb | | 2.250 + 0.5% v/v |
| 6 | Oranis + Alterne + | 250SC + | picoxi + tebucol + | 30 + 37.5 + 450 | 120 + 187.5 + |
| | DT CE M2 300 | 200EC + | mzb | | 1.297 + 0.5% v/v |
| | 02T + Rumba | 323SC | | | |
| 7 | Oranis + Alterne + | 250SC + | picoxi + tebucol + | 30 + 37.5 + 450 | 120 + 187.5 + |
| | DT CE M2 300 | 200EC + | mzb | | 1.393 + 0.5% v/v |
| | 05T + Rumba | 323SC | | | |
| 8 | Oranis + Alterne + | 250SC + | picoxi + tebucol + | 30 + 37.5 + 450 | 120 + 187.5 + |
| | Unizeb gold + | 200EC + | mzb | | 600 + 0.5% v/v |
| | Rumba | 400OD | | | |
| 9 | Oranis + Alterne + | 250SC + | picoxi + tebucol + | 30 + 37.5 + 450 | 120 + 187.5 + |
| | Arkus + Rumba | 200EC + | mzb | | 1.125 + 0.5% v/v |
| | | 750WG | | | |

Timing/Number of spray: start the first spray at R1 (beginning of flowering) in preventive moment. Spray, 3 to 4 times, with an interval of 14 days.
Spray volume: 150 L/ha
Experimental design: RCBD
Plot size: 3 m × 5 m
Nr. of replications: 04

### Assessments:

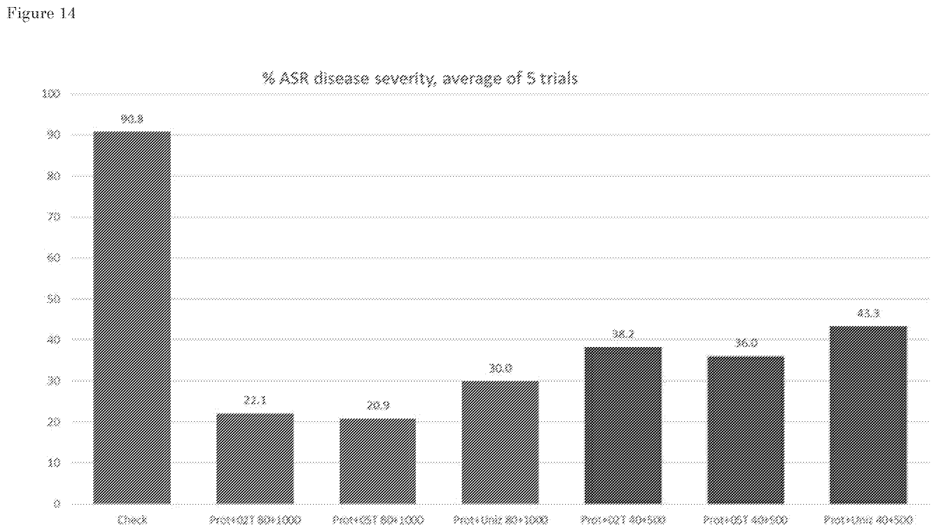

Severity: Assessment before all sprays and 7, 14 and 21 days after last spray. Assess the severity in the whole plot, considering the 3 plant parts (bottom, mid and upper). The final grade will be the mean of the 3 grades (bottom, mid and upper). If other disease is in the area, use the same criteria for SAR.
Calibrate the rating according the photos in this protocol.
Take pictures of all the plots in the moments that the treatment can be differentiated
OBS: Is mandatory to assess in all time determined by the protocol to allow the
AUCPD calculations, since the beginning of the disease attack
Do the harvest assessment in the (center of the plot (discard the borders) with at least 8 SQM per plot
   Rainfall/irrigation: collect daily rainfall from 15 days before first spray till the harvest.
   For the irrigation trial, irrigate the equivalent of 20 mm 6 hours after each spray.
   Spray Equipment: back pack CO₂
   Statistical analysis: Tukey test (5%)
   Results are shown in FIG. 13.

### Test 3: Efficacy of Tank Mix of Mancozeb Macromolecular Complexes and Prothioconazole

Nr. of trials: 06 Contracted
Crop: Soybean (Glycine max)
Target: SAR (Phakopsora pachyrhizi).

### Treatment: see Table 25

TABLE 25

| | | | | | Rate |
|---|---|---|---|---|---|
| N. | Product | Form. | a.i. | g. a.i./ha | (mL or g/ha) |
| 1 | Check | — | — | — | — |
| 2 | ADM.3500.F.2.A + | 250EC + 347SC | prothio + mzb | 80 + 1000 | 320 + 2.882 + |
| | DT CE M2 300 | | | | 0.5% v/v |
| | 02T + Rumba | | | | |
| 3 | ADM.3500.F.2.A + | 250EC + 323SC | prothio + mzb | 80 + 1000 | 320 + 3.096 + |
| | DT CE M2 300 | | | | 0.5% v/v |
| | 05T + Rumba | | | | |
| 4 | ADM.3500.F.2.A + | 250EC + | prothio + mzb | 80 + 1000 | 320 + 1.333 + |
| | Unizeb Gold + | 750WG | | | 0.5% v/v |
| | Rumba | | | | |
| 5 | ADM.3500.F.2.A + | 250EC + | prothio + mzb | 80 + 1000 | 320 + 1.333 + |
| | Arkus + | 400OD | | | 0.5% v/v |
| | Rumba | | | | |
| 6 | ADM.3500.F.2.A + | 250EC + 347SC | prothio + mzb | 40 + 500 | 160 + 1.441 + |
| | DT CE M2 300 | | | | 0.5% v/v |
| | 02T + Rumba | | | | |
| 7 | ADM.3500.F.2.A + | 250EC + 323SC | prothio + mzb | 40 + 500 | 160 + 1.548 + |
| | DT CE M2 300 | | | | 0.5% v/v |
| | 05T + Rumba | | | | |
| 8 | ADM.3500.F.2.A + | 250EC + | prothio + mzb | 40 + 500 | 160 + 666.5 + |
| | Unizeb Gold + | 750WG | | | 0.5% v/v |
| | Rumba | | | | |
| 9 | ADM.3500.F.2.A + | 250EC + | prothio + mzb | 40 + 500 | 160 + 1.250 + |
| | Arkus + | 400OD | | | 0.5% v/v |
| | Rumba | | | | |

Timing/Number of spray: start the first spray at R1 (beginning of flowering) in preventive moment. Spray, 3 to 4 times, with an interval of 14 days.
Spray volume: 150 L/ha
Experimental design: RCBD
Plot size: 3 m × 5 m
Nr. of replications: 04

### Assessments:

Severity: Assessment before all sprays and 7, 14 and 21 days after last spray. Assess the severity in the whole plot, considering the 3 plant parts (bottom, mid and upper). The final grade will be the mean of the 3 grades (bottom, mid and upper). If other disease is in the area, use the same criteria for SAR.
Calibrate the rating according the photos in this protocol.
Take pictures of all the plots in the moments that the treatment can be differentiated
OBS: Is mandatory to assess in all time determined by the protocol to allow the
AUCPD calculations, since the beginning of the disease attack
Do the harvest assessment in the (center of the plot (discard the borders) with at least 8 SQM per plot
   Rainfall/irrigation: collect daily rainfall from 15 days before first spray till the harvest.
   For the irrigation trial, irrigate the equivalent of 20 mm 6 hours after each spray.
   Spray Equipment: back pack CO₂
   Statistical analysis: Tukey test (5%)
   Results are shown in FIG. 14.

### Example 9. Effect of Order of Addition of Ingredients on the Physicochemical Properties of Mancozeb Complexes

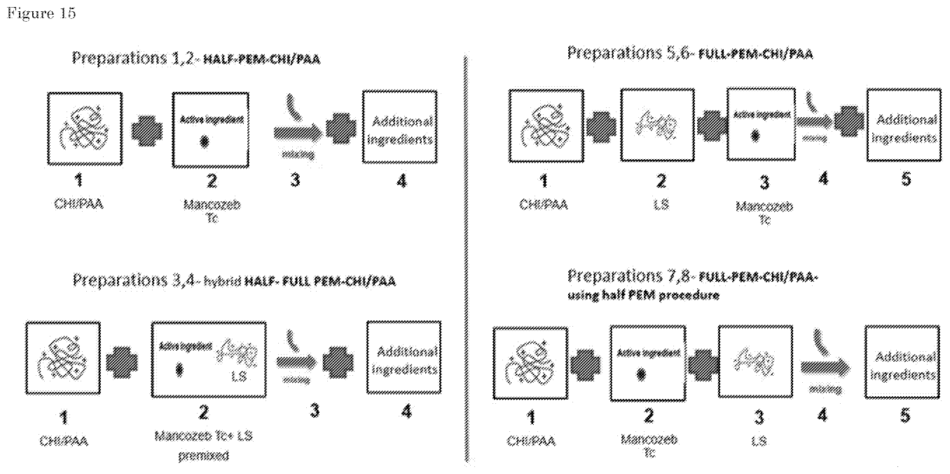

Several compositions were prepared to evaluate the effect of order of addition of the ingredients on the physicochemical properties and potential improvement of biological efficacy of lingnosulfonate:chitosan/PAA-mancozeb complexes. Eight different compositions were prepared based on the schematic illustration in FIG. 15. The eight compositions are summarized in Tables 26-33 below and differ in the order of addition of ingredients.

TABLE 26
Composition comprising mancozeb-chitosan
macromolecular complex (PT01)

| PT01 | g/L | % w/w |
|---|---|---|
| Propylene glycol | 50.0 | 4.2% |
| Chitosan-HCl (NEW CHINESE) | 5.6 | 0.5% |
| Distilled Water | 600.4 | 50.0% |
| Mancozeb 86.1% (360 g/L pure) | 418.0 | 34.8% |
| Silcolapse 426R | 5.0 | 0.4% |
| Atlas G5002L | 36.0 | 3.0% |
| Metasperse 500L | 36.0 | 3.0% |
| Acticide MBS | 1.000 | 0.083% |
| Rhodopol 23 (2% gel in water) | 48.0 | 4.0% |
| Total | 1200.0 | 100.0% |

TABLE 27
Composition comprising mancozeb-PAA
macromolecular complex (PT02)

| PT02 | g/L | % w/w |
|---|---|---|
| Propylen glycol | 50.0 | 4.2% |
| Distilled Water | 594.8 | 49.6% |
| PAA-HCl 50% (NEW CHINESE) | 11.2 | 0.9% |
| Mancozeb 86.1% (360 g/L pure) | 418.0 | 34.8% |
| Silcolapse 426R | 5.0 | 0.4% |
| Atlas G5002L | 36.0 | 3.0% |
| Metasperse 500L | 36.0 | 3.0% |
| Acticide MBS | 1.000 | 0.083% |
| Rhodopol 23 (2% gel in water) | 48.0 | 4.0% |
| Total | 1200.0 | 100.0% |

### Procedures for Preparing the Compositions of Tables 26 and 27:

Prepare a homogeneous solution of polycation (Chitosan or PAA) in water and propylene glycol
Add the mancozeb portion wise and stir for at least 30 minutes
Add Silcolapse 426R
Add Atlas G5002L
Add Metasperse 500L and stir for at least 30 minutes
Mill using Dispermat for 5 minutes
Add Acticide MBS
Add Rhodopol 23 pregel in water and mix until a homogeneous formulation is obtained

TABLE 28
Composition comprising mancozeb-chitosan
macromolecular complexes wherein the mancozeb
is premixed with lignosulfonate (PT03)

| PT03 | g/L | % w/w |
|---|---|---|
| Propylene glycol | 50.0 | 4.2% |
| Chitosan-HC1 (NEW CHINESE) | 5.6 | 0.5% |
| Distilled Water | 572.4 | 47.7% |
| Mancozeb 86.1% (360 g/L pure)* | 418.0 | 34.8% |
| Calcium Lignosulfonate* | 28.0 | 2.3% |
| Silcolapse 426R | 5.0 | 0.4% |
| Atlas G5002L | 36.0 | 3.0% |
| Metasperse 500L | 36.0 | 3.0% |
| Acticide MBS | 1.000 | 0.083% |
| Rhodopol 23 (2% gel in water) | 48.0 | 4.0% |
| Total | 1200.0 | 100.0% |

*Premixed together as powders

TABLE 29
Composition comprising mancozeb-PAA
macromolecular complexes wherein the mancozeb
is premixed with lignosulfonate (PT04)

| PT04 | g/L | % w/w |
|---|---|---|
| Propylen Glycol | 50.0 | 4.2% |
| Distilled Water | 566.8 | 47.2% |
| PAA-HCl 50% (NEW CHINESE) | 11.2 | 0.9% |
| Mancozeb 86.1% (360 g/L pure)* | 418.0 | 34.8% |
| Calcium lignosulfonate* | 28.0 | 2.3% |
| Silcolapse 426R | 5.0 | 0.4% |
| Atlas G5002L | 36.0 | 3.0% |
| Metasperse 500L | 36.0 | 3.0% |
| Acticide MBS | 1.000 | 0.083% |
| Rhodopol 23 (2% gel in water) | 48.0 | 4.0% |
| Total | 1200.0 | 100.0% |

*Premixed together as powders

### Procedure for Preparing the Compositions of Tables 28 and 29:

Prepare a homogeneous solution of polycation (Chitosan or PAA) in water and propylene glycol
Add the mancozeb premixed with lignosulfonate portion wise and stir for at least 30 minutes
Add Silcolapse 426R
Add Atlas G5002L
Add Metasperse 500L and stir for at least 30 minutes
Mill using Dispermat for 5 minutes
Add Acticide MBS
Add Rhodopol 23 pregel in water and mix until a homogeneous formulation is obtained

TABLE 30
Compositions comprising mancozeb-lignosulfonate-chitosan
macromolecular complexes (PT05)

| PT05 | g/L | % w/w |
|---|---|---|
| Propylene glycol | 50.0 | 4.2% |
| Chitosan-HCl (NEW CHINESE) | 5.6 | 0.5% |
| Distilled Water | 572.4 | 47.7% |
| Calcium lignosulfonate | 28.0 | 2.3% |
| Mancozeb 86.1% | 418.0 | 34.8% |
| Silcolapse 426R | 5.0 | 0.4% |
| Atlas G5002L | 36.0 | 3.0% |
| Metasperse 500L | 36.0 | 3.0% |
| Acticide MBS | 1.000 | 0.083% |
| Rhodopol 23 (2% gel in water) | 48.0 | 4.0% |
| Total | 1200.0 | 100.0% |

TABLE 31
Compositions comprising mancozeb-lignosulfonate-
PAA macromolecular complexes (PT06)

| PT06 | g/L | % w/w |
|---|---|---|
| Propylene glycol | 50.0 | 4.2% |
| Distilled Water | 566.8 | 47.2% |
| PAA-HCl 50% (NEW CHINESE) | 11.2 | 0.9% |
| Calcium lignosulfonate | 28.0 | 2.3% |
| Mancozeb 86.1% | 418.0 | 34.8% |
| Silcolapse 426R | 5.0 | 0.4% |
| Atlas G5002L | 36.0 | 3.0% |
| Metasperse 500L | 36.0 | 3.0% |
| Acticide MBS | 1.000 | 0.083% |
| Rhodopol 23 (2% gel in water) | 48.0 | 4.0% |
| Total | 1200.0 | 100.0% |

### Procedures for Preparing the Compositions of Tables 30 and 31:

Prepare a homogeneous solution of polycation (Chitosan or PAA) in water and propylene glycol
Add the calcium lignosulfonate and stir for 15-30 minutes
Add the mancozeb portion wise and stir for at least 30 minutes
Add Silcolapse 426R
Add Atlas G5002L
Add Metasperse 500L and stir for at least 30 minutes
Mill using Dispermat for 5 minutes
Add Acticide MBS
Add Rhodopol 23 pregel in water and mix until a homogeneous formulation is obtained

TABLE 32
Composition comprising mancozeb-chitosan macromolecular
complex and lignosulfonate as dispersing agent (PT07)

| PT07 | g/L | % w/w |
|---|---|---|
| Propylene glycol | 50.0 | 4.2% |
| Chitosan-HCl (NEW CHINESE) | 5.6 | 0.5% |
| Distilled Water | 572.4 | 47.7% |
| Mancozeb 86.1% (360 g/L pure) | 418.0 | 34.8% |
| Calcium Lignosulfonate | 28.0 | 2.3% |
| Silcolapse 426R | 5.0 | 0.4% |
| Atlas G5002L | 36.0 | 3.0% |
| Metasperse 500L | 36.0 | 3.0% |
| Acticide MBS | 1.000 | 0.083% |
| Rhodopol 23 (2% gel in water) | 48.0 | 4.0% |
| Total | 1200.0 | 100.0% |

TABLE 33
Composition comprising mancozeb-PAA
macromolecular complex and
lignosulfonate as dispersing agent (PT08)

| PT08 | g/L | % w/w |
|---|---|---|
| Propylen Glycol | 50.0 | 4.2% |
| Distilled Water | 566.8 | 47.2% |
| PAA-HCl 50% (NEW CHINESE) | 11.2 | 0.9% |
| Mancozeb 86.1% (360 g/L pure) | 418.0 | 34.8% |
| Calcium lignosulfonate | 28.0 | 2.3% |
| Silcolapse 426R | 5.0 | 0.4% |
| Atlas G5002L | 36.0 | 3.0% |
| Metasperse 500L | 36.0 | 3.0% |
| Acticide MBS | 1.000 | 0.083% |
| Rhodopol 23 (2% gel in water) | 48.0 | 4.0% |
| Total | 1200.0 | 100.0% |

### Procedures for Preparing the Compositions of Tables 32 and 33:

Prepare a homogeneous solution of polycation (Chitosan or PAA) in water and propylene glycol
Add the mancozeb portion wise and stir for at least 30 minutes
Add the calcium lignosulfonate and stir for 15-30 minutes
Add Silcolapse 426R
Add Atlas G5002L
Add Metasperse 500L and stir for at least 30 minutes
Mill using Dispermat for 5 minutes
Add Acticide MBS
Add Rhodopol 23 pregel in water and mix until a homogeneous formulation is obtained
   The physicochemical properties of the compositions of Tables 26-33 are summarized in Table 34 below.

TABLE 34
Analysis of physicochemical properties

| | PT01 | PT02 | PT03 | PT04 | PT05 | PT06 | PT07 | PT08 |
|---|---|---|---|---|---|---|---|---|
| pH | 6.4 | 6.4 | 6.5 | 6.4 | 6.5 | 6.4 | 6.5 | 6.4 |
| Density (g/mL) | 1.21 | 1.21 | 1.22 | 1.23 | 1.23 | 1.21 | 1.25 | 1.25 |
| Viscosity | 1680 | 650 | 1610 | 680 | 790 | 1130 | 1000 | 670 |
| (SP63-12 rpm) | | | | | | | | |
| Viscosity | 660 | 250 | 630 | 290 | 350 | 450 | 460 | 320 |
| (SP63-60 rpm) | | | | | | | | |
| d₅₀ (μm) | 0.6 | 1.1 | 0.6 | 0.8 | 1.1 | 1.1 | 1.1 | 1.1 |
| d₉₀ (μm) | 1.2 | 1.9 | 1.2 | 1.3 | 1.9 | 2.2 | 1.8 | 2.8 |

### Differences in Viscosity

PT03 and PT04 are compositions comprising the mancozeb complexes where the mancozeb is premixed with the lignosulfonate polyanion. In terms of viscosity, PT03 and PT04 behave more like PT01 and PT02 than PT05 and PT06. This is a first positive indication that the different methodology between PT03 and PT04 versus PT05 and PT06 could lead to different results even if the composition is the same. Moreover, the values for PT07 and PT08 where the lignosulfonate is added as a dispersant later in the preparation process are intermediate between the comparative macromolecular complexes (PT05 and PT06) and the macromolecular complexes of the present invention (PT01 and PT02).

### Differences in Metal Analysis and Solubilized Lignosulfonate

### Metal Analysis Method

The following procedure was used to analyze the metal content of each sample:
Transfer three times about 2 mL of the homogeneous samples in 3 separate Eppendorf 2.5 mL vials.
Centrifugate those vials for 20 minutes at 14000 rpm.
Recover the supernatant turbid solution and collect the 3 fractions in 1 common vial.
Centrifugate this second vial for 15 minutes at 14000 rpm.
Recover the supernatant solution that would be sent to an external laboratory for analysis trough ICP-MS. In case after the second centrifugation some turbidity is still present the supernatant was passed through a 0.45 μm PTFE filter to make sure to eliminate any influence of the suspended Mancozeb in the determination of the content of metals.

### Lignosulfonate Quantification Method

The following procedure was used to quantify the amount of lignosulfonate in each sample:
Transfer three times about 2 mL of the homogeneous samples in 3 separate Eppendorf 2.5 mL vials.
Centrifugate those vials for 20 minutes at 14000 rpm.
Recover the supernatant turbid solution and collect the 3 fractions in 1 common vial.
Centrifugate this second vial for 15 minutes at 14000 rpm.
Recover the supernatant solution. In case after the second centrifugation some turbidity is still present the supernatant was passed through a 0.45 μm PTFE filter.

After this samples preparation all the solution were clear and represent an undiluted sample of the original formulations/pre-formulated.

Ultraviolet-visible spectroscopy (UV-Vis) analysis was used. To be able to quantify the amount of lignosulfonate, a calibration curve was prepared using some known concentrations solution made with Borresperse CA. From Lambert Beer law, it is known that a linear relationship between concentration and absorbance can be established in a limited range of absorbance, usually below 1. The linear relationship is summarized in Table 35 below.

TABLE 35

| ID | C (mg/L) | A (280 nm) |
|---|---|---|
| A | 100.0 | 0.924 |
| B | 80.0 | 0.741 |
| C | 60.0 | 0.559 |
| D | 40.0 | 0.384 |
| E | 20.0 | 0.195 |
| F | 10.0 | 0.116 |

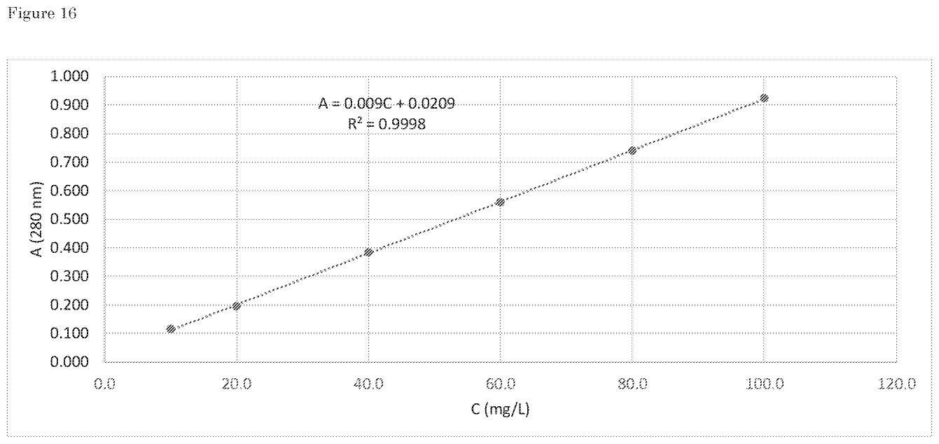

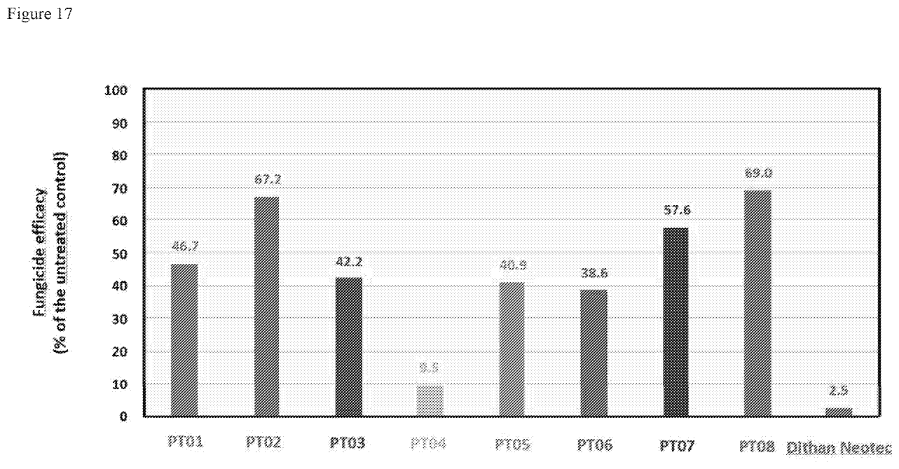

The calibration curve is shown in FIG. 16.

This concentrations are low and therefore samples were diluted 500 times to measure an absorbance in the range 0.1-1.

The metal analysis results for each sample and percentage of solubilized lignosulfonate in each sample are summarized in Tables 36, 37 and 38 below.

TABLE 36

| | C (mg/L) | | | % |
|---|---|---|---|---|
| | | | Mn²⁺ + | lignosulfonate |
| Pre-Formulated* | Mn²⁺ | Zn²⁺ | Zn²⁺ | solubilized |
| PT01 Chit | 5590 | 2610 | 8200 | 10% |
| PT02 PAA | 5100 | 3140 | 8240 | 9% |
| NO polyelectrolyte | 4450 | 2670 | 7120 | 13% |

*Preformlated are samples with only water (+ cosolvent propylene glycol), polycation and mancozeb technical without all the additional ingredients.

TABLE 37

| | C (mg/L) | | | % |
|---|---|---|---|---|
| | | | Mn²⁺ + | lignosulfonate |
| Formulations** | Mn²⁺ | Zn²⁺ | Zn²⁺ | solubilized |
| PT01 Chit | 5710 | 660 | 6370 | 43% |
| PT02 PAA | 6910 | 440 | 7350 | 23% |
| NO polyelectrolyte | 5410 | 480 | 5890 | 48% |

**Formulations are whole formulations, with all ingredients as usual. The idea behind was to observe the interaction mancozeb-polycation macromolecular complex without the possible interference of all the other ingredients.

From metal analysis, it is clear that the macromolecular complexes of the present invention have a higher release of metal in solution, in line with the hypothesis that the polycation interact with mancozeb to (partially) create a new complex with the mancozeb that lead to some metal of the mancozeb to be released in solution.

From the point of view of the lignosulfonate in solution, the differences are clearer when comparing the formulations. Considering the pre-formulated macromolecular complex, no differences in solubilized sodium lignosulfonate is in line with the hypothesis that the polycations prefer to interact with mancozeb instead of the sodium lignosulfonate present in it. The level of solubilized sodium lignosulfonate in the formulations are higher across the board, these levels are justified considering that the sodium lignosulfonate present in the technical mancozeb is displaced from the interaction with mancozeb by dispersing agent from other inert additives (dispersant=Metasperese500L) in the mixture and therefore the sodium lignosulfonate is found more in solution. In absence of other competitors (NO PEM Preformulated), most of the sodium lignosulfonate present in the technical mancozeb is interacting with mancozeb strongly enough to not be anymore soluble in the water phase.

TABLE 38

| | C (mg/L) | | | % |
|---|---|---|---|---|
| | | | Mn²⁺ + | lignosulfonate |
| Pre-Formulated | Mn²⁺ | Zn²⁺ | Zn²⁺ | solubilized |
| PT05 Chit (Comparative PEM) | 5020 | 2980 | 8000 | 27% |
| PT03 Chit | 5030 | 3170 | 8200 | 37% |
| PT07 Chit | 4500 | 2930 | 7430 | 39% |
| PT06 FAA (Comparative PEM) | 4480 | 3000 | 7480 | 23% |
| PT04 PAA | 4570 | 3430 | 8000 | 34% |
| PT08 FAA | 4650 | 3540 | 8190 | 35% |

P105 Chit = mancozeb-chitosan-lignosulfonate macromolecular complex
PT03 Chit = chitosan-mancozeb (premixed with CaLS) macromolecular complex
PT07 Chit = chitosan-mancozeb (with CAS added later as dispersant) macromolecular complex
PT06 FAA = mancozeb-PAA-lignosulfonate macromolecular complex
PT04 PAA = PAA-mancozeb (premixed with CaLS) macromolecular complex
PT08 PAA = PAA-mancozeb (with CaLS added later as dispersant) macromolecular complex

From metal analysis, in most cases, the amount of metals in solution is higher in case of the macromolecular complexes of the present invention+CaLS (PT03 and PT04). This is in line with the hypothesis that adding CaLS later in the process does not disrupt (completely) the polycation/Mz new adduct formation.

The lignosulfonate analysis confirms that the amount of lignosulfonate available for dissolution in the water phase increases with the addition of calcium lignosulfonate. This is line with the hypothesis that the later added lignosulfonate does not (completely) interact with the polycation to form a polyelectrolyte matrix.

### Differences in Biological Efficacy

FIG. 17 shows the fungicidal efficacy of mancozeb compositions PT01, PT02, PT03, PT04, PT05, PT06, PT07, PT08 and the reference mancozeb formulation Dithan Neotec used preventively at 0.75 g a.i./ha towards Phakopsora pachyrhizi strain THAI1 obtained from the AUDPC values.

Macromolecular complexes of the present invention samples PT01 and PT02 showed higher preventative fungicidal efficacy compared to samples PT05 and PT06, especially when PAA is used as the polycation (PT02 compared to PT06). This demonstrates that formation of the macromolecular complex first between the polycation and the mancozeb achieves improved efficacy compared to interaction of the polycation and polyanion first and then add the mancozeb. The samples PT07 and PT8 clearly showed that preparing macromolecular complexes by using the process of the present invention, namely interacting the polycation with the mancozeb first and adding the lignosulfonate later as dispersant, also result in improved efficacy that is comparable to the efficacy observed for the samples PT01 and PT02. The samples PT03 and PT04 which are compositions comprising the mancozeb complexes where the mancozeb is premixed with the lignosulfonate polyanion show lower efficacies especially when PAA is used as the cation. This indicates again that the different methodologies of preparation used for PT03 and FT04 versus PT05 and PT06 in terms of the order of addition of the ingredients lead to different results even if the components are the same.

From the fungicidal efficacy data, it is clear that the macromolecular complexes of the present invention have a higher biological efficacy, in line with the hypothesis that the polycation interacts with mancozeb to create a new complex with the mancozeb that leads to some metal ions of the mancozeb to be released in solution resulting in enhanced biological efficacy.

### Example 10. Metal Analysis of Macromolecular Complexes and Formulations Thereof

Complexes (pre-formulated) and formulations thereof were prepared, and metal analysis was conducted. The results are shown in Tables 39 and 40 below.

TABLE 39
Metal analysis of pre-formulated
macromolecular complexes

| | C (mg/L) | | |
|---|---|---|---|
| Pre- | | | Mn²⁺ + |
| Formulated | Mn²⁺ | Zn²⁺ | Zn²⁺ |
| PT05 Chit | 5020 | 2980 | 8000 |
| PT01 Chit | 5590 | 2610 | 8200 |
| PT06 PAA | 4480 | 3000 | 7480 |
| PT02 PAA | 5100 | 3140 | 8240 |

PT05 Chit = mancozob-chitosan-lignosulionate macromolecular complex
PT01 Chit = chitosan-mancozob macromolecular complex
PT06 PAA = mancozeb-PAA-lignosulfonate macromolecular complex
PT02 PAA = PAA-mancozeb macromolecular complex
NO PEM = mancozeb without polyelectrolyte

TABLE 40
Metal analysis of formulated
macromolecular complexes

| | C (mg/L) | | |
|---|---|---|---|
| | | | Mn²⁺ + |
| Formulations | Mn²⁺ | Zn²⁺ | Zn²⁺ |
| PT05 Chit | 4920 | 440 | 5360 |
| PT01 Chit | 5710 | 660 | 6370 |
| PT06 PAA | 4960 | 210 | 5170 |
| PT02 PAA | 6910 | 440 | 7350 |
| NO PEM | 5410 | 480 | 5890 |

PT05 Chit = -mancozeb-chitosan-lignosulfonate macromolecular complex
PT01 Chit = chitosan-mancozeb macromolecular complex
PT06 PAA = mancozeb-PAA-lignosulfonate macromolecular complex
PT02 PAA = PAA-mancozeb macromolecular complex
NO PEM = mancozeb without polyelectrolyte

### Discussion:

In the pre-formulated samples, the amount of released metals is always higher in samples with polyelectrolyte compared to the sample with no polyclectrolyte. Only a slight advantage of PT01 and PT02 against PT05 and PT06 is noticeable for chitosan. In PAA the difference is more visible.

However, in the full formulations, it is visible that the samples of the present invention PT01 and PT02 have a significant higher release of metal in solution, in line with the hypothesis of partial formation of complex/adduct polycations/mancozeb, while the comparative samples PT05 and PT06 have an opposite trend where the amount of metal released is significantly lower. These data support the hypothesis that in the comparative samples (PT05 and PT06), the polyelectrolyte works as a stabilizer/protector of the mancozeb complex because less metals are released in solution compared to the reference sample with no polyelectrolyte.

Overall, the macromolecular complexes samples of the present invention and the comparative samples were shown to be quite different.

### Example 11. 350SC Composition Comprising Mancozeb-Chitosan Macromolecular Complex

### Preparation Method:

1) Dissolve chitosan in water and 1,2 propanediol while stirring.
2) Add the mancozeb portion-wise and mix for an additional 15-30 minutes.
3) Add antifoaming, Silcolapse 426R.
4) Add Metasperse 500L and Atlas G5002L and mix for 15-30 minutes.
5) Milling for 5 min with dispermat.
6) Add the 2% in water Rhodopol 23 pregel and the biocide (Acticide MBS) to the post milled suspension and mix until a homogeneous formulation is obtained, 30-60 minutes.

### Note:

All the addition and mixing time were performed using a mechanical stirrer.
The milling was performed using a Dispermat SL Nano with a 50 mL milling chamber full for 80% of ZrO₂ beads 0.75-1.0 mm in size.

The in-process parameters are summarized in Table 41. The resultant suspension concentration (SC) composition comprising 350 g/L of mancozeb. i.e. CF1600-62=DT-CE-M2-300-05T, is provided in Table 42.

TABLE 41
In-process parameters

| | Particles | | Viscosity |
|---|---|---|---|
| | size | | mPas |
| Steps | d₅₀ | d₉₀ | (Brookfield SP-63) |
| End of step 2-PEM suspension | 7 | 67 | 50 |
| End of step 3-After addition of AI | 1.2 | 2.5 | 500 |
| End of step 5-After addition | 1.6 | 3.8 | 50 |
| of surfactants | | | |
| End of step 6-After milling | 1.1 | 2.6 | 150 |
| End of step 7-After | 1.1 | 2.6 | 300 |
| Xanthan gum dispersion | | | |

TABLE 42
3.50SC Composition

| | | | | Physical |
|---|---|---|---|---|
| Ingredient | g/L | % w/w | Function | state |
| Distilled Water | 611.4 | 51.0% | Continuos phase | Liquid |
| Propan 1,2 diol | 50.0 | 4.2% | Antifreeze- | Low |
| | | | cosolvent | viscosity |
| | | | | liquid |
| Chitosan | 5.6 | 0.5% | Polycation | Powder |
| Mancozeb 86% | 419.0 | 34.9% | AI | Powder |
| (360 g/L PURE) | | | | |
| Silcolapse 426R | 5.0 | 0.4% | Antifoaming | Low |
| | | | | viscosity |
| | | | | liquid |
| Metasperse 500L | 24.0 | 2.0% | Dispersing | Medium |
| | | | agent | viscosity |
| | | | | liquid |
| Atlas G5002L | 24.0 | 2.0% | Wetting agent | High |
| | | | | visoctiy |
| | | | | liquid |
| Acticide MBS | 1.000 | 0.083% | Biocide | Liquid |
| Rhodopol 23 | 60.0 | 5.0% | Rheology | Gel |
| (2% gel in water) | | | modifier | |
| Total | 1200.0 | 100.0% | | |

### Example 12. 400SC Composition Comprising Mancozeb-Chitosan Macromolecular Complex without Triton HW-1000

The 400SC composition comprising mancozeb-chitosan macromolecular complex without Triton HW-1000 was prepared using the following method:
1) Add water to the reactor,
2) Mix the chitosan and propylene glycol and add them to the reactor while stirring,
3) Start circulation via HS pump (alternatively start HS agitation).
4) Add acetic acid to the reactor,
5) Check if chitosan fully dissolves in liquid phase,
6) When fully dissolves, add mancozeb while doing HS, keep temperature below 35° C. if possible,
7) After feeding all the mancozeb stop HS pump and add antifoaming, Silcolapse 426R (Rhodorsil 426R),
8) Add Reax 88 A and mix for 15-30 minutes,
9) Circulate throw HS pump 3-4 times whole volume and check particle size with and without sonication (d50), and
10) Add the 2% in water AgRH 23 pregel and the biocide (Acticide MBS) to the post-milled suspension and mix until a homogeneous formulation is obtained, 30-60 minutes.

The resultant suspension concentration (SC) composition comprising 400 g/L of mancozeb is provided in Table 43 and its specifications are provided in Table 44.

TABLE 43
400SC composition comprising mancozeb-chitosan
macromolecular complex without Triton HW-1000

| | Quantity for | Percentage |
|---|---|---|
| Raw Material | 1000 liter | by Weight |
| Mancozeb | 407.0 Kg | 37.0 |
| (A.I. as 100%) | (469.9 Kg | |
| | as 86.7%) | |
| Chitosan | 6.4 | 0.5 |
| Reax 88 A | 76.2 | 6.0 |
| Acetic acid | 3.8 | 0.3 |
| Silcolapse 426R | 5.1 | 0.4 |
| Propylene glycol | 53.3 | 4.2 |
| Proxel | 1.0 | 0.1 |
| AgRH 23 (2%) | 25.4 | 2.0 |
| Water | Up to 1271 | 49.6 |
| | (629.9) | |

TABLE 44
Specifications

| | | |
|---|---|---|
| Mancozeb conc. | 400 | g/L (380-410) |
| Density | 1.27 | g/ml |
| Viscosity | 1100-1400 | mPa*S |
| (spindle 62, | | |
| 12 RPM) | | |

### Example 13. 400SC Composition Comprising Mancozeb-Chitosan Macromolecular Complex with Triton HW-1000

The 400 SC composition comprising mancozeb-chitosan macromolecular complex with Triton HW-1000 was prepared using the following method:
1) Add water to the reactor
2) Mix the chitosan and propylene glycol and add them to the reactor while stirring,
3) Start circulation via HS pump (alternatively start HS agitation),
4) Add acetic acid to the reactor,
5) Check if chitosan fully dissolves in liquid phase,
6) When fully dissolved, add Triton HW-1000 to the reactor,
7) Add mancozeb while doing HS, keep temperature below 35° C. if possible.
8) After feeding all the mancozeb, stop HS pump and add antifoaming, Silcolapse 426R (Rhodorsil 426R),
9) Add Reax 88 A and mix for 15-30 minutes,
10) Circulate throw HS pump 3-4 times whole volume and check particle size with and without sonication (d50), and
11) Add the 2% in water AgRH 23 pregel and the biocide (Acticide MBS) to the post-milled suspension and mix until a homogeneous formulation is obtained, 30-60 minutes.

The resultant suspension concentration (SC) composition comprising 400 g/L of mancozeb is provided in Table 45 and its specifications are provided in Table 46.

TABLE 45
400SC composition comprising mancozeb-chitosan
macromolecular complex with Triton HW-1000

| | Quantity for | Percentage |
|---|---|---|
| Raw Material | 1000 liter | by Weight |
| Mancozeb | 407.0 Kg | 37.0 |
| (A.I. as 100%) | (469.9 Kg | |
| | as 86.7%) | |
| Chitosan | 6.4 | 0.5 |
| Triton HW-1000 | 1.3 | 0.1 |
| Reax 88 A | 76.2 | 6.0 |
| Acetic acid | 3.8 | 0.3 |
| Silcolapse 426R | 5.1 | 0.4 |
| Propylene glycol | 53.3 | 4.2 |
| Proxel | 1.0 | 0.1 |
| AgRH 23 (2%) | 25.4 | 2.0 |
| Water | Up to 1271 | 49.5 |
| | (628.6) | |

TABLE 46
Specification

| | | |
|---|---|---|
| Mancozeb conc. | 400 | g/l (380-410) |
| Density | 1.27 | g/ml |
| Viscosity | 900-1200 | mPa*S |
| (spindle 62, | | |
| 12 RPM) | | |

1. A macromolecular complex of a polyelectrolyte and a bioactive ingredient, wherein (1) the polyelectrolyte is a polycation, (2) the bioactive ingredient is a dithiocarbamate fungicide, and (3) the macromolecular complex is characterized by intermolecular, non-covalent interactions between the polyelectrolyte and the bioactive ingredient; or
macromolecular complex comprising (i) a dithiocarbamate fungicide, and (ii) a polycation, wherein the macromolecular complex comprises up to 1 part of polyanion per 6 parts of the dithiocarbamate fungicide by weight, preferably up to 1 part of polyanion per 10 parts of the dithiocarbamate fungicide by weight, more preferably the macromolecular complex is substantially free of polyanion or free of polyanion; or
a macromolecular complex comprising (i) a dithiocarbamate fungicide, (ii) a polycation, and (ii) a polyanion, wherein the macromolecular complex has any one or any combination of the following features:
a. the macromolecular complex is characterized by intermolecular, non-covalent interactions between the polycation and the dithiocarbamate, and wherein the macromolecular complex has more intermolecular, non-covalent interactions between the polycation and the dithiocarbamate fungicide compared to a macromolecular complex comprising the same type and amount of polycation, polyanion and dithiocarbamate fungicide made by pre-mixing the polycation and the polyanion to form a polyelectrolyte matrix prior to addition of the dithiocarbamate fungicide,
b. an aqueous solution comprising the macromolecular complex comprises more zinc and/or manganese ions compared to an aqueous solution of a macromolecular complex comprising the same type and amount of polycation, polyanion and dithiocarbamate fungicide made by pre-mixing the polycation and the polyanion to form a polyelectrolyte matrix prior to addition of the dithiocarbamate fungicide,
c. the macromolecular complex has improved leaf adhesion compared to a macromolecular complex comprising the same type and amount of polycation, polyanion and dithiocarbamate fungicide made by pre-mixing the polycation and the polyanion to form a polyelectrolyte matrix prior to addition of the dithiocarbamate fungicide,
d. the macromolecular complex has improved rainfastness compared to a macromolecular complex comprising the same type and amount of polycation, polyanion and dithiocarbamate fungicide made by pre-mixing the polycation and the polyanion to form a polyelectrolyte matrix prior to addition of the dithiocarbamate fungicide,
e. the macromolecular complex has decreased drift compared to a macromolecular complex comprising the same type and amount polycation, polyanion and dithiocarbamate fungicide made by pre-mixing the polycation and the polyanion to form a polyelectrolyte matrix prior to addition of the dithiocarbamate fungicide,
f. the macromolecular complex is more fungicidally effective compared to a macromolecular complex comprising the same type and amount of polycation, polyanion and dithiocarbamate fungicide made by pre-mixing the polycation and the polyanion to form a polyelectrolyte matrix prior to addition of the dithiocarbamate fungicide when the dithiocarbamate fungicide is applied at the same amount,
g. the macromolecular complex has the same fungicidal efficacy compared to a macromolecular complex comprising the same type and amount of polycation, polyanion and dithiocarbamate fungicide made by pre-mixing the polycation and the polyanion to form a polyelectrolyte matrix prior to addition of the dithiocarbamate fungicide when the dithiocarbamate fungicide is applied at a lower amount, and
h. the macromolecular complex has increased bioavailability compared to a macromolecular complex comprising the same type and amount of polycation, polyanion and dithiocarbamate fungicide made by pre-mixing the polycation and the polyanion to form a polyelectrolyte matrix prior to addition of the dithiocarbamate fungicide.

2. (canceled)

3. The macromolecular complex of claim 1 comprising a polyanion, wherein the polyanion is selected from the group consisting of alginate, a lignin compound, pectin, carrageenan, humic acid, fulvic acid, sodium alkyl naphtalene sulfonate, poly-γ-glutamic acid, maleic starch half-ester, carboxymethyl cellulose, chondroitin sulphate, dextran sulphate, hyaluronic acid, poly(acrylic acid), polyphosphoric acid, poly(L-lactide), polyglycolide, and any combination thereof, preferably the polyanion is a lignin compound, more preferably the lignin compound is lignosulfonate.

4. The macromolecular complex of claim 3, wherein the macromolecular complex is characterized by intermolecular, non-covalent interactions between the polycation and the dithiocarbamate fungicide, preferably electrostatic interactions such as ionic interactions, hydrogen bonds and van der Waals forces, such as dipole-dipole interactions, between the polycation and the dithiocarbamate fungicide.

5. The macromolecular complex of claim 1, wherein the macromolecular complex comprises the polycation and the dithiocarbamate fungicide in a ratio between 1:5 and 1:300 (w/w), preferably between 1:60 and 1:70 (w/w).

6. The macromolecular complex of claim 1, wherein the dithiocarbamate fungicide is zinc; manganese(2+); N-[2-(sulfidocarbothioylamino)ethyl]carbamodithioate (mancozeb).

7. The macromolecular complex of claim 1, wherein the polycation is selected from the group consisting of cationic starch, poly(allylamine) (PAA), chitosan, epsilon-poly (L-lysine), chitosan derivatives preferably thiolated chitosan, 5-methyl-pyrrolidinone-chitosan, and chitosan oligosaccharide, DEAE-dextran and any combination thereof.

8. The macromolecular complex of claim 1, wherein the macromolecular complex has a particle size d50 of 1-2 microns and/or a particle size d90 of 1-15 microns.

9. (canceled)

10. The macromolecular complex of claim 1, wherein the macromolecular complex is made by pre-mixing the polycation and the dithiocarbamate fungicide prior to addition of the polyanion.

11. The macromolecular complex of claim 1, wherein the macromolecular complex is made by adding the polycation to a pre-mix of the dithiocarbamate fungicide and the polyanion.

12. The macromolecular complex of claim 11, wherein the pre-mix of the dithiocarbamate fungicide and the polyanion contains up to 1 part of polyanion per 6 parts of the dithiocarbamate fungicide.

13. A composition comprising (i) the macromolecular complex of claim 1 and (ii) at least one agriculturally acceptable additive.

14. The composition of claim 13, wherein:
a. the concentration of the macromolecular complex in the composition is between 1 and 50 g/kg,
b. the concentration of the polycation in the composition is 0.01-10% by weight based on the total weight of the composition,
c. the concentration of the dithiocarbamate fungicide in the composition is between 350 and 450 g/L, and/or
d. the concentration of the dithiocarbamate fungicide in the composition is up to 45% by weight based on the total weight of the composition, preferably between 30-45% by weight based on the total weight of the composition.

15. The composition of claim 13, wherein:
a) the composition comprises at least one dispersant, preferably the dispersant is lignosulfonate, a modified acrylic polymer or a combination thereof,
b) the composition comprises at least one stabilizer, preferably the stabilizer is an acid, more preferably the acid is acetic acid,
c) the composition comprises at least one anti-foam agent, preferably the anti-foam agent is silicone-based,
d) the composition comprises at least one antifreezing agent, preferably the antifreezing agent is propylene glycol,
e) the composition comprises at least one surfactant, preferably the surfactant is a non-ionic surfactant, more preferably the non-ionic surfactant is a non-ionic hydrocarbon-based surfactant,
f) the composition comprises at least one wetting agent, preferably the wetting agent is a polyalkylene oxide block copolymer,
g) the composition comprises at least one preservative, preferably the preservative is a biocide, and/or
h) the composition comprises at least one rheology modifier, preferably rheology modifier is xanthan gum.

16-20. (canceled)

21. A composition comprising (i) a macromolecular complex comprising a dithiocarbamate fungicide, a polycation, and a polyanion, wherein the macromolecular complex is characterized by intermolecular, non-covalent interactions between the polycation and the dithiocarbamate, and (ii) at least one agriculturally acceptable additive, wherein the composition has any one or any combination of the following features:
a. the composition has improved leaf adhesion compared to a composition comprising a macromolecular complex comprising the same type and amount of polycation, polyanion and dithiocarbamate fungicide made by pre-mixing the polycation and the polyanion to form a polyelectrolyte matrix prior to addition of the dithiocarbamate fungicide,
b. the composition has improved rainfastness compared to a composition comprising a macromolecular complex comprising the same type and amount of polycation, polyanion and dithiocarbamate fungicide made by pre-mixing the polycation and the polyanion to form a polyelectrolyte matrix prior to addition of the dithiocarbamate fungicide,
c. the composition has decreased drift compared to a composition comprising a macromolecular complex comprising the same type and amount polycation, polyanion and dithiocarbamate fungicide made by pre-mixing the polycation and the polyanion to form a polyelectrolyte matrix prior to addition of the dithiocarbamate fungicide,
d. the composition is more fungicidally effective compared to a composition comprising a macromolecular complex comprising the same type and amount of polycation, polyanion and dithiocarbamate fungicide made by pre-mixing the polycation and the polyanion to form a polyelectrolyte matrix prior to addition of the dithiocarbamate fungicide when the dithiocarbamate fungicide is applied at the same amount,
e. the composition has the same fungicidal efficacy compared to a composition comprising a macromolecular complex comprising the same type and amount of polycation, polyanion and dithiocarbamate fungicide made by pre-mixing the polycation and the polyanion to form a polyelectrolyte matrix prior to addition of the dithiocarbamate fungicide when the dithiocarbamate fungicide is applied at a lower amount, and
f. the composition has increased bioavailability compared to a composition comprising a macromolecular complex comprising the same type and amount of polycation, polyanion and dithiocarbamate fungicide made by pre-mixing the polycation and the polyanion to form a polyelectrolyte matrix prior to addition of the dithiocarbamate fungicide.

22-24. (canceled)

25. A process for producing a macromolecular complex comprising (i) a dithiocarbamate fungicide and (ii) a polycation, wherein the process comprises the following steps:
(a) providing an aqueous composition of the polycation,
(b) mixing the dithiocarbamate fungicide into the aqueous composition, while keeping the pH of the mixture between pH=3-6, preferably between 3-4, by addition of an acid or a base,
(c) thereby producing the macromolecular complex comprising the polycation and the dithiocarbamate fungicide; or
a process for producing a composition comprising (i) macromolecular complex and (ii) an agriculturally acceptable additive, wherein the process comprises the following steps:
(a) obtaining the macromolecular complex of claim 1,
(b) mixing the macromolecular complex obtained in step (a) with an agriculturally acceptable additives, and
(c) thereby producing the composition comprising (i) macromolecular complex and (ii) an agriculturally acceptable additive.

26. (canceled)

27. (canceled)

28. The process of claim 25, wherein:
a. the macromolecular complex comprises up to 1 part of polyanion per 6 parts of dithiocarbamate fungicide by weight, and step (b) comprises obtaining a batch of dithiocarbamate fungicide that has up to 1 part of polyanion per 6 parts of dithiocarbamate fungicide by weight and mixing the batch with the aqueous composition of step (a), or
b. the macromolecular complex is free of polyanion and step (b) comprises obtaining a batch of dithiocarbamate fungicide that is free of polyanion and mixing the batch with the aqueous composition of step (a).

29. A macromolecular complex produced using the process of claim 25.

30. (canceled)

31. (canceled)

32. A composition prepared using the process of claim 25.

33. A delivery system comprising a polycation, a dithiocarbamate fungicide and a system of dispersants, wherein molecules of the dithiocarbamate fungicide interact with molecules of the polycation through intermolecular force(s), or comprising the composition of claim 1.

34. A method of (i) treating a plant, or a part of a plant, against a pathogen, (ii) increasing crop yield, and/or (iii) improving plant vigor, comprising contacting the plant, or part of the plant, with the macromolecular complexes of claim 1; or
a method for (i) increasing biological activity of a dithiocarbamate fungicide on a target, (ii) increasing uptake of a dithiocarbamate fungicide into a target, (iii) increasing penetration of a dithiocarbamate fungicide into a target, (iv) increasing retention of a dithiocarbamate fungicide by a target, (v) increasing absorbance of a dithiocarbamate fungicide by a target, and/or (vi) increasing or enhancing bioavailability of a dithiocarbamate fungicide to a target, wherein the method comprises interacting the dithiocarbamate fungicide with a polycation prior to application of the dithiocarbamate fungicide to a plant, a plant part, and/or soil; or
a method for (i) reducing drift of a dithiocarbamate fungicide, (ii) increasing leaf adhesion of a dithiocarbamate fungicide, (iii) increasing rainfastness of a dithiocarbamate fungicide, (iv) increasing persistence of a dithiocarbamate fungicide, and/or (v) reducing phytotoxicity of a dithiocarbamate fungicide, wherein the method comprises interacting the dithiocarbamate fungicide with a polycation prior to application of the dithiocarbamate fungicide.

35-40. (canceled)
